(19) United States
(12) Patent Application Publication
(10) Pub. No.: US 2022/0128913 A1
(43) Pub. Date: Apr. 28, 2022

(54) ELECTROPHOTOGRAPHIC PHOTOSENSITIVE MEMBER, PROCESS CARTRIDGE, AND IMAGE FORMING APPARATUS

(71) Applicant: KYOCERA Document Solutions Inc., Osaka (JP)

(72) Inventors: Tomofumi SHIMIZU, Osaka-shi (JP); Makoto SHISHIDO, Osaka-shi (JP); Kazuaki EZURE, Osaka-shi (JP); Kiichiro OJI, Osaka-shi (JP); Katsuya TAKANO, Osaka-shi (JP)

(73) Assignee: KYOCERA Document Solutions Inc., Osaka (JP)

(21) Appl. No.: 17/505,721

(22) Filed: Oct. 20, 2021

(30) Foreign Application Priority Data
Oct. 23, 2020 (JP) 2020-178043
Oct. 23, 2020 (JP) 2020-178044
Oct. 23, 2020 (JP) 2020-178045

(51) Int. Cl. G03G 5/06; G03G 5/07

(52) U.S. Cl. CPC G03G 5/0696; G03G 5/075; G03G 5/078

(57) ABSTRACT

An electrophotographic photosensitive member includes a conductive substrate and a photosensitive layer. The photosensitive layer is a single layer and contains a charge generating material, a hole transport material, an electron transport material, and a polyarylate resin. The polyarylate resin includes repeating units represented by formulas (1), (2), and (3).

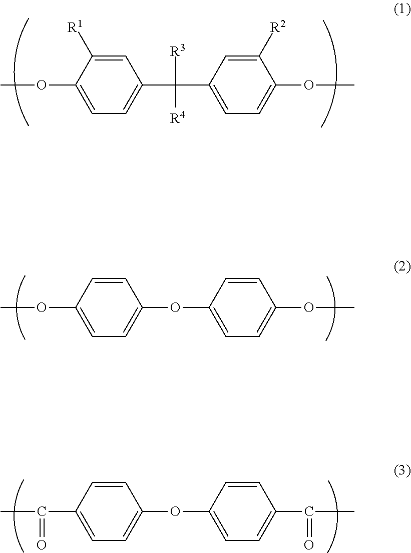

A ratio n₁/n₂ of the number n₁ of repeats of the repeating unit represented by formula (1) to the number n₂ of repeats of the repeating unit represented by formula (2) is at least 1.0.

### INCORPORATION BY REFERENCE

The present application claims priority under 35 U.S.C. § 119 to Japanese Patent Applications No. 2020-178044, filed on Oct. 23, 2020, No. 2020-178043, filed on Oct. 23, 2020, and No. 2020-178045, filed on Oct. 23, 2020. The contents of these applications are incorporated herein by reference in their entirety.

### BACKGROUND

The present disclosure relates to an electrophotographic photosensitive member, a process cartridge, and an image forming apparatus.

An electrophotographic photosensitive member is used as an image bearing member in an electrographic image forming apparatus (e.g., a printer or a multifunction peripheral). The electrophotographic photosensitive member includes a photosensitive layer. Examples of the electrophotographic photosensitive member include a single-layer electrophotographic photosensitive member and a multi-layer electrophotographic photosensitive member. The single-layer electrophotographic photosensitive member includes a single-layer photosensitive layer having a charge generating function and a charge transporting function. The multi-layer electrophotographic photosensitive member includes a photosensitive layer including a charge generating layer having a charge generating function and a charge transport layer having a charge transporting function.

For example, an electrophotographic photosensitive member including a photosensitive layer is known. A binder resin contained in the photosensitive layer is a polyarylate resin with a structure represented by the following formula.

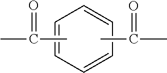

### SUMMARY

An electrophotographic photosensitive member according to an aspect of the present disclosure includes a conductive substrate and a photosensitive layer. The photosensitive layer is a single layer. The photosensitive layer contains a charge generating material, a hole transport material, an electron transport material, and a polyarylate resin. The polyarylate resin includes a repeating unit represented by formula (1), a repeating unit represented by formula (2), and a repeating unit represented by formula (3). A ratio n₁/n₂ of a number n₁ of repeats of the repeating unit represented by formula (1) to a number n₂ of repeats of the repeating unit represented by formula (2) is at least 1.0.

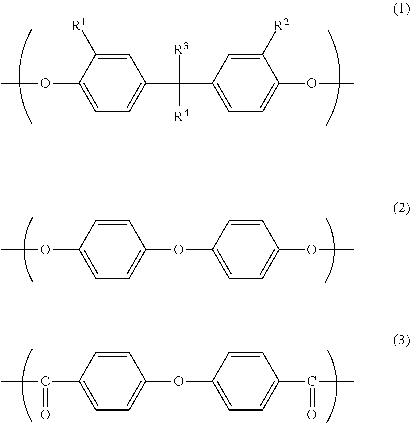

In the formula (1): R¹ and R² each represent a methyl group, and R³ and R⁴ are bonded to each other to represent a cycloalkylidene group with a carbon number of 5 or 6; or R¹ and R² each represent, independently of one another, a hydrogen atom or a methyl group, R³ represents a methyl group, and R⁴ represents a hydrogen atom or an alkyl group with a carbon number of 2 or 3.

A process cartridge according to an aspect of the present disclosure includes the above-described electrophotographic photosensitive member.

An image forming apparatus according to an aspect of the present disclosure includes an image bearing member, a charger that charges a surface of the image bearing member, a light exposure device that exposes the charged surface of the image bearing member to light to form an electrostatic latent image on the surface of the image bearing member, a development device that develops the electrostatic latent image into a toner image by supplying toner to the surface of the image bearing member, and a transfer device that transfers the toner image from the image bearing member to a transfer target. The image bearing member is the above-described electrophotographic photosensitive member.

### BRIEF DESCRIPTION OF THE DRAWINGS

FIG. 1 is a partial cross-sectional view of an example of an electrophotographic photosensitive member according to a first embodiment of the present disclosure.

FIG. 2 is a partial cross-sectional view of another example of the electrophotographic photosensitive member according to the first embodiment of the present disclosure.

FIG. 3 is a partial cross-sectional view of still another example of the electrophotographic photosensitive member according to the first embodiment of the present disclosure.

FIG. 4 is a diagram illustrating an example of a configuration of an image forming apparatus according to a second embodiment of the present disclosure.

FIG. 5 is a diagram illustrating an example of a configuration of a development device illustrated in FIG. 4.

### DETAILED DESCRIPTION

The following describes preferable embodiments of the present disclosure in detail. However, the present disclosure is not limited to any of the following embodiments and can be practiced with appropriate alteration added within the scope of the purpose of the present disclosure. Note that although duplicate explanations may be omitted as appropriate, the gist of the disclosure is not limited in any ways. In the following description, the term “-based” may be appended to the name of a chemical compound in order to form a generic name encompassing both the chemical compound itself and derivatives thereof. When the term “-based” is appended to the name of a chemical compound to form a generic name of a polymer, it means that a repeating unit of the polymer is derived from the chemical compound or a derivative thereof. Furthermore, general formulas and chemical formulas are each generally referred to as “formula”. The words “each represent, independently of one another” in description of formulas mean representing the same group as or different groups from each other. Any one type of each component described in the present specification may be used independently or any two or more types of the component may be used in combination unless otherwise stated. Furthermore, values for volume median diameter (e.g., volume median diameter of resin particles) are values as measured using for example a precision particle size distribution analyzer (“Coulter Counter Multisizer 3”, product of Beckman Coulter, Inc.). The term volume median diameter means a median diameter calculated in terms of volume by the Coulter Counter method. Furthermore, values for viscosity average molecular weight are values as measured according to Japanese Industrial Standards (JIS) K7252-1:2016 unless otherwise stated.

Substituents used in the present specification are described first. Examples of a halogen atom (halogen group) include a fluorine atom (fluoro group), a chlorine atom (chloro group), a bromine atom (bromo group), and an iodine atom (iodine group).

Unless otherwise stated, an alkyl group with a carbon number of at least 1 and no greater than 6, an alkyl group with a carbon number of at least 1 and no greater than 5, an alkyl group with a carbon number of at least 1 and no greater than 4, an alkyl group with a carbon number of at least 1 and no greater than 3, an alkyl group with a carbon number of 2, and an alkyl group with a carbon number of 3 each are a unsubstituted straight chain or branched chain alkyl group. Examples of the alkyl group with a carbon number of at least 1 and no greater than 6 include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethypropyl group, a 1-ethylbutyl group, a 2-ethylbutyl group, and a 3-ethylbutyl group. Examples of the alkyl group with a carbon number of at least 1 and no greater than 5, the alkyl group with a carbon number of at least 1 and no greater than 4, the alkyl group with a carbon number of at least 1 and no greater than 3, the alkyl group with a carbon number of 2, and the alkyl group with a carbon number of 3 are groups with corresponding carbon numbers among the groups listed as the examples of the alkyl group with a carbon number of at least 1 and no greater than 6.

An alkoxy group with a carbon number of at least 1 and no greater than 6 and an alkoxy group with a carbon number of at least 1 and no greater than 3 each are an unsubstituted straight chain or branched chain alkoxy group unless otherwise stated. Examples of the alkoxy group with a carbon number of at least 1 and no greater than 6 include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, and a 3-ethylbutoxy group. Examples of the alkoxy group with a carbon number of at least 1 and no greater than 3 include groups with a corresponding carbon number among the groups listed as the examples of the alkoxy group with a carbon number of at least 1 and no greater than 6.

An aryl group with a carbon number of at least 6 and no greater than 14 and an aryl group with a carbon number of at least 6 and no greater than 10 each are an unsubstituted aryl group unless otherwise stated. Examples of the aryl group with a carbon number of at least 6 and no greater than 14 include a phenyl group, a naphthyl group, an indacenyl group, a biphenylenyl group, an acenaphthylenyl group, an anthryl group, and a phenanthryl group. Examples of the aryl group with a carbon number of at least 6 and no greater than 10 includes a phenyl group and a naphthyl group.

An alkenyl group with a carbon number of at least 2 and no greater than 6 is an unsubstituted straight chain or branched chain alkenyl group unless otherwise stated. The alkenyl group with a carbon number of at least 2 and no greater than 6 has one to three double bonds. Examples of the alkenyl group with a carbon number of at least 2 and no greater than 6 include an ethenyl group, a propenyl group, a butenyl group, a butadienyl group, a pentenyl group, a hexenyl group, a hexadienyl group, and a hexatrinyl group. The substituents used in the present specification have been described so far.

### First Embodiment: Electrophotographic Photosensitive Member

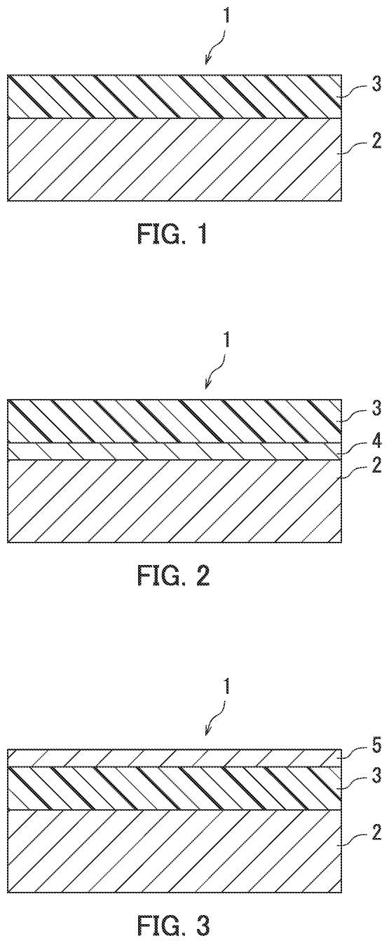

A first embodiment relates to an electrophotographic photosensitive member (also referred to below as photosensitive member). Examples of the structure of the photosensitive member according to the first embodiment of the present disclosure are describe below with reference to FIGS. 1 to 3. FIGS. 1 to 3 each are a partial cross-sectional view of an example of a photosensitive member 1.

As illustrated in FIG. 1, the photosensitive member 1 includes a conductive substrate 2 and a photosensitive layer 3, for example. The photosensitive layer 3 is a single layer. The photosensitive member 1 is a single-layer electrophotographic photosensitive member including the single-layer photosensitive layer 3.

As illustrated in FIG. 2, the photosensitive member 1 may further include an intermediate layer 4 (undercoat layer) in addition to the conductive substrate 2 and the photosensitive layer 3. The intermediate layer 4 is disposed between the conductive substrate 2 and the photosensitive layer 3. As illustrated in FIG. 1, the photosensitive layer 3 may be disposed directly on the conductive substrate 2. Alternatively, as illustrated in FIG. 2, the photosensitive layer 3 may be disposed on the conductive substrate 2 with the intermediate layer 4 therebetween.

As illustrated in FIG. 3, the photosensitive member 1 may further include a protective layer 5 in addition to the conductive substrate 2 and the photosensitive layer 3. The protective layer 5 is disposed on the photosensitive layer 3. As illustrated in FIG. 3, the protective layer 5 may be provided as an outermost surface layer of the photosensitive member 1. However, the photosensitive layer 3 is preferably provided as an outermost surface layer of the photosensitive member 1 as illustrated in FIGS. 1 and 2. When the photosensitive layer 3 contains a later-described polyarylate resin (PA) and is provided as an outermost surface layer, the photosensitive member 1 can have further improved filming resistance and scratch resistance.

The thickness of the photosensitive layer 3 is not limited particularly, but preferably at least 5 μm and no greater than 100 μm, and more preferably at least 10 μm and no greater than 50 μm. Examples of the structure of the photosensitive member 1 have been described so far with reference to FIGS. 1 to 3.

The photosensitive member is further described below. The photosensitive layer of the photosensitive member contains a charge generating material, a hole transport material, an electron transport material, and a polyarylate resin.

(Charge Generating Material)

Examples of the charge generating material include phthalocyanine-based pigments, perylene-based pigments, bisazo pigments, tris-azo pigments, dithioketopyrrolopyrrole pigments, metal-free naphthalocyanine pigments, metal naphthalocyanine pigments, squaraine pigments, indigo pigments, azulenium pigments, cyanine pigments, powders of inorganic photoconductive materials (e.g., selenium, selenium-tellurium, selenium-arsenic, cadmium sulfide, and amorphous silicon), pyrylium pigments, anthanthrone-based pigments, triphenylmethane-based pigments, threne-based pigments, toluidine-based pigments, pyrazoline-based pigments, and quinacridone-based pigments. The photosensitive layer may contain only one charge generating material or contain two or more charge generating materials.

The phthalocyanine-based pigments are pigments having phthalocyanine structure. Examples of the phthalocyanine-based pigments include metal phthalocyanine and metal-free phthalocyanine. Examples of the metal phthalocyanine include titanyl phthalocyanine, hydroxygallium phthalocyanine, and chlorogallium phthalocyanine. A preferable metal phthalocyanine is titanyl phthalocyanine. Titanyl phthalocyanine is represented by formula (CG-1). Metal-free phthalocyanine is represented by formula (CG-2).

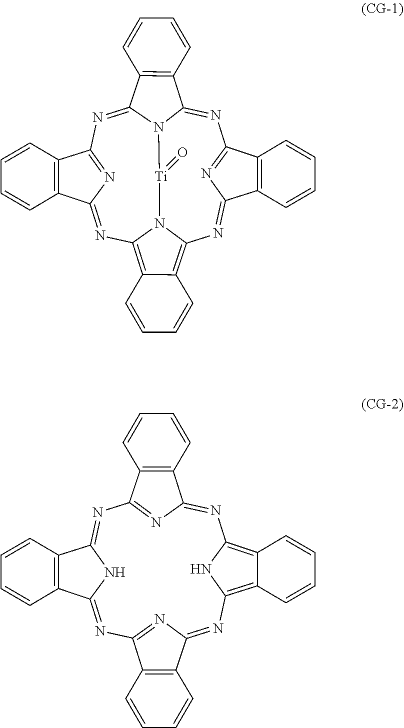

The phthalocyanine-based pigments may be crystalline or non-crystalline. An example of crystalline metal-free phthalocyanine is metal-free phthalocyanine having an X-form crystal structure (also referred to below as X-form metal-free phthalocyanine). Examples of crystalline titanyl phthalocyanine include titanyl phthalocyanine having any of an α-form, β-form, and Y-form crystal structure (also referred to below as α-form, β-form, and Y-form titanyl phthalocyanine, respectively).

For example, a photosensitive member with a sensitivity in a wavelength range of at least 700 nm is preferably used in a digital optical image forming apparatus (e.g., a laser beam printer or facsimile machine including a light source such as a semiconductor laser). In terms of attaining a high quantum yield in a wavelength range of at least 700 nm, the charge generating material is preferably a phthalocyanine-based pigment, more preferably metal-free phthalocyanine or titanyl phthalocyanine, and particularly preferably X-form metal-free phthalocyanine or Y-form titanyl phthalocyanine.

Y-form titanyl phthalocyanine exhibits a main peak for example at a Bragg angle (2θ±0.2°) of 27.2° in a CuKα characteristic X-ray diffraction spectrum. The term main peak refers to a most intense or second most intense peak within a range of Bragg angles (2θ±0.2°) from 3° to 40° in the CuKα characteristic X-ray diffraction spectrum. Y-form titanyl phthalocyanine exhibits no peak at 26.2° C. in the CuKα characteristic X-ray diffraction spectrum.

The CuKα characteristic X-ray diffraction spectrum can be measured by the following method, for example. First, a sample (titanyl phthalocyanine) is loaded into a sample holder of an X-ray diffraction spectrometer (e.g., “RINT (registered Japanese trademark) 1100”, product of Rigaku Corporation) and an X-ray diffraction spectrum is measured using a Cu X-ray tube under conditions of a tube voltage of 40 kV, a tube current of 30 mA, and a wavelength of CuKα characteristic X-rays of 1.542 Å. The measurement range (2θ) is for example 3° to 40° (start angle 3°, stop angle 40°), and the scanning speed is for example 10°/min. A main peak is determined in the obtained X-ray diffraction spectrum, and a Bragg angle of the main peak is read from the X-ray diffraction spectrum.

The content ratio of the charge generating material is preferably at least 0.1 parts by mass and no greater than 50 parts by mass relative to 100 parts by mass of the binder resin, and more preferably at least 0.5 parts by mass and no greater than 5 parts by mass.

(Binder Resin)

The photosensitive layer contains the polyarylate resin as a binder resin. The polyarylate resin includes a repeating unit represented by formula (1), a repeating unit represented by formula (2), and a repeating unit represented by formula (3). A ratio n₁/n₂ of the number n₁ of repeats of the repeating unit represented by formula (1) to the number n₂ of repeats of the repeating unit represented by formula (2) is at least 1.0.

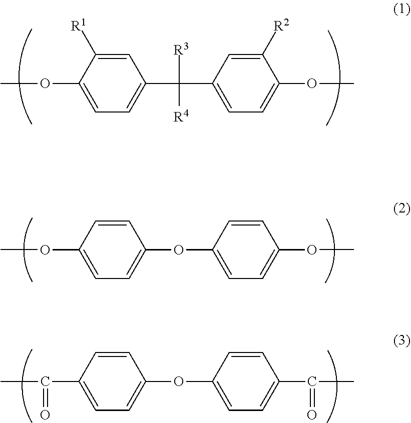

In formula (1), R¹ and R² each represent a methyl group, and R³ and R⁴ are bonded to each other to represent a cycloalkylidene group with a carbon number of 5 or 6. Alternatively, in formula (1), R¹ and R² each represent, independently of one another, a hydrogen atom or a methyl group, R³ represents a methyl group, and R⁴ represents a hydrogen atom or an alkyl group with a carbon number of 2 or 3.

In the following, the repeating units represented by formulas (1), (2), and (3) are also referred to below as repeating units (1), (2), and (3), respectively. Furthermore, a polyarylate resin including the repeating unit (1), the repeating unit (2), and the repeating unit (3) with a ratio n₁/n₂ of the number n₁ of repeats of the repeating unit (1) to the number n₂ of repeats of the repeating unit (2) of at least 1.0 is referred to as polyarylate resin (PA).

As a result of the photosensitive layer containing the polyarylate resin (PA), the photosensitive member can have improved filming resistance and scratch resistance. The reasons thereof are presumed as follows.

The polyarylate resin (PA) includes the repeating unit (1) and the repeating units (2) and (3) each having an ether bond (—O— bond) with a ratio n₁/n₂ of at least 1.0. As a result of containing the polyarylate resin (PA) having such a specific structure, the photosensitive layer can have increased strength to improve scratch resistance of the photosensitive member. Furthermore, the polyarylate resin (PA) with the specific structure is excellent in solubility in a solvent for photosensitive layer formation, enabling formation of a uniform photosensitive layer with high density. From the reason as above, the photosensitive member can also have improved scratch resistance. Furthermore, as a result of containing the polyarylate resin (PA) having the specific structure, elasticity of the photosensitive layer is increased, so that paper dust and an external additive of toner are hardly buried in the photosensitive layer. Accordingly, the external additive and paper dust attached to the photosensitive layer are favorably cleaned off to improve filming resistance of the photosensitive member. Note that filming of a photosensitive member is a defect in which an external additive and paper dust remaining on the surface of the photosensitive member after cleaning fuse on the surface of the photosensitive member.

Examples of a cycloalkylidene group with a carbon number of 5 or 6 that R³ and R⁴ in formula (1) are bonded to each other to represent include a cyclopentylidene group and a cyclohexylidene group. The cyclopentylidene group and the cyclohexylidene group are bivalent groups represented by the following formulas (5) and (6), respectively. A preferable cycloalkylidene group with a carbon number of 5 or 6 is a cyclohexylidene group.

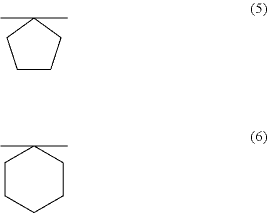

Examples of the alkyl group with a carbon number of 2 or 3 represented by R⁴ in formula (1) include an ethyl group, an n-propyl group, and an isopropyl group. The alkyl group with a carbon number of 2 or 3 is preferably an ethyl group or an isopropyl group.

Preferable examples of the repeating unit (1) include repeating units represented by formulas (1-1), (1-2), (1-3), (1-4), and (1-5). In the following, the repeating units represented by formulas (1-1), (1-2), (1-3), (1-4), and (1-5) may be also referred to below as repeating units (1-1), (1-2), (1-3), (1-4), and (1-5), respectively. In order to improve filming resistance and scratch resistance of the photosensitive member, the repeating unit (1) is preferably the repeating unit (1-5).

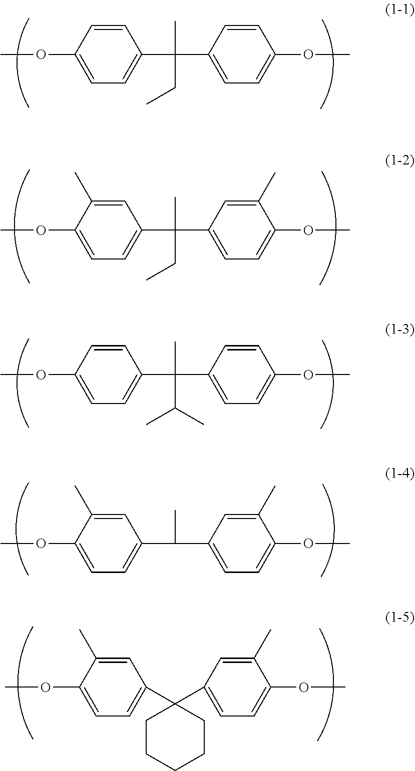

The ratio n₁/n₂ of the number n₁ of repeats of the repeating unit (1) included in the polyarylate resin (PA) to the number n₂ of repeats of the repeating unit (2) included in the polyarylate resin (PA) is at least 1.0. That is, the number n₁ of repeats of the repeating unit (1) is equal to the number n₂ of repeats of the repeating unit (2) or larger than the number n₂ of repeats of the repeating unis (2). As a result of the ratio n₁/n₂ being at least 1.0, filming resistance and scratch resistance of the photosensitive member are improved. In order to improve filming resistance and scratch resistance of the photosensitive member, the ratio n₁/n₂ is preferably at least 1.5, and more preferably at least 2.0. For the same purpose as above, the ratio n₁/n₂ is preferably no greater than 10.0, more preferably no greater than 9.0, further preferably no greater than 6.0, and particularly preferably no greater than 5.0. For the same purpose as above, it is also preferable that the ratio n₁/n₂ is within a range between two values selected from 1.0, 1.5, 2.0, 3.0, 4.0, 5.0, 6.0, 9.0, and 10.0. The ratio n₁/n₂ can be calculated from a peak ratio unique to each repeating unit in a ¹H-NMR spectrum of the polyarylate resin (PA) measured using a proton nuclear magnetic resonance spectrometer, for example.

The polyarylate resin (PA) is preferably any of polyarylate resins (PA-a) to (PA-e) shown in Table 1 below. More preferably, the polyarylate resin (PA) is any of polyarylate resins (PA-1) to (PA-8) shown in Table 2 below. In Tables 1 and 2, “unit (1)”, “unit (2)”, and “unit (3)” indicates the repeating units (1), (2), and (3), respectively. In Tables 1 and 2, “n₁/n₂” indicates the ratio n₁/n₂.

TABLE 1

| Polyarylate | | | | |
|---|---|---|---|---|
| resin | Unit (1) | Unit (2) | Unit (3) | n₁/n₂ |
| PA-a | 1-1 | 2 | 3 | 1.0 ≤ n₁/n₂ |
| PA-b | 1-5 | 2 | 3 | 1.0 ≤ n₁/n₂ |
| PA-c | 1-2 | 2 | 3 | 1.0 ≤ n₁/n₂ |
| PA-d | 1-3 | 2 | 3 | 1.0 ≤ n₁/n₂ |
| PA-e | 1-4 | 2 | 3 | 1.0 ≤ n₁/n₂ |

TABLE 2

| Polyarylate | Unit | Unit | Unit | |
|---|---|---|---|---|
| resin | (1) | (2) | (3) | n₁/n₂ |
| PA-1 | 1-1 | 2 | 3 | 2.0 ≤ n₁/n₂ ≤ 6.0 |
| PA-2 | 1-5 | 2 | 3 | 2.0 ≤ n₁/n₂ ≤ 6.0 |
| PA-3 | 1-2 | 2 | 3 | 2.0 ≤ n₁/n₂ ≤ 6.0 |
| PA-4 | 1-3 | 2 | 3 | 2.0 ≤ n₁/n₂ ≤ 6.0 |
| PA-5 | 1-4 | 2 | 3 | 2.0 ≤ n₁/n₂ ≤ 6.0 |
| PA-6 | 1-1 | 2 | 3 | 1.0 ≤ n₁/n₂ ≤ 1.5 |
| PA-7 | 1-5 | 2 | 3 | 1.5 ≤ n₁/n₂ ≤ 2.0 |
| PA-8 | 1-5 | 2 | 3 | 6.0 ≤ n₁/n₂ ≤ 10.0 |

Further preferably, the polyarylate resin (PA) is any of polyarylate resins represented by formulas (R-1) to (R-8) (also referred to below as polyarylate resins (R-1) to (R-8), respectively). Note that the number attached to the lower right of each repeating unit in formulas (R-1) to (R-8) indicates a percentage (%) of the number of repeats of the corresponding repeating unit relative to the total number of repeats of each repeating unit included in the polyarylate resin. The total number of repeats of each repeating unit is a sum of the number of repeats of each bisphenol-derived repeating unit and the number of repeats of each dicarboxylic acid-derived repeating unit. Furthermore, two repeating units (3) are indicated in each of formulas (R-1) to (R-8) for the sake of convenience. However, the percentage of the number of repeats of the repeating unit (3) relative to the total number of repeats of each repeating unit included in each of the polyarylate resins (R-1) to (R-8) is 50% (total of the numbers attached to the lower right of the two repeating units (3)).

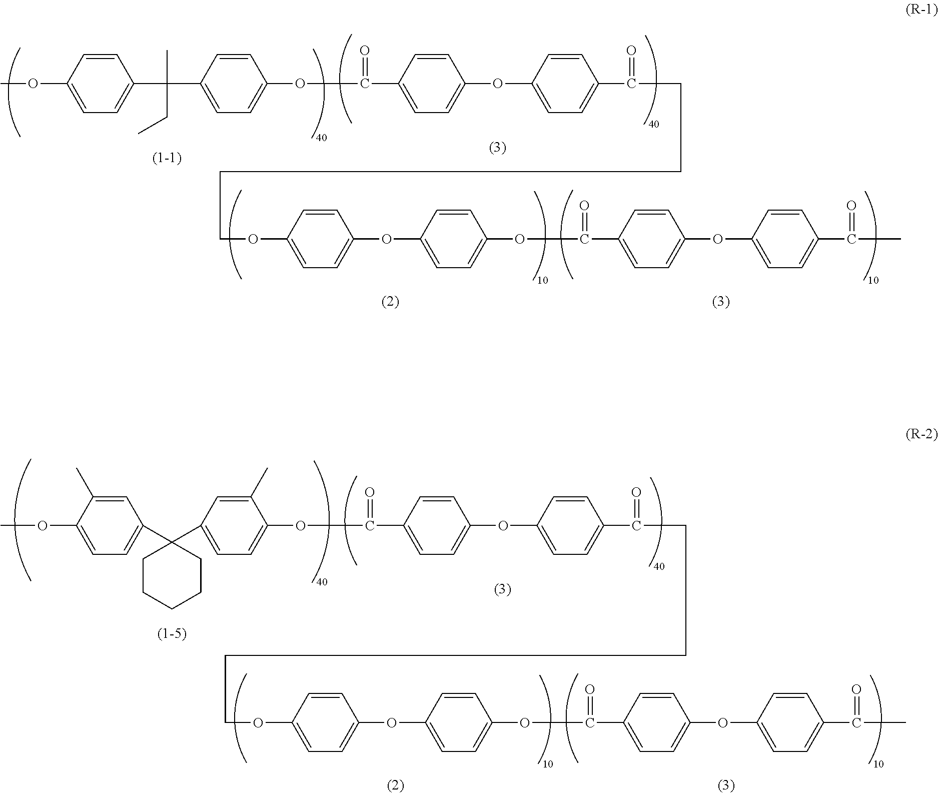

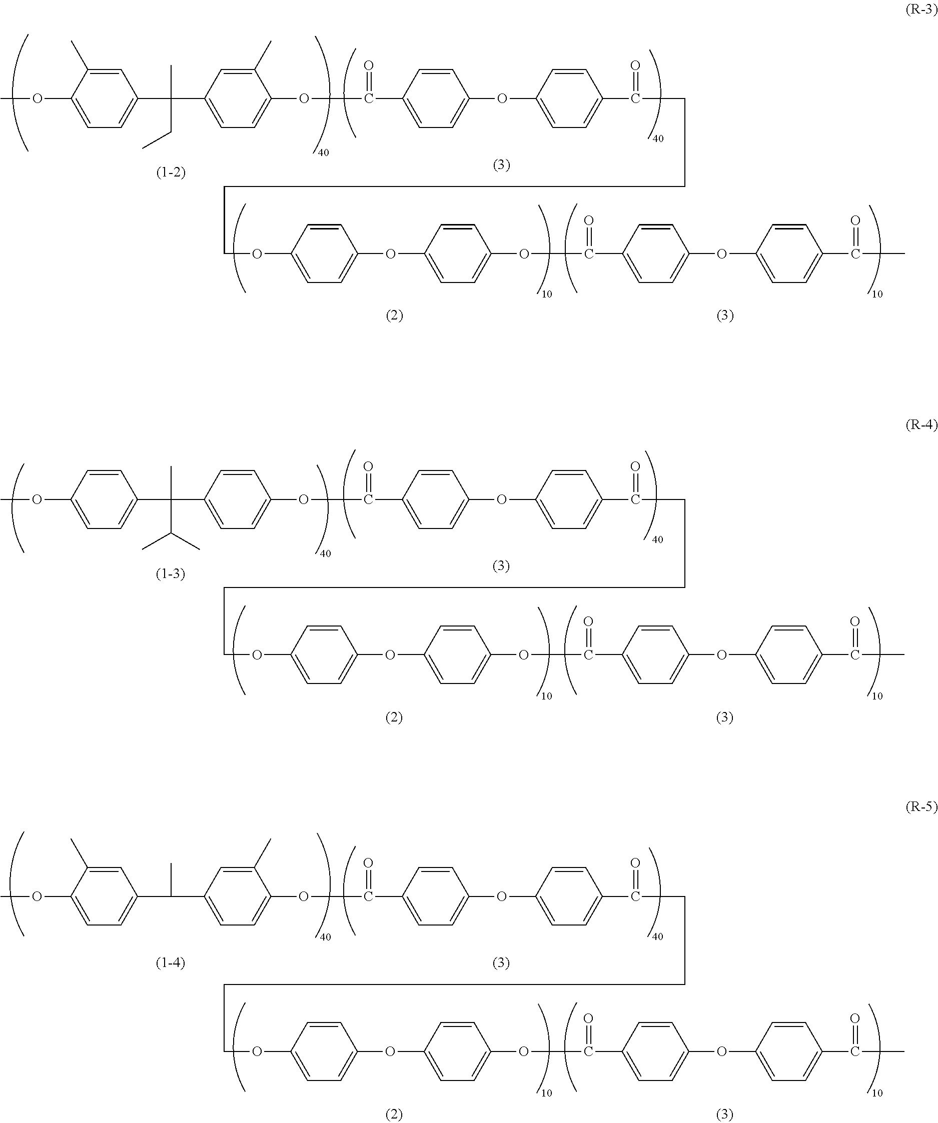

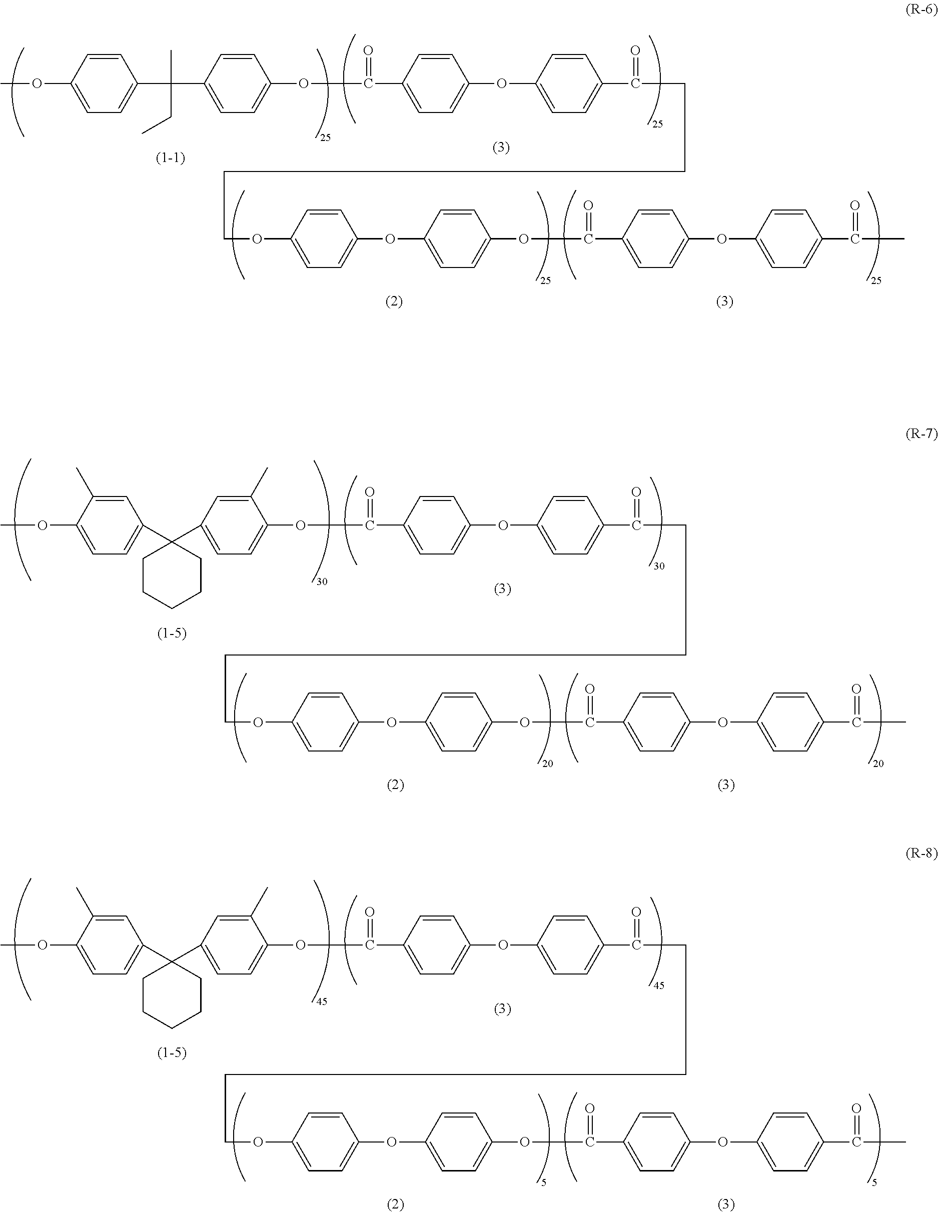

The polyarylate resin (PA) may include only one type of the repeating unit (1) or include two or more types of the repeating unit (1). Furthermore, the polyarylate resin (PA) may include only the repeating units (1), (2), and (3) as the repeating units or further include a repeating unit besides these repeating units. In addition, the photosensitive layer may contain only one type of the polyarylate resin (PA) or contain two or more types of the polyarylate resin (PA).

In the polyarylate resin (PA), the bisphenol-derived repeating unit and the dicarboxylic acid-derived repeating unit are adjacent to each other to be bonded to each other. The bisphenol-derived repeating unit includes the repeating unit (1) and (2), for example. Also, the dicarboxylic acid-derived repeating unit is the repeating unit (3), for example. The polyarylate resin (PA) may be a random copolymer, an alternating copolymer, a periodic copolymer, or a block copolymer, for example.

The polyarylate resin (PA) has a viscosity average molecular weight of preferably at least 10,000, more preferably at least 30,000, and further preferably at least 50,000. As a result of the viscosity average molecular weight of the polyarylate resin (PA) being set to at least 10,000, abrasion resistance of the photosensitive member is improved. By contrast, the polyarylate resin (PA) has a viscosity average molecular weight of preferably no greater than 80,000, and more preferably no greater than 70,000. As a result of the viscosity average molecular weight of the polyarylate resin (PA) being set to no greater than 80,000, the polyarylate resin (PA) can readily dissolve in a solvent for photosensitive layer formation.

No particular limitations are placed on a production method of the polyarylate resin (PA). An example of the production method of the polyarylate resin (PA) is condensation polymerization of bisphenol for forming a bisphenol-derived repeating unit and dicarboxylic acid for forming a dicarboxylic acid-derived repeating unit. For condensation polymerization, any known synthesis method (e.g., solution polymerization, melt polymerization, or interface polymerization) can be employed.

Examples of the bisphenol for forming a bisphenol-derived repeating unit include compounds represented by formulas (BP-1) and (BP-2) (also referred to below as compounds (BP-1) and (BP-2), respectively). Examples of the dicarboxylic acid for forming a dicarboxylic acid-derived repeating unit include a compound represented by formula (DC-3) (also referred to below as compound (DC-3)). R′, R², R³, and R⁴ in formula (BP-1) are the same as defined for R′, R², R³, and R⁴ in formula (1), respectively. The ratio n₁/n₂ can be adjusted by changing the amount of the compound (BP-1) and the amount of the compound (BP-2) added in production of the polyarylate resin (PA).

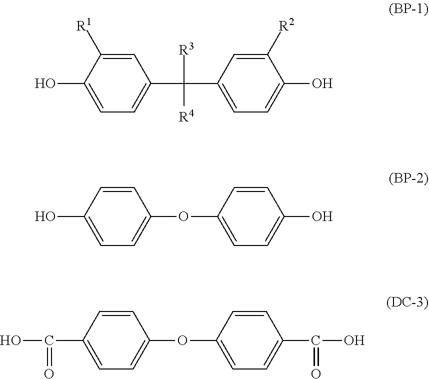

The bisphenol (e.g., the compound (BP-1) or the compound (BP-2)) may be derivatized to an aromatic diacetate for use. The dicarboxylic acid (e.g., the compound (DC-3)) may be derivatized for use. Examples of a derivative of the dicarboxylic acid include dicarboxylic acid dichloride, dicarboxylic acid dimethyl ester, dicarboxylic acid diethyl ester, and dicarboxylic acid anhydride. Dicarboxylic acid dichloride is a compound in which two “—C(═O)—OH” groups of dicarboxylic acid are each replaced by a “—C(═O)—Cl” group.

Either or both a base and a catalyst may be added in condensation polymerization of the bisphenol and the dicarboxylic acid. Examples of the base include sodium hydroxide. Examples of the catalyst include benzyltributylammonium chloride, ammonium chloride, ammonium bromide, quaternary ammonium salt, triethylamine, and trimethylamine.

The photosensitive layer may contain only the polyarylate resin (PA) as the binder resin or further contain a binder resin other than the polyarylate resin (PA) (also referred to below as additional binder resin). Example of the additional binder resin include thermoplastic resins (specific examples include polyarylate resins other than the polyarylate resin (PA), polycarbonate resins, styrene-based resins, styrene-butadiene copolymers, styrene-acrylonitrile copolymers, styrene-maleic acid copolymers, styrene-acrylic acid copolymers, acrylic copolymers, polyethylene resins, ethylene-vinyl acetate copolymers, chlorinated polyethylene resins, polyvinyl chloride resins, polypropylene resins, ionomers, vinyl chloride-vinyl acetate copolymers, polyester resins, alkyd resins, polyamide resins, polyurethane resins, polysulfone resins, diallyl phthalate resins, ketone resins, polyvinyl butyral resins, polyvinyl acetal resins, and polyether resins), thermosetting resins (specific examples include silicone resins, epoxy resins, phenolic resins, urea resins, melamine resins, and cross-linkable thermosetting resin other than these), and photocurable resins (specific examples include epoxy-acrylic acid-based resins and urethane-acrylic acid-based copolymers).

(Resin Particles)

Preferably, the photosensitive layer further contains resin particles. The resin particles are contained for example as filler particles in the photosensitive layer. As a result of containing the resin particles together with the polyarylate resin (PA), the photosensitive layer can have increased elasticity, so that paper dust and an external additive of toner are hardly buried in the photosensitive layer. Accordingly, the external additive and paper dust attached to the photosensitive layer are favorably cleaned off to improve filming resistance of the photosensitive member. Furthermore, as a result of the photosensitive layer containing relatively hard resin particles, abrasion of the photosensitive layer by a cleaning member such as a cleaning blade and generation of scratches in the photosensitive layer can be inhibited. As a result, abrasion resistance and scratch resistance are improved.

The resin particles contained in the photosensitive layer can increase elasticity of the photosensitive layer as compared with non-resin particles (e.g., silica particles or alumina particles). Furthermore, the resin particles contained in the photosensitive layer can reduce surface frictional resistance of the photosensitive layer as compared with the non-resin particles. Moreover, the resin particles contained in the photosensitive layer hardly impair electrical characteristics of the photosensitive member as compared with the non-resin particles. Thus, filming resistance and abrasion resistance of the photosensitive member can be improved while the electrical characteristics of the photosensitive member are maintained as a result of the photosensitive layer containing the resin particles rather than non-resin particles.

The resin particles are preferably particles of a resin other than the binder resin, more preferably particles of a resin different from a polyarylate resin, and further more preferably silicone resin particles. When silicone resin particles with siloxane structure are contained, surface frictional resistance of the photosensitive layer can be further reduced and abrasion resistance of the photosensitive member can be further improved.

The resin particles have a volume median diameter (D₅₀) of preferably at least 0.05 μm, more preferably at least 0.50 μm, and further preferably at least 0.60 μm. By contrast, the resin particles have a volume median diameter (D₅₀) of preferably no greater than 5.00 μm, more preferably no greater than 3.00 μm, and further preferably no greater than 1.00 μm. As a result of the volume median diameter of the resin particles being set to at least 0.05 μm and no greater than 5.00 μm, abrasion resistance, filming resistance, and scratch resistance of the photosensitive member can be further improved.

The percentage content of the resin particles is preferably at least 0.01% by mass relative to the mass of the photosensitive layer, more preferably at least 0.5% by mass, further preferably at least 1.0% by mass, and particularly preferably at least 2.5% by mass. The percentage content of the resin particles is preferably no greater than 15.0% by mass relative to the mass of the photosensitive layer, more preferably no greater than 11.0% by mass, and further preferably no greater than 10.0% by mass. As a result of the percentage content of the resin particles being set to at least 0.01% by mass and no greater than 15.0% by mass relative to the mass of the photosensitive layer, abrasion resistance, filming resistance, and scratch resistance of the photosensitive member can be further improved. Furthermore, as a result of the percentage content of the resin particles being set to at least 0.01% by mass and no greater than 15.0% by mass relative to the mass of the photosensitive layer, production of image defects (e.g., stain such as black spots) due to surface roughness of the photosensitive member can be favorably inhibited.

Preferably, the resin particles are spherical in shape. Spherical resin particles hardly agglomerate in a solvent for photosensitive layer formation as compared with acicular resin particles. Therefore, a photosensitive layer in which the resin particles are dispersed uniformly can be formed favorably. The shape of the resin particles can be confirmed using an electron microscope.

(Dispersion Agent)

Preferably, the photosensitive layer further contains a dispersion agent. The dispersion agent includes either of compounds represented by formulas (30) and (31) (also referred to below as dispersion agents (30) and (31), respectively).

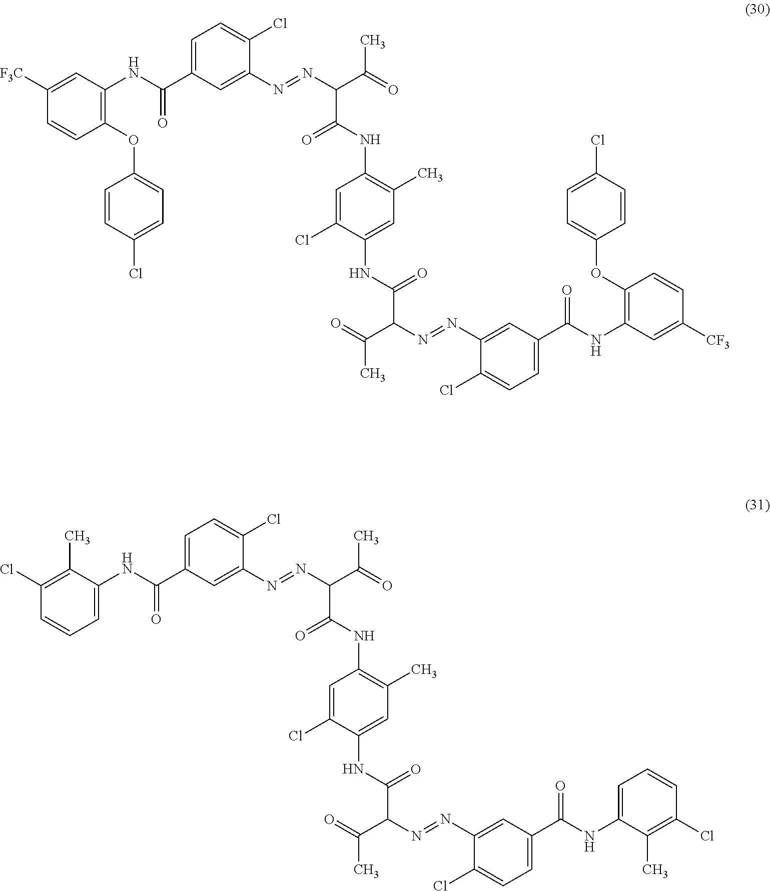 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C ; CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C]

As a result of the photosensitive layer containing the dispersion agent (30) or (31), photosensitivity of the photosensitive member is improved. It is preferable that the charge generating material contained in the photosensitive layer includes titanyl phthalocyanine, the photosensitive layer further contains a dispersion agent, and the dispersion agent includes the dispersion agent (30) or (31). As a result of the photosensitive layer containing titanyl phthalocyanine and the dispersion agent (30) or (31), photosensitivity of the photosensitive member is particularly improved. The reason thereof is presumed as follows. The dispersion agents (30) and (31) each have an electron-withdrawing group (e.g., a chloro group or a trifluoromethyl group). Titanyl phthalocyanine that is a charge generating material has an electron donating moiety (e.g., a TiO moiety). As such, the electron-withdrawing group of the dispersion agent (30) or (31) is withdrawn to the electron donating moiety of titanyl phthalocyanine. The withdrawn dispersion agent (30) or (31) aids dispersion of titanyl phthalocyanine in the photosensitive layer. When titanyl phthalocyanine is favorably dispersed in the photosensitive layer, photosensitivity of the photosensitive member is improved.

The content ratio of the dispersion agent is preferably at least 0.01 parts by mass and no greater than 10.00 parts by mass relative to 100.00 parts by mass of the binder resin, more preferably at least 0.10 parts by mass and no greater than 5.00 parts by mass, and further preferably at least 0.50 parts by mass and no greater than 3.00 parts by mass. The photosensitive layer may contain only one dispersion agent or contain two or more dispersion agents.

(Electron Transport Material)

Examples of the electron transport material include quinone-based compounds, diimide-based compounds, hydrazone-based compounds, malononitrile-based compounds, thiopyran-based compounds, trinitrothioxanthone-based compounds, 3,4,5,7-tetranitro-9-fluorenone-based compounds, dinitroanthracene-based compounds, dinitroacridine-based compounds, tetracyanoethylene, 2,4,8-trinitrothioxanthone, dinitrobenzene, dinitroacridine, succinic anhydride, maleic anhydride, and dibromomaleic anhydride. Examples of the quinone-based compounds include diphenoquinone-based compounds, azoquinone-based compounds, anthraquinone-based compounds, naphthoquinone-based compounds, nitroanthraquinone-based compounds, and dinitroanthraquinone-based compounds.

Preferable examples of the electron transport material include compounds represented by formulas (10), (11), (12), (13), (14), (15), and (16) (also referred to below as electron transport materials (10), (11), (12), (13), (14), (15), and (16), respectively). As a result of the photosensitive layer containing the electron transport material (10), (11), (12), (13), (14), (15), or (16) together with the polyarylate resin (PA), abrasion resistance of the photosensitive member is improved and filming resistance and scratch resistance of the photosensitive member are further improved.

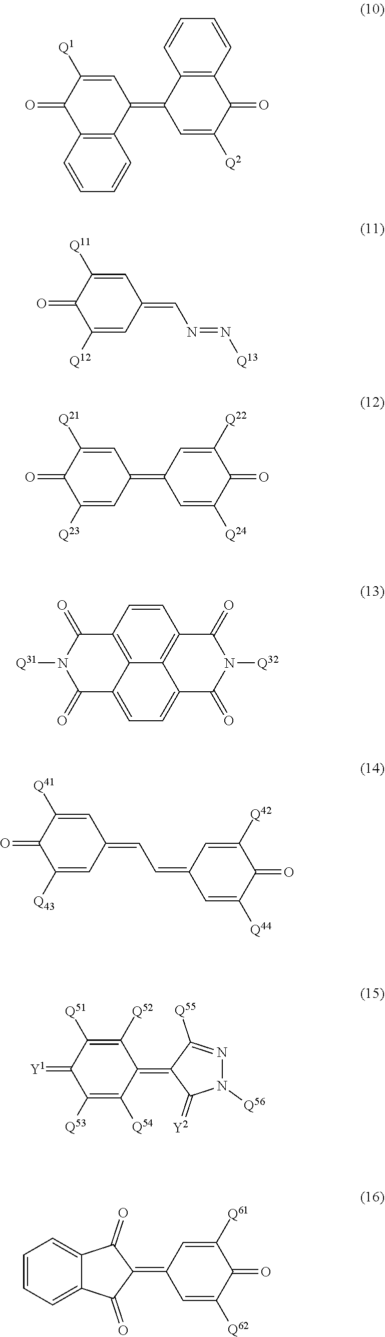

Q¹ and Q² in formula (10), Q¹¹, Q¹², and Q¹³ in formula (11), Q²¹, Q²², Q²³, and Q²⁴ in formula (12), Q³¹ and Q³² in formula (13), Q⁴¹, Q⁴², Q⁴³ and Q⁴⁴ in formula (14), Q⁵¹, Q⁵², Q⁵³, Q⁵⁴, Q⁵⁵ and Q⁵⁶ in formula (15), and Q⁶¹ and Q⁶² in formula (16) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6. Y¹ and Y² in formula (15) each represent, independently of one another, an oxygen atom or a sulfur atom.

Preferably, Q¹ and Q² in formula (10), Q¹¹ to Q¹³ in formula (11), Q²¹ to Q²⁴ in formula (12), Q³¹ and Q³² in formula (13), Q⁴¹ to Q⁴⁴ in formula (14), Q⁵¹ to Q⁵⁶ in formula (15), and Q⁶¹ and Q⁶² in formula (16) each represent, independently of one another, a hydrogen atom, an alkyl group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6. Preferably, Y¹ and Y² in formula (15) each represent an oxygen atom.

An alkyl group with a carbon number of at least 1 and no greater than 6 that is represented by any of Q¹ and Q² in formula (10), Q¹¹ to Q¹³ in formula (11), Q²¹ to Q²⁴ in formula (12), Q³¹ and Q³² in formula (13), Q⁴¹ to Q⁴⁴ in formula (14), Q⁵¹ to Q⁵⁶ in formula (15), and Q⁶¹ and Q⁶² in formula (16) is preferably an alkyl group with a carbon number of at least 1 and no greater than 5, more preferably a methyl group, an ethyl group, a propyl group, a butyl group, or a pentyl group, and particularly preferably a methyl group, an isopropyl group, a tert-butyl group, or a 1,1-dimethylpropyl group.

An aryl group with a carbon number of at least 6 and no greater than 14 that is represented by any of Q¹ and Q² in formula (10), Q¹¹ to Q¹³ in formula (11), Q²¹ to Q²⁴ in formula (12), Q³¹ and Q³² in formula (13), Q⁴¹ to Q⁴⁴ in formula (14), Q⁵¹ to Q⁵⁶ in formula (15), and Q⁶¹ and Q⁶² in formula (16) is preferably an aryl group with a carbon number of at least 6 and no greater than 10, and further preferably a phenyl group. The aryl group with a carbon number of at least 6 and no greater than 14 may be substituted with at least one substituent selected from the group consisting of a halogen atom and an alkyl group with a carbon number of at least 1 and no greater than 6. The alkyl group with a carbon number of at least 1 and no greater than 6 that is a substituent is preferably an alkyl group with a carbon number of at least 1 and no greater than 3, and more preferably a methyl group or an ethyl group. The halogen atom that is a substituent is preferably a fluorine atom, a chlorine atom, or a bromine atom, and particularly preferably a chlorine atom. When the aryl group with a carbon number of at least 6 and no greater than 14 is substituted, the number of the substituents is preferably at least 1 and no greater than 5, and more preferably 1 or 2. The aryl group with a carbon number of at least 6 and no greater than 14 substituted with at least one substituent selected from the group consisting of a halogen atom and an alkyl group with a carbon number of at least 1 and no greater than 6 is preferably a chlorophenyl group, a dichlorophenyl group, or an ethylmethylphenyl group, and more preferably a 4-chlorophenyl group, a 2,5-dichlorophenyl group, or a 2-ethyl-6-methyl phenyl group.

Preferably, the electron transport material includes the electron transport material (15), (12), (13), or (14). As a result of the photosensitive layer containing the electron transport material (15), (12), (13), or (14) together with the polyarylate resin (PA), abrasion resistance of the photosensitive member can be improved and transfer memory can be inhibited.

A preferable example of the electron transport material (10) is a compound represented by formula (E-4). A preferable example of the electron transport material (11) is a compound represented by formula (E-5). A preferable example of the electron transport material (12) is a compound represented by formula (E-7). A preferable example of the electron transport material (13) is a compound represented by formula (E-6). A preferable example of the electron transport material (14) is a compound represented by formula (E-8). Preferable examples of the electron transport material (15) include compounds represented by formulas (E-3) and (E-2). A preferable example of the electron transport material (16) is a compound represented by formula (E-1). In the following, the compounds represented by formulas (E-1) to (E-8) may be referred to as electron transport materials (E-1) to (E-8), respectively.

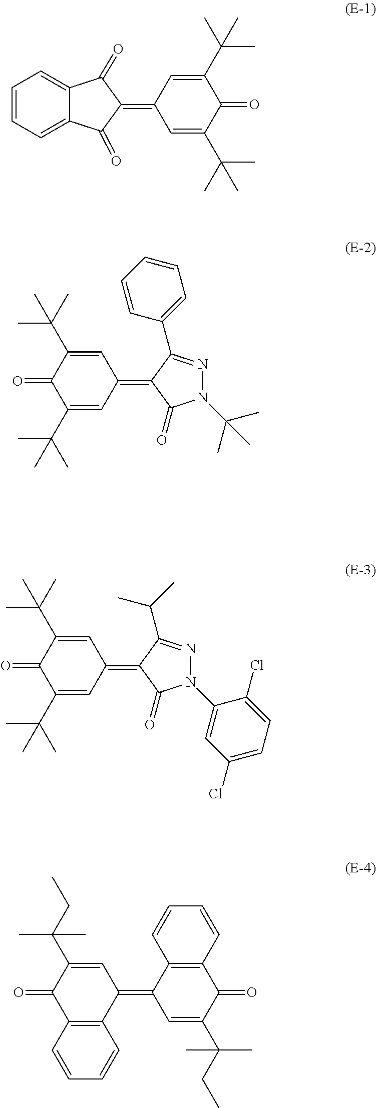 [SMILES: CC(C)(C)C1=CC(=C2C(=O)c3ccccc3C2=O)C=C(C(C)(C)C)C1=O ; CC(C)(C)C1=CC(=C2C(=O)N(C(C)(C)C)N=C2c2ccccc2)C=C(C(C)(C)C)C1=O ; CC(C)C1=NN(c2cc(Cl)ccc2Cl)C(=O)C1=C1C=C(C(C)(C)C)C(=O)C(C(C)(C)C)=C1 ; CCC(C)(C)C1=C/C(=C2/C=C(C(C)(C)CC)C(=O)c3ccccc32)c2ccccc2C1=O]

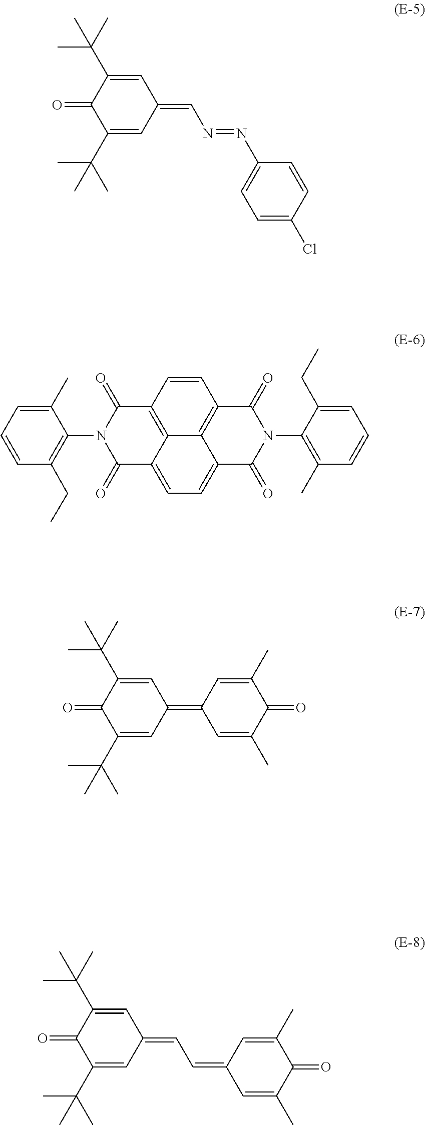 [SMILES: CC(C)(C)C1=CC(=C/N=N/c2ccc(Cl)cc2)C=C(C(C)(C)C)C1=O ; CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

In order to improve abrasion resistance of the photosensitive member and inhibit transfer memory, the electron transport material is preferably the electron transport material (E-2), (E-3), (E-6), (E-7), or (E-8).

The content ratio of the electron transport material is preferably at least 5 parts by mass and no greater than 150 parts by mass relative to 100 parts by mass of the binder resin, more preferably at least 10 parts by mass and no greater than 100 parts by mass, and further preferably at least 30 parts by mass and no greater than 70 parts by mass. The photosensitive layer may contain only one electron transport material or contain two or more electron transport materials.

(Hole Transport Material)

Example of the hole transport material include triphenylamine derivatives, diamine derivatives (e.g., an N,N,N′,N′-tetraphenylbenzidine derivative, an N,N,N′,N′-tetraphenylphenylenediamine derivative, an N,N,N′,N′-tetraphenylnaphtylenediamine derivative, an N,N,N′,N′-tetraphenylphenanthrylenediamine derivative, and a di(aminophenylethenyl)benzene derivative), oxadiazole-based compounds (e.g., 2,5-di(4-methylaminophenyl)-1,3,4-oxadiazole), styryl-based compounds (e.g., 9-(4-diethylaminostyryl) anthracene), carbazole-based compounds (e.g., polyvinyl carbazole), organic polysilane compounds, pyrazoline-based compounds (e.g., 1-phenyl-3-(p-dimethylaminophenyl)pyrazoline), hydrazone-based compounds, indole-based compounds, oxazole-based compounds, isoxazole-based compounds, thiazole-based compounds, thiadiazole-based compounds, imidazole-based compounds, pyrazole-based compounds, and triazole-based compounds.

Preferable examples of the hole transport material include compounds represented by formulas (20), (21), (22), (23), and (24) (also referred to below as hole transport materials (20), (21), (22), (23), and (24), respectively). As a result of the photosensitive layer containing the hole transport material (20), (21), (22), (23), or (24) together with the polyarylate resin (PA), abrasion resistance of the photosensitive member is improved, filming resistance and scratch resistance of the photosensitive member are further improved, and transfer memory can be inhibited.

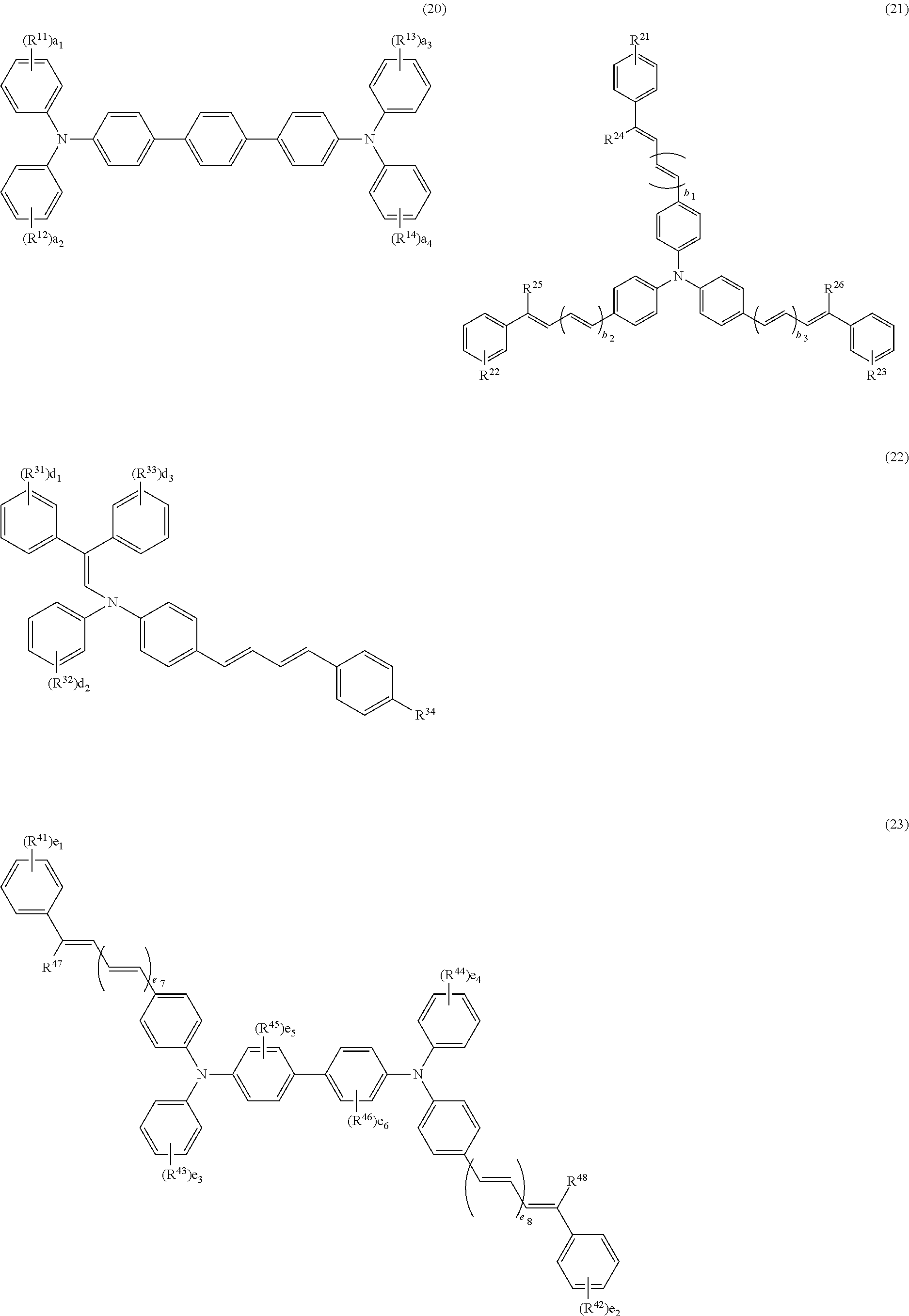

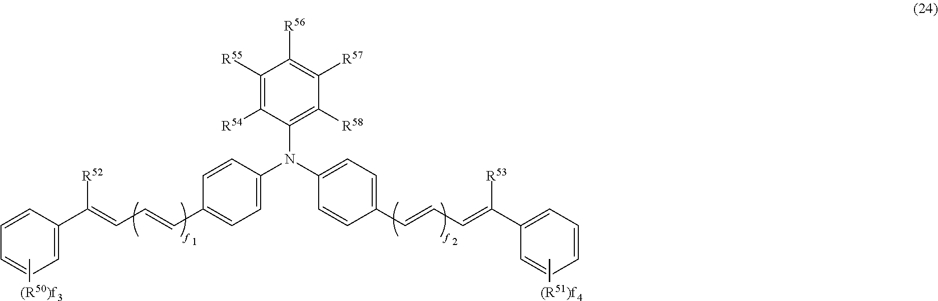

In formula (20), R¹¹, R¹², R¹³, and R¹⁴ each represent, independently of one another, an alkyl group with a carbon number of at least 1 and no greater than 6 or an alkoxy group with a carbon number of at least 1 and no greater than 6. a₁, a₂, a₃, and a₄ each represent, independently of one another, an integer of at least 0 and no greater than 5.

Where a₁ in formula (20) represents an integer of at least 2 and no greater than 5, chemical groups R¹¹ may represent the same group or different groups. Where a₂ represents an integer of at least 2 and no greater than 5, chemical groups R¹² may represent the same group or different groups. Where a₃ represents an integer of at least 2 and no greater than 5, chemical groups R¹³ may represent the same group or different groups. Where a₄ represents an integer of at least 2 and no greater than 5, chemical groups R¹⁴ may represent the same group or different groups.

In formula (20), R¹¹, R¹², R¹³, and R¹⁴ each represent, independently of one another, preferably an alkyl group with a carbon number of at least 1 and no greater than 3, and more preferably a methyl group or an ethyl group. a₁, a₂, a₃, and a₄ each represent, independently of one another, preferably an integer of at least 1 and no greater than 3, and more preferably represent 1.

In formula (21), R²¹, R²², and R²³ each represent, independently of one another, an alkyl group with a carbon number of at least 1 and no greater than 6. R²⁴, R²⁵, and R²⁶ each represent, independently of one another, a hydrogen atom or an alkyl group with a carbon number of at least 1 and no greater than 6. b₁, b₂, and b₃ each represent, independently of one another, 0 or 1.

In formula (21), R²¹, R²², and R²³ each represent, independently of one another, preferably an alkyl group with a carbon number of at least 1 and no greater than 3, and more preferably a methyl group. Preferably, R²¹, R²², and R²³ are bonded at the meta position of a phenyl group relative to an ethenyl group or a butadienyl group. Preferably, R²⁴, R²⁵, and R²⁶ each represent a hydrogen atom. Preferably, b₁, b₂, and b₃ each represent 0 or each represent 1.

In formula (22), R³¹, R³², and R³³ each represent, independently of one another, an alkyl group with a carbon number of at least 1 and no greater than 6. R³⁴ represents a hydrogen atom or an alkyl group with a carbon number of at least 1 and no greater than 6. d₁, d₂, and d₃ each represent, independently of one another, an integer of at least 0 and no greater than 5.

Where d₁ in formula (22) represents an integer of at least 2 and no greater than 5, chemical groups R³¹ may represent the same group or different groups. Where d₂ represents an integer of at least 2 and no greater than 5, chemical groups R³² may represent the same group or different groups. Where d₃ represents an integer of at least 2 and no greater than 5, chemical groups R³³ may represent the same group or different groups.

In formula (22), R³⁴ preferably represents a hydrogen atom. Preferably, d₁, d₂, and d₃ each represent 0.

In formula (23), R⁴¹, R⁴², R⁴³, R⁴⁴, R⁴⁵, and R⁴⁶ each represent, independently of one another, a phenyl group or an alkyl group with a carbon number of at least 1 and no greater than 6. R⁴⁷ and R⁴⁸ each represent, independently of one another, a hydrogen atom, a phenyl group, or an alkyl group with a carbon number of at least 1 and no greater than 6. e₁, e₂, e₃, and e₄ each represent, independently of one another, an integer of at least 0 and no greater than 5. e₅ and e₆ each represent, independently of one another, an integer of at least 0 and no greater than 4. e₇ and e₈ each represent, independently of one another, 0 or 1.

Where e₁ in formula (23) represents an integer of at least 2 and no greater than 5, chemical groups R⁴¹ may represent the same group or different groups. Where e₂ represents an integer of at least 2 and no greater than 5, chemical groups R⁴² may represent the same group or different groups. Where e₃ represents an integer of at least 2 and no greater than 5, chemical groups R⁴³ may represent the same group or different groups. Where e₄ represents an integer of at least 2 and no greater than 5, chemical groups R⁴⁴ may represent the same group or different groups. Where e₅ represents an integer of at least 2 and no greater than 4, chemical groups R⁴⁵ may represent the same group or different groups. Where e₆ represents an integer of at least 2 and no greater than 4, chemical groups R⁴⁶ may represent the same group or different groups.

In formula (23), R⁴¹ to R⁴⁶ each represent, independently of one another, preferably an alkyl group with a carbon number of at least 1 and no greater than 6, more preferably an alkyl group with a carbon number of at least 1 and no greater than 3, and further preferably a methyl group or an ethyl group. Preferably, R⁴⁷ and R⁴⁸ each represent a hydrogen atom. Preferably, e₁, e₂, e₃, and e₄ each represent, independently of one another, an integer of at least 0 and no greater than 2. It is more preferable that e₁ and e₂ each represent 0 while e₃ and e₄ each represent 2. Preferably, e₅ and e₆ each represent 0. It is preferable that e₇ and e₈ each represent 0 or each represent 1.

In formula (24), R⁵⁰ and R⁵¹ each represent, independently of one another, a phenyl group, an alkyl group with a carbon number of at least 1 and no greater than 6, or an alkoxy group with a carbon number of at least 1 and no greater than 6. R⁵², R⁵³, R⁵⁴, R⁵⁵ R⁵⁶, R⁵⁷, and R⁵⁸ each represent, independently of one another, a hydrogen atom, an alkyl group with a carbon number of at least 1 and no greater than 6, an alkoxy group with a carbon number of at least 1 and no greater than 6, or a phenyl group optionally substituted with an alkyl group with a carbon number of at least 1 and no greater than 6. f₁ and f₂ each represent, independently of one another, an integer of at least 0 and no greater than 2. f₃ and f₄ each represent, independently of one another, an integer of at least 0 and no greater than 5.

Where f₃ in formula (24) represents an integer of at least 2 and no greater than 5, chemical groups R⁵⁰ may represent the same group or different groups. Where f₄ represents an integer of at least 2 and no greater than 5, chemical groups R⁵¹ may represent the same group or different groups.

In formula (24), preferably, R⁵⁰ and R⁵¹ each represent, independently of one another, an alkyl group with a carbon number of at least 1 and no greater than 6. Preferably, R⁵² and R⁵³ each represent, independently of one another, a hydrogen atom or a phenyl group optionally substituted with an alkyl group with a carbon number of at least 1 and no greater than 6. Preferably, R⁵⁴ to R⁵⁸ each represent, independently of one another, a hydrogen atom, an alkyl group with a carbon number of at least 1 and no greater than 6, or an alkoxy group with a carbon number of at least 1 and no greater than 6. Preferably, f₁ and f₂ each represent 0, 1, or 2. Preferably, f₃ and f₄ each represent, independently of one another, an integer of 0 or 1.

An alkyl group with a carbon number of at least 1 and no greater than 6 that is represented by R⁵⁰ or R⁵¹ is preferably an alkyl group with a carbon number of at least 1 and no greater than 3, and more preferably a methyl group. A phenyl group optionally substituted with an alkyl group with a carbon number of at least 1 and no greater than 6 that is represented by R⁵² or R⁵³ is preferably a phenyl group or a phenyl group substituted with an alkyl group with a carbon number of at least 1 and no greater than 3. The phenyl group substituted with an alkyl group with a carbon number of at least 1 and no greater than 3 is preferably a methylphenyl group, and more preferably 4-methylphenyl group. An alkyl group with a carbon number of at least 1 and no greater than 6 that is represented by any of R⁵⁴ to R⁵⁸ is preferably an alkyl group with a carbon number of at least 1 and no greater than 4, and more preferably a methyl group, an ethyl group, or an n-butyl group. An alkoxy group with a carbon number of at least 1 and no greater than 6 that is represented by any of R⁵⁴ to R⁵⁸ is preferably an alkoxy group with a carbon number of at least 1 and no greater than 3, and more preferably an ethoxy group.

A preferable example of the hole transport material (20) is a compound represented by formula (H-11). Preferable examples of the hole transport material (21) include compounds represented by formulas (H-7) and (H-8). A preferable example of the hole transport material (22) is a compound represented by formula (H-6). Preferable examples of the hole transport material (23) include compounds represented by formulas (H-9) and (H-10). Preferable examples of the hole transport material (24) include compounds represented by formulas (H-1), (H-2), (H-5), (H-4), and (H-3). In the following, the compounds represented by formulas (H-1) to (H-11) may be referred to as hole transport materials (H-1) to (H-11), respectively.

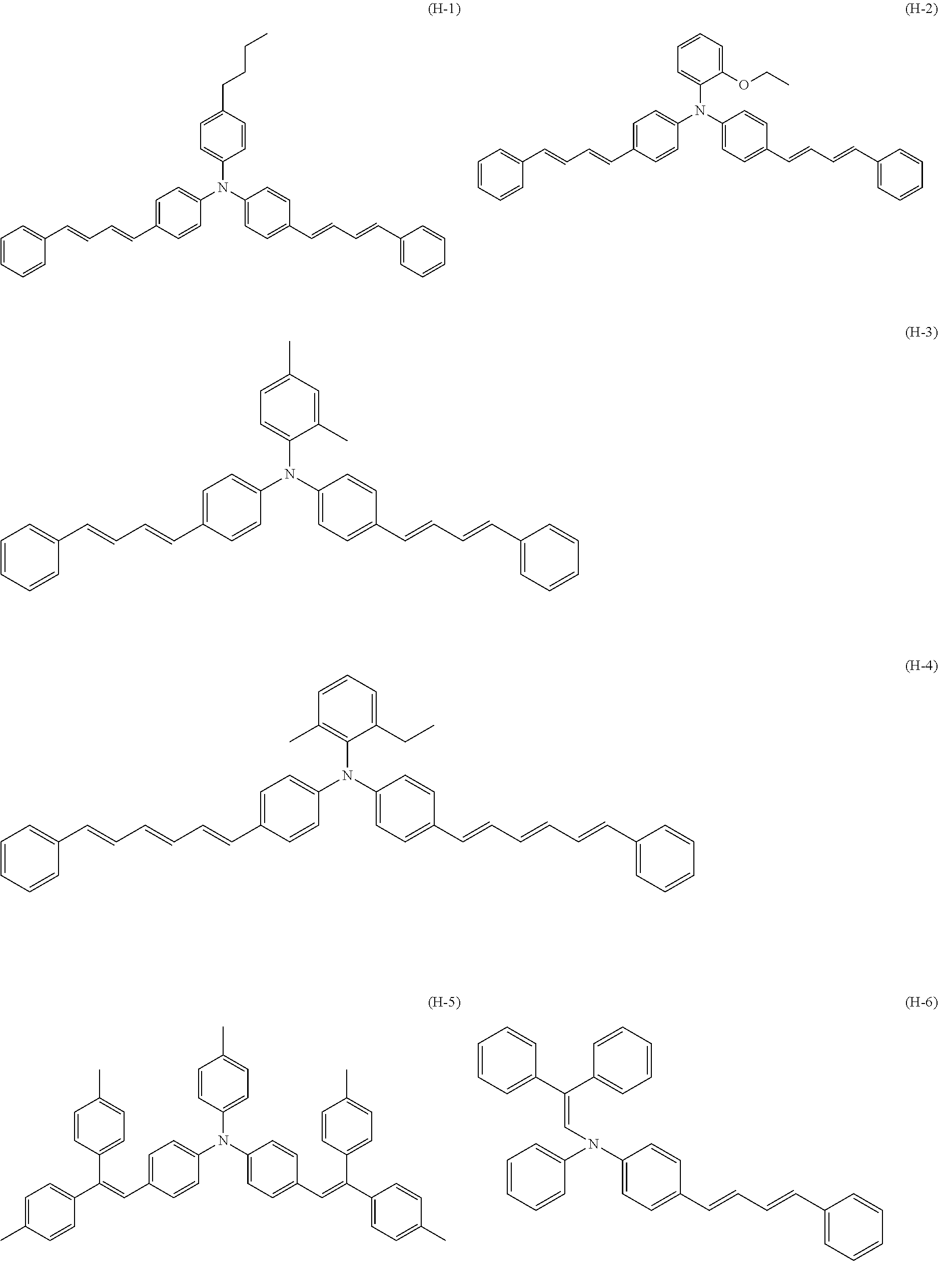

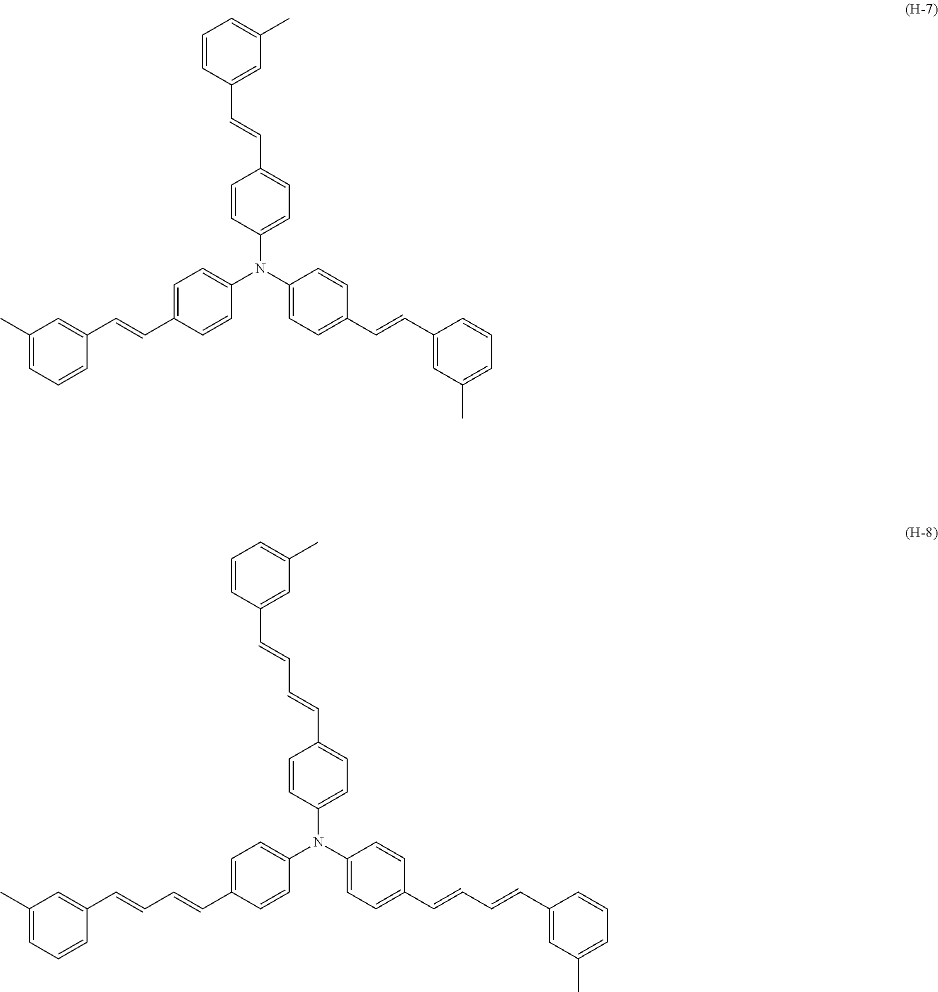 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

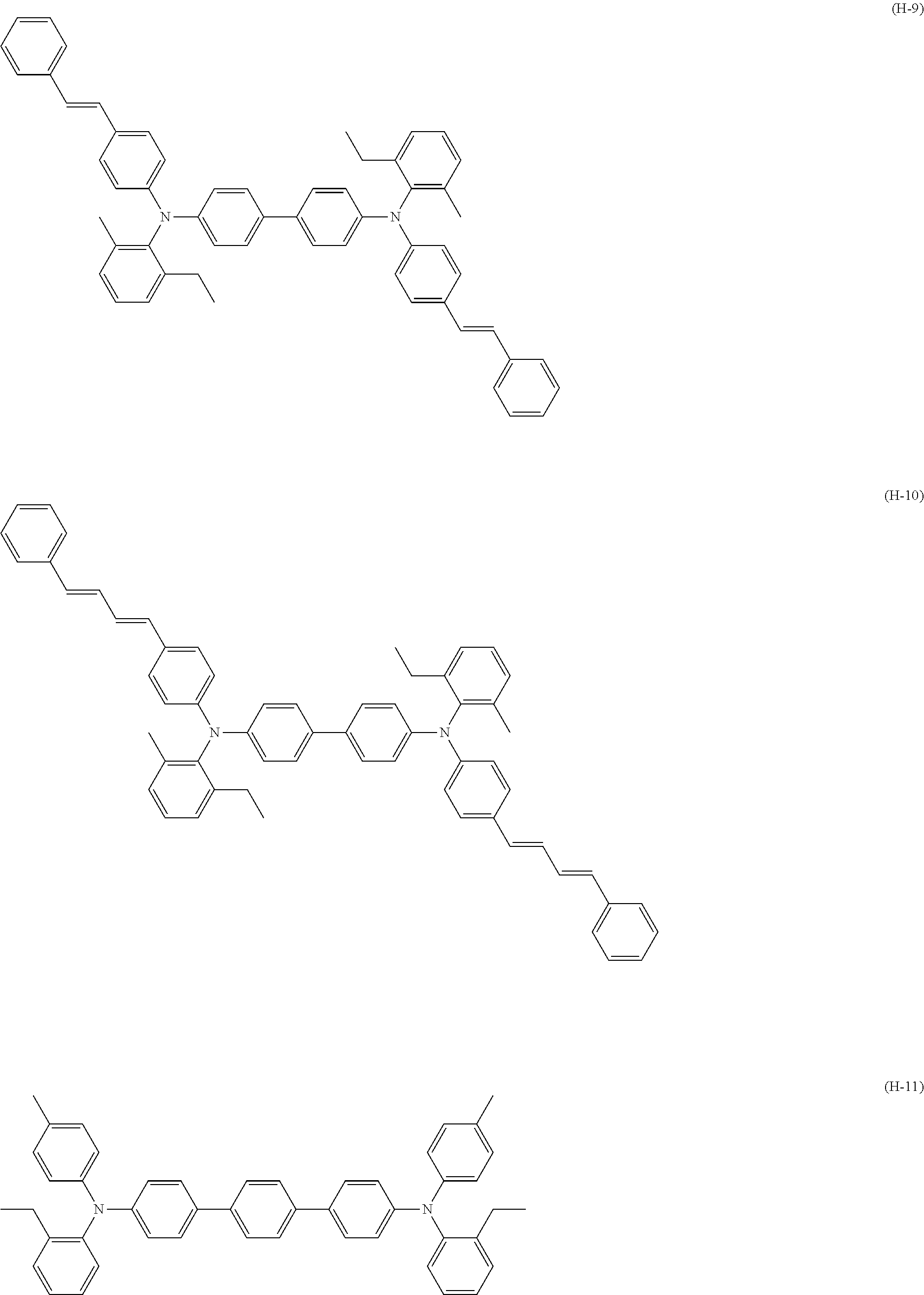 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

The content ratio of the hole transport material is preferably at least 10 parts by mass and no greater than 200 parts by mass relative to 100 parts by mass of the binder resin, more preferably at least 30 parts by mass and no greater than 120 parts by mass, and further preferably at least 50 parts by mass and no greater than 90 parts by mass. Furthermore, the photosensitive layer may contain only one hole transport material or contain two or more hole transport materials.

It is preferable that the hole transport material includes the hole transport material (20), (21), (22), (23), or (24) and the electron transport material includes the electron transport material (15), (12), (13), or (14). As a result of the photosensitive layer containing the hole transport material (20), (21), (22), (23), or (24) and the electron transport material (15), (12), (13), or (14) in addition to the polyarylate resin (PA), abrasion resistance of the photosensitive member can be improved and transfer memory can be inhibited.

(Additive)

The photosensitive layer may contain an additive as necessary. Examples of the additive include an ultraviolet absorbing agent, an antioxidant, a radical scavenger, a singlet quencher, a softener, a surface modifier, an extender, a thickener, a wax, a donor, a surfactant, a plasticizer, a sensitizer, and a leveling agent.

(Material Combination)

Preferable material combinations where the photosensitive layer includes the resin particles are shown in Tables 3 to 5. In order to improve abrasion resistance, filming resistance, and scratch resistance of the photosensitive member, it is preferable that the polyarylate resin is any of the polyarylate resins (PA-a) to (PA-e), (PA-1) to (PA-8), and (R-1) to (R-8) and the resin particles are silicone resin particles. For the same purpose as above, it is preferable that a combination of the electron transport material and the polyarylate resin is any of the combinations Nos. a-1 to a-12, b-1 to b-15, and c-1 to c-15 shown in Table 3 and the resin particles are silicone resin particles. For the same purpose as above, it is preferable that a combination of the hole transport material and the polyarylate resin is any of the combinations Nos. d-1 to d-15, e-1 to e-18, and f-1 to f-18 shown in Table 4 and the resin particles are silicon resin particles. For the same purpose as above, it is preferable that a combination of the electron transport material, the hole transport material, and the polyarylate resin is any of the combinations Nos. g-1 to g-25, h-1 to h-28, and i-1 to i-28 shown in Table 5 and the resin particles are silicone resin particles. For the same purpose as above, it is preferable that the photosensitive layer contains Y-form titanyl phthalocyanine that is a charge generating material and the materials of any of the above combinations. Note that “No.” in Tables 3 to 5 represents “combination No.”, “ETM” indicates “electron transport material”, “HTM” indicates “hole transport material”, “Resin” indicates “polyarylate resin”, and “H-2,6,4,7” indicates “hole transport material (H-2), (H-6), (H-4), or (H-7)”.

TABLE 3

| No. | ETM | Resin |
|---|---|---|
| a-1 | E-4 | PA-a |
| a-2 | E-4 | PA-b |
| a-3 | E-4 | PA-c |
| a-4 | E-4 | PA-d |
| a-5 | E-4 | PA-e |
| a-6 | E-3 | PA-b |
| a-7 | E-2 | PA-b |
| a-8 | E-1 | PA-b |
| a-9 | E-5 | PA-b |
| a-10 | E-6 | PA-b |
| a-11 | E-7 | PA-b |
| a-12 | E-8 | PA-b |
| b-1 | E-4 | PA-1 |
| b-2 | E-4 | PA-2 |
| b-3 | E-4 | PA-3 |
| b-4 | E-4 | PA-4 |
| b-5 | E-4 | PA-5 |
| b-6 | E-4 | PA-6 |
| b-7 | E-4 | PA-7 |
| b-8 | E-4 | PA-8 |
| b-9 | E-3 | PA-2 |
| b-10 | E-2 | PA-2 |
| b-11 | E-1 | PA-2 |
| b-12 | E-5 | PA-2 |
| b-13 | E-6 | PA-2 |
| b-14 | E-7 | PA-2 |
| b-15 | E-8 | PA-2 |
| c-1 | E-4 | R-1 |
| c-2 | E-4 | R-2 |
| c-3 | E-4 | R-3 |
| c-4 | E-4 | R-4 |
| c-5 | E-4 | R-5 |
| c-6 | E-4 | R-6 |
| c-7 | E-4 | R-7 |
| c-8 | E-4 | R-8 |
| c-9 | E-3 | R-2 |
| c-10 | E-2 | R-2 |
| c-11 | E-1 | R-2 |
| c-12 | E-5 | R-2 |
| c-13 | E-6 | R-2 |
| c-14 | E-7 | R-2 |
| c-15 | E-8 | R-2 |

TABLE 4

| No. | HTM | Resin |
|---|---|---|
| d-1 | H-1 | PA-a |
| d-2 | H-1 | PA-b |
| d-3 | H-1 | PA-c |
| d-4 | H-1 | PA-d |
| d-5 | H-1 | PA-e |
| d-6 | H-2 | PA-b |
| d-7 | H-5 | PA-b |
| d-8 | H-6 | PA-b |
| d-9 | H-4 | PA-b |
| d-10 | H-7 | PA-b |
| d-11 | H-8 | PA-b |
| d-12 | H-3 | PA-b |
| d-13 | H-9 | PA-b |
| d-14 | H-10 | PA-b |
| d-15 | H-11 | PA-b |
| e-1 | H-1 | PA-1 |
| e-2 | H-1 | PA-2 |
| e-3 | H-1 | PA-3 |
| e-4 | H-1 | PA-4 |
| e-5 | H-1 | PA-5 |
| e-6 | H-1 | PA-6 |
| e-7 | H-1 | PA-7 |
| e-8 | H-1 | PA-8 |
| e-9 | H-2 | PA-2 |
| e-10 | H-5 | PA-2 |
| e-11 | H-6 | PA-2 |
| e-12 | H-4 | PA-2 |
| e-13 | H-7 | PA-2 |
| e-14 | H-8 | PA-2 |
| e-15 | H-3 | PA-2 |
| e-16 | H-9 | PA-2 |
| e-17 | H-10 | PA-2 |
| e-18 | H-11 | PA-2 |
| f-1 | H-1 | R-1 |
| f-2 | H-1 | R-2 |
| f-3 | H-1 | R-3 |
| f-4 | H-1 | R-4 |
| f-5 | H-1 | R-5 |
| f-6 | H-1 | R-6 |
| f-7 | H-1 | R-7 |
| f-8 | H-1 | R-8 |
| f-9 | H-2 | R-2 |
| f-10 | H-5 | R-2 |
| f-11 | H-6 | R-2 |
| f-12 | H-4 | R-2 |
| f-13 | H-7 | R-2 |
| f-14 | H-8 | R-2 |
| f-15 | H-3 | R-2 |
| f-16 | H-9 | R-2 |
| f-17 | H-10 | R-2 |
| f-18 | H-11 | R-2 |

TABLE 5

| No. | ETM | HTM | Resin |
|---|---|---|---|
| g-1 | E-4 | H-1 | PA-a |
| g-2 | E-4 | H-1 | PA-b |
| g-3 | E-4 | H-1 | PA-c |
| g-4 | E-4 | H-1 | PA-d |
| g-5 | E-4 | H-1 | PA-e |
| g-6 | E-3 | H-1 | PA-b |
| g-7 | E-2 | H-1 | PA-b |
| g-8 | E-1 | H-1 | PA-b |
| g-9 | E-5 | H-1 | PA-b |
| g-10 | E-6 | H-1 | PA-b |
| g-11 | E-7 | H-1 | PA-b |
| g-12 | E-8 | H-1 | PA-b |
| g-13 | E-4 | H-2 | PA-b |
| g-14 | E-4 | H-5 | PA-b |
| g-15 | E-4 | H-6 | PA-b |
| g-16 | E-4 | H-4 | PA-b |
| g-17 | E-4 | H-7 | PA-b |
| g-18 | E-4 | H-8 | PA-b |
| g-19 | E-4 | H-3 | PA-b |
| g-20 | E-4 | H-9 | PA-b |
| g-21 | E-4 | H-10 | PA-b |
| g-22 | E-4 | H-11 | PA-b |
| g-23 | E-2 | H-2, 6, 4, 7 | PA-b |
| g-24 | E-1 | H-2, 6, 4, 7 | PA-b |
| g-25 | E-5 | H-2, 6, 4, 7 | PA-b |
| h-1 | E-4 | H-1 | PA-1 |
| h-2 | E-4 | H-1 | PA-2 |
| h-3 | E-4 | H-1 | PA-3 |
| h-4 | E-4 | H-1 | PA-4 |
| h-5 | E-4 | H-1 | PA-5 |
| h-6 | E-4 | H-1 | PA-6 |
| h-7 | E-4 | H-1 | PA-7 |
| h-8 | E-4 | H-1 | PA-8 |
| h-9 | E-3 | H-1 | PA-2 |
| h-10 | E-2 | H-1 | PA-2 |
| h-11 | E-1 | H-1 | PA-2 |
| h-12 | E-5 | H-1 | PA-2 |
| h-13 | E-6 | H-1 | PA-2 |
| h-14 | E-7 | H-1 | PA-2 |
| h-15 | E-8 | H-1 | PA-2 |
| h-16 | E-4 | H-2 | PA-2 |
| h-17 | E-4 | H-5 | PA-2 |
| h-18 | E-4 | H-6 | PA-2 |
| h-19 | E-4 | H-4 | PA-2 |
| h-20 | E-4 | H-7 | PA-2 |
| h-21 | E-4 | H-8 | PA-2 |
| h-22 | E-4 | H-3 | PA-2 |
| h-23 | E-4 | H-9 | PA-2 |
| h-24 | E-4 | H-10 | PA-2 |
| h-25 | E-4 | H-11 | PA-2 |
| h-26 | E-2 | H-2, 6, 4, 7 | PA-2 |
| h-27 | E-1 | H-2, 6, 4, 7 | PA-2 |
| h-28 | E-5 | H-2, 6, 4, 7 | PA-2 |
| i-1 | E-4 | H-1 | R-1 |
| i-2 | E-4 | H-1 | R-2 |
| i-3 | E-4 | H-1 | R-3 |
| i-4 | E-4 | H-1 | R-4 |
| i-5 | E-4 | H-1 | R-5 |
| i-6 | E-4 | H-1 | R-6 |
| i-7 | E-4 | H-1 | R-7 |
| i-8 | E-4 | H-1 | R-8 |
| i-9 | E-3 | H-1 | R-2 |
| i-10 | E-2 | H-1 | R-2 |
| i-11 | E-1 | H-1 | R-2 |
| i-12 | E-5 | H-1 | R-2 |
| i-13 | E-6 | H-1 | R-2 |
| i-14 | E-7 | H-1 | R-2 |
| i-15 | E-8 | H-1 | R-2 |
| i-16 | E-4 | H-2 | R-2 |
| i-17 | E-4 | H-5 | R-2 |
| i-18 | E-4 | H-6 | R-2 |
| i-19 | E-4 | H-4 | R-2 |
| i-20 | E-4 | H-7 | R-2 |
| i-21 | E-4 | H-8 | R-2 |
| i-22 | E-4 | H-3 | R-2 |
| i-23 | E-4 | H-9 | R-2 |
| i-24 | E-4 | H-10 | R-2 |
| i-25 | E-4 | H-11 | R-2 |
| i-26 | E-2 | H-2, 6, 4, 7 | R-2 |
| i-27 | E-1 | H-2, 6, 4, 7 | R-2 |
| i-28 | E-5 | H-2, 6, 4, 7 | R-2 |

In order to improve transfer memory inhibition and abrasion resistance, filming resistance, and scratch resistance of the photosensitive member, the combination of the electron transport material, the hole transport material, and the polyarylate resin is preferably any of combinations Nos. a2-1 to a2-22 shown in Table 6, combinations Nos. b2-1 to b2-25 shown in Table 7, and combinations Nos. c2-1 to c2-25 shown in table 8. For the same purpose as above, it is more preferable that the combination of the electron transport material, the hole transport material, and the polyarylate resin is any of combinations Nos. a2-1 to a2-22 shown in Table 6, combinations Nos. b2-1 to b2-25 shown in Table 7, and combinations Nos. c2-1 to c2-25 shown in table 8 and the charge generating material is Y-form titanyl phthalocyanine. In Tables 6 to 8, “No.” indicates “combination No.”, “ETM” indicates “electron transport material”, “HTM” indicates “hole transport material”, and “Resin” indicates “polyarylate resin”.

TABLE 6

| No. | ETM | HTM | Resin |
|---|---|---|---|
| a2-1 | E-2 | H-1 | PA-a |
| a2-2 | E-2 | H-1 | PA-c |
| a2-3 | E-2 | H-1 | PA-d |
| a2-4 | E-2 | H-1 | PA-e |
| a2-5 | E-2 | H-1 | PA-b |
| a2-6 | E-3 | H-1 | PA-b |
| a2-7 | E-6 | H-1 | PA-b |
| a2-8 | E-7 | H-1 | PA-b |
| a2-9 | E-8 | H-1 | PA-b |
| a2-10 | E-2 | H-2 | PA-b |
| a2-11 | E-2 | H-3 | PA-b |
| a2-12 | E-2 | H-4 | PA-b |
| a2-13 | E-2 | H-5 | PA-b |
| a2-14 | E-2 | H-6 | PA-b |
| a2-15 | E-2 | H-7 | PA-b |
| a2-16 | E-2 | H-8 | PA-b |
| a2-17 | E-2 | H-9 | PA-b |
| a2-18 | E-2 | H-10 | PA-b |
| a2-19 | E-2 | H-11 | PA-b |
| a2-20 | E-3 | H-5 | PA-b |
| a2-21 | E-3 | H-6 | PA-b |
| a2-22 | E-3 | H-8 | PA-b |

TABLE 7

| No. | ETM | HTM | Resin |
|---|---|---|---|
| b2-1 | E-2 | H-1 | PA-1 |
| b2-2 | E-2 | H-1 | PA-2 |
| b2-3 | E-2 | H-1 | PA-3 |
| b2-4 | E-2 | H-1 | PA-4 |
| b2-5 | E-2 | H-1 | PA-5 |
| b2-6 | E-2 | H-1 | PA-6 |
| b2-7 | E-2 | H-1 | PA-7 |
| b2-8 | E-2 | H-1 | PA-8 |
| b2-9 | E-3 | H-1 | PA-2 |
| b2-10 | E-6 | H-1 | PA-2 |
| b2-11 | E-7 | H-1 | PA-2 |
| b2-12 | E-8 | H-1 | PA-2 |
| b2-13 | E-2 | H-2 | PA-2 |
| b2-14 | E-2 | H-3 | PA-2 |
| b2-15 | E-2 | H-4 | PA-2 |
| b2-16 | E-2 | H-5 | PA-2 |
| b2-17 | E-2 | H-6 | PA-2 |
| b2-18 | E-2 | H-7 | PA-2 |
| b2-19 | E-2 | H-8 | PA-2 |
| b2-20 | E-2 | H-9 | PA-2 |
| b2-21 | E-2 | H-10 | PA-2 |
| b2-22 | E-2 | H-11 | PA-2 |
| b2-23 | E-3 | H-5 | PA-7 |
| b2-24 | E-3 | H-6 | PA-7 |
| b2-25 | E-3 | H-8 | PA-7 |

TABLE 8

| No. | ETM | HTM | Resin |
|---|---|---|---|
| c2-1 | E-2 | H-1 | R-1 |
| c2-2 | E-2 | H-1 | R-2 |
| c2-3 | E-2 | H-1 | R-3 |
| c2-4 | E-2 | H-1 | R-4 |
| c2-5 | E-2 | H-1 | R-5 |
| c2-6 | E-2 | H-1 | R-6 |
| c2-7 | E-2 | H-1 | R-7 |
| c2-8 | E-2 | H-1 | R-8 |
| c2-9 | E-3 | H-1 | R-2 |
| c2-10 | E-6 | H-1 | R-2 |
| c2-11 | E-7 | H-1 | R-2 |
| c2-12 | E-8 | H-1 | R-2 |
| c2-13 | E-2 | H-2 | R-2 |
| c2-14 | E-2 | H-3 | R-2 |
| c2-15 | E-2 | H-4 | R-2 |
| c2-16 | E-2 | H-5 | R-2 |
| c2-17 | E-2 | H-6 | R-2 |
| c2-18 | E-2 | H-7 | R-2 |
| c2-19 | E-2 | H-8 | R-2 |
| c2-20 | E-2 | H-9 | R-2 |
| c2-21 | E-2 | H-10 | R-2 |
| c2-22 | E-2 | H-11 | R-2 |
| c2-23 | E-3 | H-5 | R-7 |
| c2-24 | E-3 | H-6 | R-7 |
| c2-25 | E-3 | H-8 | R-7 |

Preferable material combinations where the photosensitive layer contains a dispersion agent are shown in Tables 9 to 11. In order to improve abrasion resistance, filming resistance, and scratch resistance of the photosensitive member, it is preferable that the polyarylate resin is any of the polyarylate resins (PA-a) to (PA-e), (PA-1) to (PA-8), and (R-1) to (R-8) and the dispersion agent is the dispersion agent (30). For the same purpose as above, it is preferable that the polyarylate resin is any of the polyarylate resins (PA-a) to (PA-e), (PA-1) to (PA-8), and (R-1) to (R-8) and the dispersion agent is the dispersion agent (31). For the same purpose as above, the combination of the electron transport material and the polyarylate resin is any of the combinations Nos. a3-1 to a3-14, b3-1 to b3-17, and c3-1 to c3-17 shown in Table 9 and the dispersion agent is the dispersion agent (30) or (31). For the same purpose as above, the combination of the hole transport material and the polyarylate resin is any of the combinations Nos. d3-1 to d3-17, e3-1 to e3-20, and f3-1 to f3-20 shown in Table 10 and the dispersion agent is the dispersion agent (30) or (31). For the same purpose as above, the combination of the electron transport material, the hole transport material, and the polyarylate resin is any of the combinations Nos. g3-1 to g3-24, h3-1 to h3-27, and i3-1 to i3-27 shown in Table 11 and the dispersion agent is the dispersion agent (30) or (31). For the same purpose as above, it is preferable that the photosensitive layer contains the materials of any of the above combinations and Y-form titanyl phthalocyanine that is a charge generating material. Note that “No.” in Tables 9 to 11 represents “combination No.”, “ETM” indicates “electron transport material”, “HTM” indicates “hole transport material”, and “Resin” indicates “polyarylate resin”.

TABLE 9

| No. | ETM | Resin |
|---|---|---|
| a3-1 | E-1 | PA-a |
| a3-2 | E-2 | PA-a |
| a3-3 | E-3 | PA-a |
| a3-4 | E-4 | PA-a |
| a3-5 | E-5 | PA-a |
| a3-6 | E-6 | PA-a |
| a3-7 | E-7 | PA-a |
| a3-8 | E-8 | PA-a |
| a3-9 | E-4 | PA-b |
| a3-10 | E-1 | PA-b |
| a3-11 | E-1 | PA-c |
| a3-12 | E-1 | PA-d |
| a3-13 | E-1 | PA-e |
| a3-14 | E-4 | PA-c |
| b3-1 | E-1 | PA-1 |
| b3-2 | E-2 | PA-1 |
| b3-3 | E-3 | PA-1 |
| b3-4 | E-4 | PA-1 |
| b3-5 | E-5 | PA-1 |
| b3-6 | E-6 | PA-1 |
| b3-7 | E-7 | PA-1 |
| b3-8 | E-8 | PA-1 |
| b3-9 | E-4 | PA-2 |
| b3-10 | E-1 | PA-2 |
| b3-11 | E-1 | PA-3 |
| b3-12 | E-1 | PA-4 |
| b3-13 | E-1 | PA-5 |
| b3-14 | E-1 | PA-6 |
| b3-15 | E-1 | PA-7 |
| b3-16 | E-1 | PA-8 |
| b3-17 | E-4 | PA-3 |
| c3-1 | E-1 | R-1 |
| c3-2 | E-2 | R-1 |
| c3-3 | E-3 | R-1 |
| c3-4 | E-4 | R-1 |
| c3-5 | E-5 | R-1 |
| c3-6 | E-6 | R-1 |
| c3-7 | E-7 | R-1 |
| c3-8 | E-8 | R-1 |
| c3-9 | E-4 | R-2 |
| c3-10 | E-1 | R-2 |
| c3-11 | E-1 | R-3 |
| c3-12 | E-1 | R-4 |
| c3-13 | E-1 | R-5 |
| c3-14 | E-1 | R-6 |
| c3-15 | E-1 | R-7 |
| c3-16 | E-1 | R-8 |
| c3-17 | E-4 | R-3 |

TABLE 10

| No. | HTM | Resin |
|---|---|---|
| d3-1 | H-1 | PA-a |
| d3-2 | H-2 | PA-a |
| d3-3 | H-3 | PA-a |
| d3-4 | H-4 | PA-a |
| d3-5 | H-5 | PA-a |
| d3-6 | H-6 | PA-a |
| d3-7 | H-7 | PA-a |
| d3-8 | H-8 | PA-a |
| d3-9 | H-9 | PA-a |
| d3-10 | H-10 | PA-a |
| d3-11 | H-11 | PA-a |
| d3-12 | H-11 | PA-b |
| d3-13 | H-1 | PA-b |
| d3-14 | H-1 | PA-c |
| d3-15 | H-1 | PA-d |
| d3-16 | H-1 | PA-e |
| d3-17 | H-11 | PA-c |
| e3-1 | H-1 | PA-1 |
| e3-2 | H-2 | PA-1 |
| e3-3 | H-3 | PA-1 |
| e3-4 | H-4 | PA-1 |
| e3-5 | H-5 | PA-1 |
| e3-6 | H-6 | PA-1 |
| e3-7 | H-7 | PA-1 |
| e3-8 | H-8 | PA-1 |
| e3-9 | H-9 | PA-1 |
| e3-10 | H-10 | PA-1 |
| e3-11 | H-11 | PA-1 |
| e3-12 | H-11 | PA-2 |
| e3-13 | H-1 | PA-2 |
| e3-14 | H-1 | PA-3 |
| e3-15 | H-1 | PA-4 |
| e3-16 | H-1 | PA-5 |
| e3-17 | H-1 | PA-6 |
| e3-18 | H-1 | PA-7 |
| e3-19 | H-1 | PA-8 |
| e3-20 | H-11 | PA-3 |
| f3-1 | H-1 | R-1 |
| f3-2 | H-2 | R-1 |
| f3-3 | H-3 | R-1 |
| f3-4 | H-4 | R-1 |
| f3-5 | H-5 | R-1 |
| f3-6 | H-6 | R-1 |
| f3-7 | H-7 | R-1 |
| f3-8 | H-8 | R-1 |
| f3-9 | H-9 | R-1 |
| f3-10 | H-10 | R-1 |
| f3-11 | H-11 | R-1 |
| f3-12 | H-11 | R-2 |
| f3-13 | H-1 | R-2 |
| f3-14 | H-1 | R-3 |
| f3-15 | H-1 | R-4 |
| f3-16 | H-1 | R-5 |
| f3-17 | H-1 | R-6 |
| f3-18 | H-1 | R-7 |
| f3-19 | H-1 | R-8 |
| f3-20 | H-11 | R-3 |

TABLE 11

| No. | HTM | ETM | Resin |
|---|---|---|---|
| g3-1 | H-1 | E-1 | PA-a |
| g3-2 | H-1 | E-2 | PA-a |
| g3-3 | H-1 | E-3 | PA-a |
| g3-4 | H-1 | E-4 | PA-a |
| g3-5 | H-1 | E-5 | PA-a |
| g3-6 | H-1 | E-6 | PA-a |
| g3-7 | H-1 | E-7 | PA-a |
| g3-8 | H-1 | E-8 | PA-a |
| g3-9 | H-2 | E-4 | PA-a |
| g3-10 | H-3 | E-4 | PA-a |
| g3-11 | H-4 | E-4 | PA-a |
| g3-12 | H-5 | E-4 | PA-a |
| g3-13 | H-6 | E-4 | PA-a |
| g3-14 | H-7 | E-4 | PA-a |
| g3-15 | H-8 | E-4 | PA-a |
| g3-16 | H-9 | E-4 | PA-a |
| g3-17 | H-10 | E-4 | PA-a |
| g3-18 | H-11 | E-4 | PA-a |
| g3-19 | H-11 | E-4 | PA-b |
| g3-20 | H-1 | E-1 | PA-b |
| g3-21 | H-1 | E-1 | PA-c |
| g3-22 | H-1 | E-1 | PA-d |
| g3-23 | H-1 | E-1 | PA-e |
| g3-24 | H-11 | E-4 | PA-c |
| h3-1 | H-1 | E-1 | PA-1 |
| h3-2 | H-1 | E-2 | PA-1 |
| h3-3 | H-1 | E-3 | PA-1 |
| h3-4 | H-1 | E-4 | PA-1 |
| h3-5 | H-1 | E-5 | PA-1 |
| h3-6 | H-1 | E-6 | PA-1 |
| h3-7 | H-1 | E-7 | PA-1 |
| h3-8 | H-1 | E-8 | PA-1 |
| h3-9 | H-2 | E-4 | PA-1 |
| h3-10 | H-3 | E-4 | PA-1 |
| h3-11 | H-4 | E-4 | PA-1 |
| h3-12 | H-5 | E-4 | PA-1 |
| h3-13 | H-6 | E-4 | PA-1 |
| h3-14 | H-7 | E-4 | PA-1 |
| h3-15 | H-8 | E-4 | PA-1 |
| h3-16 | H-9 | E-4 | PA-1 |
| h3-17 | H-10 | E-4 | PA-1 |
| h3-18 | H-11 | E-4 | PA-1 |
| h3-19 | H-11 | E-4 | PA-2 |
| h3-20 | H-1 | E-1 | PA-2 |
| h3-21 | H-1 | E-1 | PA-3 |
| h3-22 | H-1 | E-1 | PA-4 |
| h3-23 | H-1 | E-1 | PA-5 |
| h3-24 | H-1 | E-1 | PA-6 |
| h3-25 | H-1 | E-1 | PA-7 |
| h3-26 | H-1 | E-1 | PA-8 |
| h3-27 | H-11 | E-4 | PA-3 |
| i3-1 | H-1 | E-1 | R-1 |
| i3-2 | H-1 | E-2 | R-1 |
| i3-3 | H-1 | E-3 | R-1 |
| i3-4 | H-1 | E-4 | R-1 |
| i3-5 | H-1 | E-5 | R-1 |
| i3-6 | H-1 | E-6 | R-1 |
| i3-7 | H-1 | E-7 | R-1 |
| i3-8 | H-1 | E-8 | R-1 |
| i3-9 | H-2 | E-4 | R-1 |
| i3-10 | H-3 | E-4 | R-1 |
| i3-11 | H-4 | E-4 | R-1 |
| i3-12 | H-5 | E-4 | R-1 |
| i3-13 | H-6 | E-4 | R-1 |
| i3-14 | H-7 | E-4 | R-1 |
| i3-15 | H-8 | E-4 | R-1 |
| i3-16 | H-9 | E-4 | R-1 |
| i3-17 | H-10 | E-4 | R-1 |
| i3-18 | H-11 | E-4 | R-1 |
| i3-19 | H-11 | E-4 | R-2 |
| i3-20 | H-1 | E-1 | R-2 |
| i3-21 | H-1 | E-1 | R-3 |
| i3-22 | H-1 | E-1 | R-4 |
| i3-23 | H-1 | E-1 | R-5 |
| i3-24 | H-1 | E-1 | R-6 |
| i3-25 | H-1 | E-1 | R-7 |
| i3-26 | H-1 | E-1 | R-8 |
| i3-27 | H-11 | E-4 | R-3 |

(Conductive Substrate)

No particular limitations are placed on the photosensitive member other than being a conductive substrate that can be used in a photosensitive member. It is only required that at least a surface portion of the conductive substrate be constituted by a conductive material. One example of the conductive substrate is a conductive substrate constituted by a conductive material. Another example of the conductive substrate is a conductive substrate covered with a conductive material. Examples of the conductive material include aluminum, iron, copper, tin, platinum, silver, vanadium, molybdenum, chromium, cadmium, titanium, nickel, palladium, indium, stainless steel, and brass. Of these conductive materials, aluminum or aluminum alloy is preferable in terms of favorable charge mobility from the photosensitive layer to the conductive substrate.

The shape of the conductive substrate is appropriately selected according to the configuration of an image forming apparatus. The conductive substrate may be sheet-shaped or drum-shaped, for example. Furthermore, the thickness of the conductive substrate is selected as appropriate according to the shape of the conductive substrate.

(Intermediate Layer)

The intermediate layer (undercoat layer) contains inorganic particles and a resin (intermediate layer resin) for intermediate layer use. Provision of the intermediate layer facilitates flow of current generated when the photosensitive member is exposed to light and inhibits increasing resistance, while also maintaining insulation to a sufficient degree so as to inhibit occurrence of leakage current.

Examples of the inorganic particles include particles of metals (e.g., aluminum, iron, and copper), particles of metal oxides (e.g., titanium oxide, alumina, zirconium oxide, tin oxide, and zinc oxide), and particles of non-metal oxides (e.g., silica).

Examples of the intermediate layer resin are the same as the examples of the additional binder resin described previously. In order to favorably form the intermediate layer and the photosensitive layer, the intermediate layer resin is preferably different from the binder resin contained in the photosensitive layer. The intermediate layer may contain an additive. Examples of the additive that may be contained in the intermediate layer are the same as the example of the additive that may be contained in the photosensitive layer.

(Photosensitive Member Production Method)

An example of a photosensitive member production method is described next. The photosensitive member production method includes a photosensitive layer formation process. In the photosensitive layer formation process, an application liquid for forming a photosensitive layer (also referred to below as application liquid for photosensitive layer formation) is prepared. The application liquid for photosensitive layer formation is applied onto a conductive substrate. Next, at least a portion of a solvent contained in the applied application liquid for photosensitive layer formation is removed to form a photosensitive layer. The application liquid for photosensitive layer formation contains a charge generating material, a hole transport material, an electron transport material, a binder resin, and the solvent, for example. The application liquid for photosensitive layer formation is prepared by dissolving or dispersing the charge generating material, the hole transport material, the electron transport material, and the binder resin in the solvent.

No particular limitations are placed on the solvent contained in the application liquid for photosensitive layer formation so long as the solvent is capable of dissolving or dispersing each component contained in the application liquid for photosensitive layer formation. Examples of the solvent include alcohols (specific examples include methanol, ethanol, isopropanol, and butanol), aliphatic hydrocarbons (specific examples include n-hexane, octane, and cyclohexane), aromatic hydrocarbons (specific examples include benzene, toluene, and xylene), halogenated hydrocarbons (specific examples include dichloromethane, dichloroethane, carbon tetrachloride, and chlorobenzene), ethers (specific examples include dimethyl ether, diethyl ether, tetrahydrofuran, ethylene glycol dimethyl ether, and diethylene glycol dimethyl ether), ketones (specific examples include acetone, methyl ethyl ketone, and cyclohexanone), esters (specific examples include ethyl acetate and methyl acetate), dimethyl formaldehyde, dimethyl formamide, and dimethyl sulfoxide.

The application liquid for photosensitive layer formation is prepared by mixing each component and dispersing the component in the solvent. Mixing or dispersion can be performed for example using a bead mill, a roll mill, a ball mill, an attritor, a paint shaker, a rod-shaped sonic oscillator, or an ultrasonic disperser.

No particular limitations are placed on an application method of the application liquid for photosensitive layer formation so long as the method enables uniform application of the application liquid for photosensitive layer formation. Examples of the application method include dip coating, spray coating, spin coating, and bar coating.

Examples of the method for removing at least a portion of the solvent contained in the application liquid for photosensitive layer formation include heating, depressurization, and combination of heating and depressurization. More specific examples of the removal method include heat treatment (hot-air drying) using a high-temperature dryer or a reduced pressure dryer. The heat treatment is performed at a temperature of at least 40° C. and no higher than 150° C., for example. The heat treatment is performed for no shorter than 3 minutes and no longer than 120 minutes, for example.

Note that the photosensitive member production method may further include an intermediate layer formation process as necessary. Any known method is appropriately selected as the intermediate layer formation process.

### Second Embodiment: Image Forming Apparatus

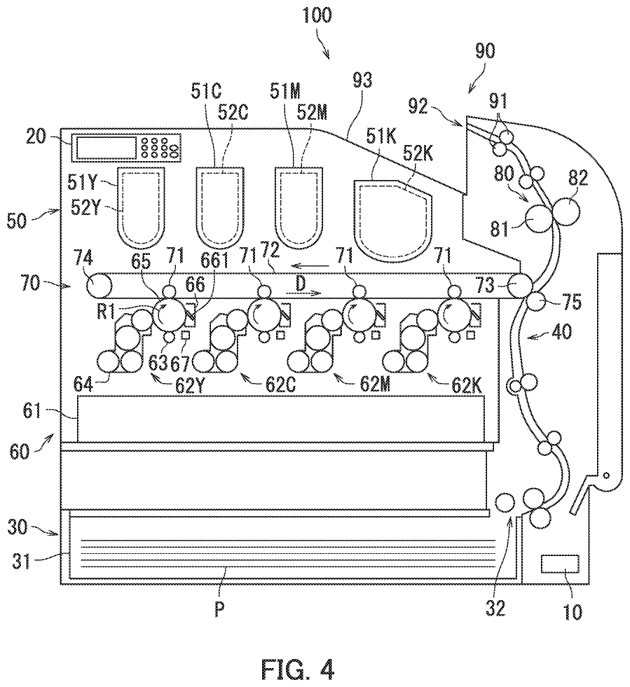

With reference to FIG. 4, an image forming apparatus 100 according to a second embodiment of the present disclosure is described next. FIG. 4 is a diagram illustrating an example of the configuration of the image forming apparatus 100. The image forming apparatus 100 is a tandem color printer, for example.

As illustrated in FIG. 4, the image forming apparatus 100 includes a controller 10, an operation section 20, a sheet feed section 30, a conveyance section 40, a toner replenishing section 50, an image forming section 60, a transfer device 70, a fixing device 80, and an ejection section 90.

The controller 10 controls operation of each element included in the image forming apparatus 100. The controller 10 includes a processor (not illustrated) and storage (not illustrated). The processor includes a central processing unit (CPU), for example. The storage include memory such as semiconductor memory, and may include a hard disk drive (HDD). The processor executes a control program (a control program stored in a non-transitory computer-readable storage medium) to control the operation of the image forming apparatus 100. The storage stores the control program therein.

The operation section 20 receives an instruction from a user. Upon receiving the instruction from the user, the operation section 20 transmits a signal indicating the instruction from the user to the controller 10. In response, image forming operation by the image forming apparatus 100 starts.

The sheet feed section 30 includes a sheet feed cassette 31 and a sheet feed roller group 32. The sheet feed cassette 31 accommodates sheets of a recording medium P (e.g., paper). The sheet feed roller group 32 feeds the sheets accommodated in the sheet feed cassette 31 one at a time to the conveyance section 40.

The conveyance section 40 includes a roller and a guide member. The conveyance section 40 extends from the sheet feed section 30 to the ejection section 90. The conveyance section 40 conveys the recording medium P from the sheet feed section 30 to the ejection section 90 via the image forming section 60 and the fixing device 80.

The toner replenishing section 50 replenishes the image forming section 60 with toner. The toner replenishing section 50 includes a first fitting section 51Y, a second fitting section 51C, a third fitting section 51M, and a fourth fitting section 51K.

A first toner container 52Y is fitted to the first fitting section 51Y. Similarly, a second toner container 52C is fitted to the second fitting section 51C, a third toner container 52M is fitted to the third fitting section 51M, and a fourth toner container 52K is fitted to the fourth fitting section 51K.

Toners are loaded in the first toner container 52Y, the second toner container 52C, the third toner container 52M, and the fourth toner container 52K. In the second embodiment, a yellow toner is loaded in the first toner container 52Y. A cyan toner is loaded in the second toner container 52C. A magenta toner is loaded in the third toner container 52M. A black toner is loaded in the fourth toner container 52K.

The image forming section 60 includes a light exposure device 61, a first image forming unit 62Y, a second image forming unit 62C, a third image forming unit 62M, and a fourth image forming unit 62K.

Each of the first to fourth image forming units 62Y to 62K includes a charger 63, a development device 64, an image bearing member 65, a cleaner 66, and a static eliminator 67.

Note that the configurations of the first to fourth image forming units 62Y to 62K are the same as each other except the type of the toner supplied from the toner replenishing section 50. Therefore, the reference sign for each element of the second to fourth image forming units 62C to 62K in FIG. 4 is omitted.

The image bearing member 65 is the photosensitive member 1 of the first embodiment. As has been described in the first embodiment, the photosensitive member 1 of the first embodiment has excellent filming resistance and scratch resistance. As such, the photosensitive member 1 that is the image bearing member 65 can have improved filming resistance and scratch resistance in the image forming apparatus 100 of the second embodiment.

The charger 63, the development device 64, the cleaner 66, and the static eliminator 67 are disposed along the circumference of the image bearing member 65. In the second embodiment, the image bearing member 65 rotates in a direction (clockwise direction) indicated by an arrow R1 in FIG. 4.

The charger 63 charges the surface (circumferential surface) of the image bearing member 65. The charger 63 uniformly charges the image bearing member 65 to a specific polarity by discharging. In the second embodiment, the charger 63 charges the image bearing member 65 to a positive polarity. The charger 63 is a charging roller, for example.

The light exposure device 61 exposes the charged surface of the image bearing member 65 to light. In detail, the light exposure device 61 irradiates the charged surface of the image bearing member 65 with laser light. Through the above, an electrostatic latent image is formed on the surface of the image bearing member 65.

The corresponding toner is supplied from the toner replenishing section 50 to the development device 64. The development device 64 supplies the toner supplied from the toner replenishing section 50 to the surface of the image bearing member 65. As a result, the electrostatic latent image formed on the surface of the image bearing member 65 is developed into a toner image.

In the second embodiment, the development device 64 of the first image forming unit 62Y is connected to the first toner container 52Y. As such, the yellow toner is supplied to the development device 64 of the first image forming unit 62Y. Accordingly, a yellow toner image is formed on the surface of the image bearing member 65 of the first image forming unit 62Y.

Similarly, the development device 64 of the second image forming unit 62C, the development device 64 of the third image forming unit 62M, and the development device 64 of the fourth image forming unit 62K are respectively connected to the second toner container 52C, the third toner container 52M, and the fourth toner container 52K. As such, the cyan toner, the magenta toner, and the black toner are respectively supplied to the development device 64 of the second image forming unit 62C, the development device 64 of the third image forming unit 62M, and the development device 64 of the fourth image forming unit 62K. Accordingly, a cyan toner image, a magenta toner image, and a black toner image are respectively formed on the surface of the image bearing member 65 of the second image forming unit 62C, the surface of the image bearing member 65 of the third image forming unit 62M, and the surface of the image bearing member 65 of the fourth image forming unit 62K.

The cleaner 66 includes a cleaning member 661. After transfer by a later-described primary transfer roller 71, the cleaner 66 collects toner attached to the surface of the image bearing member 65. In detail, the cleaner 66 collects toner attached to the surface of the image bearing member 65 by pressing the cleaning member 661 against the surface of the image bearing member 65. The cleaning member 661 is a cleaning blade, for example.

The static eliminator 67 perform static elimination on the surface of the image bearing member 65 by irradiating the surface of the image bearing member 65 with static elimination light.

The transfer device 70 transfers the toner images from the image bearing members 65 to the recording medium P that is a transfer target. In detail, the transfer device 70 transfers the toner images formed on the respective surfaces of the image bearing members 65 of the first to fourth image forming units 62Y to 62K to the recording medium P in a superimposed manner. In the second embodiment, the transfer device 70 transfers the toner images to the recording medium P in a superimposed manner by a secondary transfer process (intermediate transfer process). The transfer device 70 includes four primary transfer rollers 71, an intermediate transfer belt 72, a drive roller 73, a driven roller 74, and a secondary transfer roller 75.

The intermediate transfer belt 72 is an endless belt wound around the four primary transfer rollers 71, the drive roller 73, and the driven roller 74. The intermediate transfer belt 72 is driven in response to rotation of the drive roller 73. In FIG. 4, the intermediate transfer belt 72 circulates anticlockwise. The driven roller 74 is rotationally driven according to driving of the intermediate transfer belt 72.

The first to fourth image forming units 62Y to 62K are disposed opposite to the lower surface of the intermediate transfer belt 72. In the second embodiment, the first to fourth image forming units 62Y to 62K are disposed from upstream to downstream in the order of the first to fourth image forming units 62Y to 62K in terms of a driving direction D of the intermediate transfer belt 72.

The primary transfer rollers 71 are each disposed opposite to a corresponding one of the image bearing members 65 with the intermediate transfer belt 72 therebetween, and pressed toward the image bearing member 65. As such, the toner images formed on the respective surfaces of the image bearing members 65 are sequentially transferred to the intermediate transfer belt 72 by the corresponding primary transfer rollers 71. In the second embodiment, the yellow toner image, the cyan toner image, the magenta toner image, and the black toner image are sequentially transferred to the intermediate transfer belt 72 in the stated order in a superimposed manner. In the following, a toner image formed by superimposing the yellow toner image, the cyan toner image, the magenta toner image, and the black toner image may be also referred to below as “layered toner image”.

The secondary transfer roller 75 is disposed opposite to the drive roller 73 with the intermediate transfer belt 72 therebetween. The secondary transfer roller 75 is pressed toward the drive roller 73. In the above configuration, a transfer nip is formed between the secondary transfer roller 75 and the drive roller 73. When the recording medium P passes through the transfer nip, the layered toner image on the intermediate transfer belt 72 is transferred to the recording medium P by the secondary transfer roller 75. In the second embodiment, the yellow toner image, the cyan toner image, the magenta toner image, and the black toner image are transferred to the recording medium Pin the stated order to be superimposed from the upper layer to the lower layer. The recording medium P to which the layered toner image has been transferred is conveyed to the fixing device 80 by the conveyance section 40.

The fixing device 80 includes a heating member 81 and a pressure member 82. The heating member 81 and the pressure member 82 are disposed opposite to each other to form a fixing nip. When passing through the fixing nip, the recording medium P conveyed from the image forming section 60 is pressed while being heated at a specific fixing temperature. As a result, the layered toner image is fixed to the recording medium P. The recording medium P is conveyed from the fixing device 80 to the ejection section 90 by the conveyance section 40.

The ejection section 90 includes an ejection roller pair 91 and an exit tray 93. The ejection roller pair 91 conveys the recording medium P to the exit tray 93 through an exit port 92. The exit port 92 is formed in an upper part of the image forming apparatus 100.

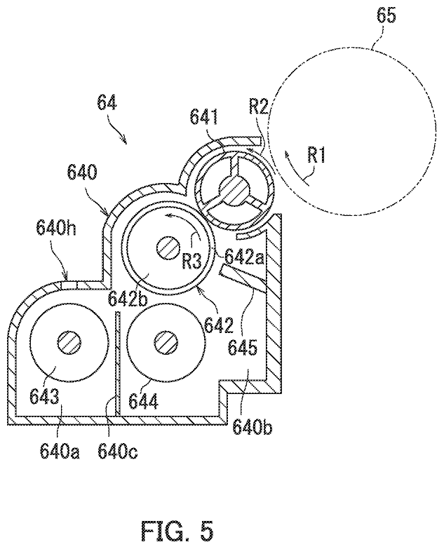

The configuration of the development device 64 is described next in detail with reference to FIG. 5. FIG. 5 is a diagram illustrating an example of the configuration of the development device 64. Specifically, FIG. 5 illustrates the development device 64 of the first image forming unit 62Y. Note that the image bearing member 65 is illustrated with a dashed and double dotted line in FIG. 5 for facilitating understanding. In the second embodiment, the development device 64 adopts a touch-down development process and a two-component development process using a two-component developer.

As described previously with reference to FIG. 4, the developer container 640 of the development device 64 is connected to the first toner container 52Y. As such, the yellow toner is supplied to the developer container 640 of the development device 64 through a toner replenishment port 640h.

As illustrated in FIG. 5, the development device 64 includes inside the developer container 640 a development roller 641, a magnetic roller 642, a first stirring screw 643, a second stirring screw 644, and a blade 645. Specifically, the development roller 641 is disposed opposite to the magnetic roller 642. The magnetic roller 642 is disposed opposite to the second stirring screw 644. The blade 645 is disposed opposite to the magnetic roller 642.

The developer container 640 is divided into a first stirring chamber 640a and a second stirring chamber 640b by a partition wall 640c. The partition wall 640c extends in an axial direction of the development roller 641. The first stirring chamber 640a and the second stirring chamber 640b communicate with each other at the outsides of the opposite ends of the partition wall 640c in the longitudinal direction of the partition wall 640c.

The first stirring screw 643 is disposed in the first stirring chamber 640a. A carrier that is a magnetic material is contained in the first stirring chamber 640a. A toner that is a non-magnetic material is supplied to the first stirring chamber 640a through the toner replenishment port 640h. The yellow toner is supplied to the first stirring chamber 640a in the example illustrated in FIG. 5.

The second stirring screw 644 is disposed in the second stirring chamber 640b. A carrier that is a magnetic material is contained in the second stirring chamber 640b.

The yellow toner is stirred together with the carrier by the first stirring screw 643 and the second stirring screw 644. As a result, a two-component developer containing the carrier and the yellow toner is formed.

The first stirring screw 643 and the second stirring screw 644 stir while circulating the two-component developer between the first stirring chamber 640a and the second stirring chamber 640b. As a result, the toner is charged to a specific polarity by friction with the carrier. In the second embodiment, the toner is charged to a positive polarity.

The magnetic roller 642 includes a magnet 642b and a rotation sleeve 642a that is non-magnetic. The magnet 642b is disposed to be fixed inside the rotation sleeve 642a. The magnet 642b has a plurality of polarities. The two-component developer is adsorbed to the magnetic roller 642 due to the presence of magnetic force of the magnet 642b. As a result, a magnetic brush is formed on the surface of the magnetic roller 642.

In the second embodiment, the magnetic roller 642 rotates in a direction (anticlockwise direction) indicated by an arrow R3 in FIG. 5. Rotation of the magnetic roller 642 conveys the magnetic brush to a location opposite to the blade 645. The blade 645 is disposed so as to form a gap (slit) between the blade 645 and the magnetic roller 642. As such, the thickness of the magnetic brush is defined by the blade 645. The blade 645 is disposed upstream of a location where the magnetic roller 642 is opposite to the development roller 641 in the rotational direction of the magnetic roller 642.

A specific voltage is applied to the development roller 641 and the magnetic roller 642. When a specific potential difference arises between the development roller 641 and the magnetic roller 642 as a result of application of the specific voltage, the yellow toner included in the two-component developer moves to the development roller 641. This forms a thin toner layer of the yellow toner on the surface of the development roller 641.

The development roller 641 rotates in a direction (anticlockwise direction) indicated by an arrow R2 in FIG. 5. Through the rotation of the development roller 641, the thin toner layer formed on the surface of the development roller 641 is conveyed to a location opposite to the image bearing member 65 and attaches to the image bearing member 65. In the manner described above, the development device 64 supplies the toner charged by friction with the carrier to the surface of the image bearing member 65.

The development device 64 of the first image forming unit 62Y has been described so far with reference to FIG. 5. The configurations of the development devices 64 of the first to fourth image forming units 62Y to 62K are the same as each other except the type of the toner supplied from the toner replenishing section 50. Therefore, description of the configuration of the development devices 64 of the second to fourth image forming units 62C to 62K is omitted.

An example of the image forming apparatus has been described so far with reference to FIGS. 4 and 5. However, the image forming apparatus is not limited to the above-described image forming apparatus 100. The image forming apparatus 100 is a color image forming apparatus, but the image forming apparatus may be a monochrome image forming apparatus. In this case, it is only required that the image forming apparatus includes only one image forming unit, for example. Furthermore, the image forming apparatus 100 is a tandem image forming apparatus, but the image forming apparatus may be a rotary image forming apparatus, for example. A charging roller is exemplified as the charger 63. However, the charger may be a charger other than the charging roller (e.g., a scorotron charger, a charging brush, or a corotron charger). The image forming apparatus 100 adopts a two-component development process using a two-component developer, but the image forming apparatus may adopt a one-component development process using a one-component developer. The image forming apparatus 100 adopts a touch down development process, but the image forming apparatus may adopt a development process other than the touch down development process (e.g., a development process using a magnetic roller serving also as a development roller rather than using a development roller). The image forming apparatus 100 adopts an intermediate transfer process, but the image forming apparatus may adopt a direct transfer process. Where the image forming apparatus adopts a direct transfer process, a toner image is directly transferred to the recording medium P from the image bearing member 65 while the image bearing member 65 is in contact with the recording medium P. A cleaning blade is exemplified as the cleaning member 661, but the cleaning member may be a cleaning roller. Furthermore, the image forming apparatus may not include the cleaner 66. Moreover, the first to fourth image forming units 62Y to 62K each include a static eliminator, but each image forming unit may not include the static eliminator.

### Third Embodiment: Process Cartridge

With further reference to FIG. 4, a process cartridge according to a third embodiment of the present disclosure is described next. The process cartridge of the third embodiment corresponds to each of the first to fourth image forming units 62Y to 62K. The process cartridge includes the image bearing member 65. The image bearing member 65 is the photosensitive member 1 of the first embodiment. As has been described in the first embodiment, the photosensitive member 1 of the first embodiment has excellent filming resistance and scratch resistance. As such, the photosensitive member 1 that is the image bearing member 65 of the process cartridge of the third embodiment can have improved filming resistance and scratch resistance.

The process cartridge further includes at least one (e.g., at least 1 and no greater than 4) selected from the group consisting of the charger 63, the development device 64, the cleaner 66, and the static eliminator 67 in addition to the image bearing member 65. The process cartridge may further include the transfer device 70 (particularly, the primary transfer roller 71). The process cartridge may further include the light exposure device 61. The process cartridge is designed to be freely attachable to and detachable from the image forming apparatus 100. As such, the process cartridge is easy to handle and the process cartridge including the image bearing member 65 can be replaced easily and quickly once photosensitivity or the like of the image bearing member 65 degrades. The process cartridge of the third embodiment has been described so far with reference to FIG. 4.

### EXAMPLES

The following describes the present disclosure further in detail using Examples. However, the present disclosure is not limited to the scope of Examples.

First, charge generating materials, electron transport materials, hole transport materials, binder resins, dispersion agents, and filler particles described below were prepared as materials for forming photosensitive layers of photosensitive members.

(Charge Generating Material)

Y-form titanyl phthalocyanine and X-form metal-free phthalocyanine described in the first embodiment were prepared each as the charge generating material.

(Electron Transport Material)

The electron transport materials (E-1) to (E-8) described in the first embodiment were prepared each as the electron transport material. In addition, a compound represented by formula (E-A) was also prepared as an electron transport material used in Examples.

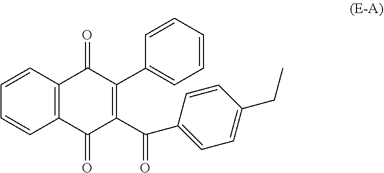 [SMILES: CCc1ccc(C(=O)C2=C(c3ccccc3)C(=O)c3ccccc3C2=O)cc1]

(Hole Transport Material)

The hole transport materials (H-1) to (H-11) described in the first embodiment were prepared each as the hole transport material. In addition, a compound represented by formula (H-A) was also prepared as a hole transport material used in Examples.

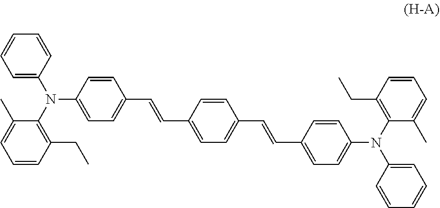 [SMILES: CCc1cccc(C)c1N(c1ccccc1)c1ccc(/C=C/c2ccc(/C=C/c3ccc(N(c4ccccc4)c4c(C)cccc4CC)cc3)cc2)cc1]

(Binder Resin)

The polyarylate resins (R-1) to (R-8) described in the first embodiment were prepared each as the binder resin. The polyarylate resins (R-1) to (R-8) each had a viscosity average molecular weight of 60,000.

In addition, polycarbonate resins (R-A) to (R-C) and polyarylate resins (R-D) to (R-F), (R-X), and (R-Y) were also prepared as binder resins used in Comparative Examples. The polycarbonate resins (R-A) to (R-C) and the polyarylate resins (R-D) to (R-F), (R-X), and (R-Y) are represented by the following formulas (R-A) to (R-F), (R-X), and (R-Y), respectively. Note that the number attached to the lower right of each repeating unit indicates a percentage (unit: %) of the number of repeats of the repeating unit relative to the total number of repeats of each repeating unit included in the corresponding resin. The polycarbonate resins (R-A) to (R-C) and the polyarylate resins (R-D) to (R-F), (R-X), and (R-Y) each had a viscosity average molecular weight of 60,000.

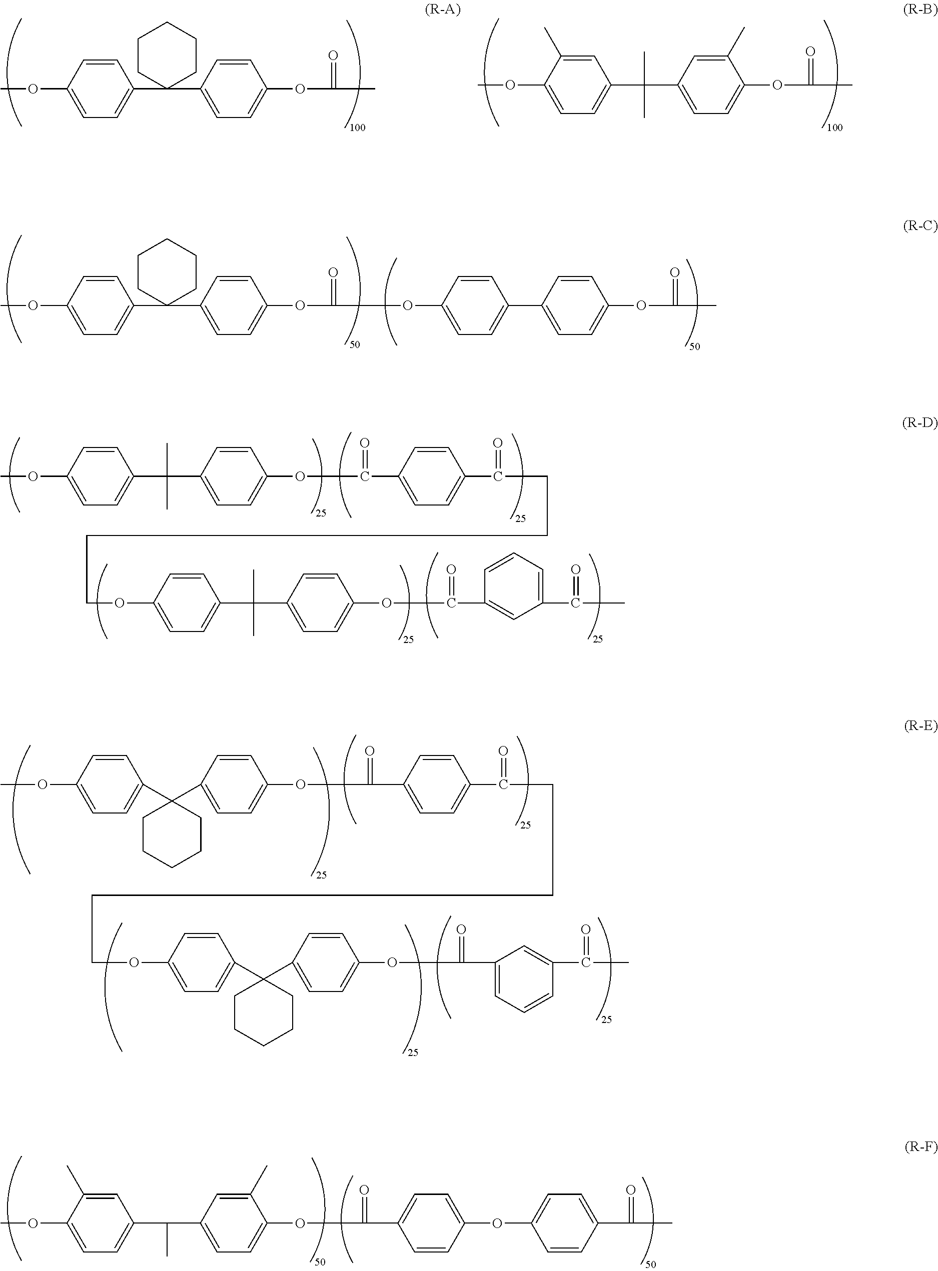

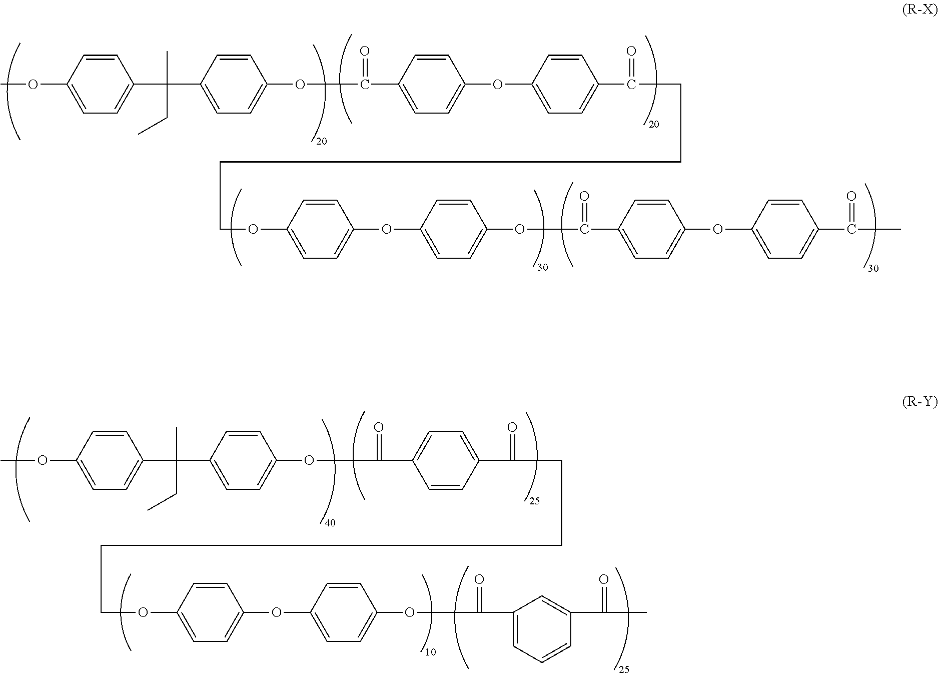

(Dispersion Agent)

The dispersion agents (30) and (31) described in the first embodiment were prepared each as the dispersion agent.

(Filler Particles)

Filler particles (F-1) to (F-4) shown in Table 12 were prepared as the filler particles. Note that the filler particles (F-1) to (F-4) were resin particles.

TABLE 12

| Filler | | | D₅₀ | Product | |
|---|---|---|---|---|---|
| particles | Material | | (μm) | name | Manufacturer |
| F-1 | Resin | Silicone | 0.70 | X-52- | Shin-Etsu |
| | | resin | | 854 | Chemical |
| | | | | | Co., Ltd. |
| F-2 | Resin | Silicone | 2.00 | KMP- | Shin-Etsu |
| | | resin | | 590 | Chemical |
| | | | | | Co., Ltd. |
| F-3 | Resin | Silicone | 5.00 | X-52- | Shin-Etsu |
| | | resin | | 1621 | Chemical |
| | | | | | Co., Ltd. |
| F-4 | Resin | Silicone | 0.50 | MSP- | Nikko Rica |
| | | resin | | N050 | Corporation |

<Photosensitive Member Production>

(Production of Photosensitive member (A-1))

Using a rod-shaped sonic oscillator, 2.0 parts by mass of Y-form titanyl phthalocyanine being the charge generating material, 70.0 parts by mass of the hole transport material (H-1), 50.0 parts by mass the electron transport material (E-4), 100.0 parts by mass of the polyarylate resin (R-1) being the binder resin, 5.9 parts by mass of the filler particles (F-1), and 500.0 parts by mass of tetrahydrofuran being a solvent were mixed for 20 minutes, thereby obtaining a dispersion. The dispersion was filtered using a filter with an opening of 5 μm, thereby obtaining an application liquid for photosensitive layer formation. The application liquid for photosensitive layer formation was applied onto a conductive substrate (drum-shaped aluminum support) by dip coating, and hot-air dried for 50 minutes at 120° C. In the manner described above, a photosensitive layer (film thickness 30 μm) was formed on the conductive substrate, thereby obtaining a photosensitive member (A-1). In the photosensitive member (A-1), a single-layer photosensitive layer was directly provided on the conductive substrate. Using an equation “(percentage content of filler particles)=100×(mass of filler particles)/[(mass of charge generating material)+(mass of hole transport material)+(mass of electron transport material)+(mass of binder resin)+(mass of filler particles)]=100×5.9/(2.0+70.0+50.0+100.0+5.9)”, the percentage content of the filler particles relative to the mass of the photosensitive member (A-1) was calculated to be 2.6% by mass.

(Production of Photosensitive Members (A-2) to (A-31) and (B-1) to (B-8)) Photosensitive members (A-2) to (A-31) and (B-1) to (B-8) were produced according to the same method as that for the photosensitive member (A-1) in all aspects other than that the electron transport materials, the hole transport materials, the binder resins, and the filler particles shown in Tables 13 to 15 were used and the filler particles were added so that the percentage contents of the filler particles relative to the mass of the corresponding photosensitive layers were values shown in Tables 13 to 15. Note that 5.9 parts by mass of filler particles of the corresponding type were added in production of each of the photosensitive members (A-2) to (A-28) and (B-1) to (B-8). In production of the photosensitive member (A-29), 11.7 parts by mass of the corresponding filler particles were added. In production of the photosensitive member (A-30), 23.3 parts by mass of the corresponding filler particles were added. In production of the photosensitive member (A-31), 27.4 parts by mass of the corresponding filler particles were added.

(Production of Photosensitive Member (B-9))

A photosensitive member (B-9) was produced according to the same method as that for the photosensitive member (A-1) in all aspects other than that the polyarylate resin (R-1) was changed to the polyarylate resin (R-2) and no filler particles were used.

(Production of Photosensitive member (A2-1))

Using a rod-shaped sonic oscillator, 2 parts by mass of Y-form titanyl phthalocyanine being the charge generating material, 70 parts by mass of the hole transport material (H-1), 50 parts by mass of the electron transport material (E-2), 100 parts by mass of the polyarylate resin (R-1) being the binder resin, and 500 parts by mass of tetrahydrofuran being a solvent were mixed for 20 minutes, thereby obtaining a dispersion. The dispersion was filtered using a filter with an opening of 5 μm, thereby obtaining an application liquid for photosensitive layer formation. The application liquid for photosensitive layer formation was applied onto a conductive substrate (drum-shaped aluminum support) by dip coating, and hot-air dried for 50 minutes at 120° C. In the manner described above, a photosensitive layer (film thickness 30 μm) was formed on the conductive substrate, thereby obtaining a photosensitive member (A2-1). In the photosensitive member (A2-1), a single-layer photosensitive layer was directly provided on the conductive substrate.

(Production of Photosensitive Members (A2-2) to (A2-24) and (B2-1) to (B2-6))

Photosensitive members (A2-2) to (A2-24) and (B2-1) to (B2-6) were produced according to the same method as that for production of the photosensitive member (A2-1) in all aspects other than use of the hole transport materials, the electron transport materials, and the binder resins shown in Tables 16 and 17.

(Production of Photosensitive Member (A3-1))

Using a rod-shaped sonic oscillator, 2.0 parts by mass of Y-form titanyl phthalocyanine being the charge generating material, 1.6 parts by mass of the dispersion agent (30), 70.0 parts by mass of the hole transport material (H-1), 50.0 parts by mass of the electron transport material (E-1), 100.0 parts by mass of the polyarylate resin (R-1) being the binder resin, and 500.0 parts by mass of tetrahydrofuran being a solvent were mixed for 20 minutes, thereby obtaining an dispersion. The dispersion was filtered using a filter with an opening of 5 μm, thereby obtaining an application liquid for photosensitive layer formation. The application liquid for photosensitive layer formation was applied onto a conductive substrate (drum-shaped aluminum support) by dip coating, and hot-air dried for 50 minutes at 120° C. In the manner described above, a photosensitive layer (film thickness 30 μm) was formed on the conductive substrate, thereby obtaining a photosensitive member (A3-1). In the photosensitive member (A3-1), a single-layer photosensitive layer was directly provided on the conductive substrate.

(Production of Photosensitive Members (A3-2) to (A3-31) and (B3-5) to (B3-10))

Photosensitive members (A3-2) to (A3-27), (A3-30), (A3-31) and (B3-5) to (B3-10) were produced according to the same method as that for the photosensitive member (A3-1) in all aspects other than use of the charge generating materials, the dispersion agents, the hole transport materials, the electron transport materials, and the binder resins shown in Tables 18 and 19.

(Production of Photosensitive Members (A3-28) and (A3-29))

Photosensitive members (A3-28) and (A3-29) were produced according to the same method as that for production of the photosensitive member (A3-1) in all aspects other than that no dispersion agents were used and the charge generating materials, the hole transport materials, the electron transport materials, and the binder resins shown in Table 19 were used.

<Evaluation>

With respect to each of the obtained photosensitive members (A-1) to (A-31) and (B-1) to (B-9), abrasion resistance, filming resistance, and scratch resistance were evaluated according to methods described below. With reference to each of the obtained photosensitive members (A2-1) to (A2-24) and (B2-1) to (B2-6), abrasion resistance, filming resistance, scratch resistance, and transfer memory inhibition were evaluated according to methods described below. With reference to each of the obtained photosensitive members (A3-1) to (A3-31) and (B3-5) to (B3-10), photosensitivity, filming resistance, and scratch resistance were evaluated according to methods described below. Paper used for each evaluation was “ASKUL MULTIPAPER SUPER ECONOMY+”, available at ASKUL Corporation. Also, a modified version of an image forming apparatus (“FS-05250DN”, product of KYOCERA Document Solutions Inc.) was used as an evaluation apparatus for each evaluation. The evaluation apparatus included a charging roller as a charger formed from epichlorohydrin resin in which conductive carbon has been dispersed. The charge polarity of the charging roller was a positive polarity, and the application voltage to the charging roller was a direct current voltage. Furthermore, the evaluation apparatus adopted a two-component development process and an intermediate transfer process. Moreover, the evaluation apparatus included a cleaning blade and a static eliminator.

<Evaluation of Abrasion Resistance>

Evaluation of abrasion resistance was carried out in an environment at a temperature of 23° C. and a relative humidity of 50%. A film thickness T1 of the photosensitive layer of the photosensitive member was measured. Next, the photosensitive member was mounted in the evaluation apparatus. Using the evaluation apparatus, an image I (character image with a printing rate of 5%) was continuously printed on 50,000 sheets of the paper. After the printing, a film thickness T2 of the photosensitive layer of the photosensitive member was measured. Note that an eddy current film thickness meter (“LH-373”, product of Kett Electric Laboratory) was used for the measurement of the film thicknesses T1 and T2. Subsequently, an abrasion amount (unit: μm) of the photosensitive layer was obtained using an expression “abrasion amount=T1−T2”. The obtained abrasion amounts are shown in Tables 13 to 17. A smaller abrasion amount indicates that the photosensitive member has more excellent abrasion resistance.

<Evaluation of Filming Resistance and Scratch Resistance>

The photosensitive member after the evaluation of abrasion resistance was mounted in the evaluation apparatus. In an environment at a temperature of 23° C. and a relative humidity of 50%, an image I (character image with a printing rate of 5%) was continuously printed on 50,000 sheets of the paper using the evaluation apparatus. Next, an image II (image including a halftone image and a blank image) was printed on one sheet of the paper using the evaluation apparatus, and the obtained image was taken to be a first evaluation image.

After the first evaluation image was obtained, the photosensitive member was taken out of the evaluation apparatus. The surface of the photosensitive member was observed with the naked eye to check the occurrence or non-occurrence of filming and the presence or absence of scratches in the surface of the photosensitive member. After the observation with the naked eye, the photosensitive member was re-mounted in the evaluation apparatus.

Next, an image I (character image with a printing rate of 5%) was continuously printed on 50,000 sheets of the paper using the evaluation apparatus in an environment at a temperature of 10° C. and a relative humidity of 15%. Subsequently, an image II (image including a halftone image and a blank image) was printed on one sheet of the paper using the evaluation apparatus, and the obtained image was taken to be a second evaluation image.

The first evaluation image and the second evaluation image were observed to check the presence or absence of image defects resulting from filming. The image defects resulting from filming include dash marks and fogging, for example. The dash marks are black spots lined in parallel to a conveyance direction of the paper. As an area of a part of the surface of the photosensitive member where filming occurs increases, fogging starting from dash marks occurs in a wider area of a formed image. Filming resistance and scratch resistance were evaluated based on the following criteria from a result of observation of the surface of the photosensitive member and results of check on image defects of the first evaluation image and the second evaluation image. Results of the evaluation of filming resistance and scratch resistance are shown in Tables 13 to 19.

Evaluation A (very good): Neither scratches nor filming was observed in the surface of the photosensitive member. Also, no image defects were observed in both the first evaluation image and the second evaluation image.

Evaluation B (good): At least one of scratches and filming was observed in the surface of the photosensitive member. However, no image defects were observed in both the first evaluation image and the second evaluation image.

Evaluation C (poor): At least one of scratches and filming was observed in the surface of the photosensitive member. An image defect was observed in the second evaluation image. However, no image defects were observed in the first evaluation image.

Evaluation D (very poor): At least one of scratches and filming was observed in the surface of the photosensitive member. Also, an image defect was observed in each of the first evaluation image and the second evaluation image.

<Evaluation of Transfer Memory Inhibition>

Evaluation of transfer memory inhibition was carried out in an environment at a temperature of 23° C. and a relative humidity of 50%. The photosensitive member after the evaluation of abrasion resistance and the evaluation of filming resistance and scratch resistance was mounted in the evaluation apparatus. The application voltage to the charging roller was set so that the charge potential of the photosensitive member was +570 V. The transfer bias of the primary transfer roller was set to −2.0 kV.

The photosensitive member was charged using the evaluation apparatus, and a first charge potential V₁ (unit: +V) was measured. Next, the transfer bias was applied to the photosensitive member without performing light exposure and development. Next, the photosensitive member was subjected to static elimination and re-charged, and a second charge potential V₂ (unit: +V) was measured. Using an equation “transfer memory potential ΔVtc=V1−V2”, a transfer memory potential ΔVtc (unit: V) was obtained. The obtained transfer memory potentials ΔVtc are shown in Tables 16 and 17. A smaller absolute value of the transfer memory potential ΔVtc indicates that transfer memory is more inhibited.

<Evaluation of Photosensitivity>

The application voltage to the charging roller was set so that the charge potential of the photosensitive member was +570 V. The exposure light of the light exposure device was set to have a wavelength of 780 nm, a half-width of 20 nm, and a light intensity of 1.16 μJ/m². The photosensitive member was charged and exposed to light using the evaluation apparatus in an environment at a temperature of 10° C. and a relative humidity of 15%. The surface potential of an area exposed to the light (corresponding to an image area) was measured at a location where development was to be performed. The measured surface potential of the area exposed to the light was taken to be a post-exposure potential VL (unit: +V). The measured post-exposure potentials VL are shown in Tables 18 and 19. A lower post-exposure potential VL indicates that the photosensitive member has more excellent photosensitivity.

The terms in Tables 13 to 19 mean as follows. “CGM” indicates charge generating material. “CG-1” indicates Y-form titanyl phthalocyanine. “CG-A” indicates X-form metal-free phthalocyanine. “ETM” indicates electron transport material. “HTM” indicates hole transport material. “Resin” indicates binder resin. “n₁/n₂” indicates the ratio n₁/n₂ of the number n₁ of repeats of the repeating unit (1) to the number n₂ of repeats of the repeating unit (2). “Filler” indicates filler particles. “Content percentage” under “Filler” indicates percentage content (unit: wt %, i.e., % by mass) of the filler particles relative to the mass of a corresponding photosensitive layer. “Filming⋅scratch” indicates a result of evaluation of filming resistance and scratch resistance. “ΔVtc” indicates transfer memory potential. “−” indicates no use of a corresponding material or no corresponding value.

TABLE 13

| | | | | | | | Filler | | | |
|---|---|---|---|---|---|---|---|---|---|---|
| | | | | | | | | Content | Abrasion | |
| | Photosensitive | | | | Resin | | | percentage | amount | Filming |
| | member | CGM | ETM | HTM | Type | n₁/n₂ | Type | [wt %] | [μm] | •scratch |
| Example 1-1 | A-1 | CG-1 | E-4 | H-1 | R-1 | 4.0 | F-1 | 2.6 | 1.4 | B |
| Example 1-2 | A-2 | CG-1 | E-4 | H-1 | R-2 | 4.0 | F-1 | 2.6 | 1.1 | A |
| Example 1-3 | A-3 | CG-1 | E-4 | H-1 | R-3 | 4.0 | F-1 | 2.6 | 1.2 | A |
| Example 1-4 | A-4 | CG-1 | E-4 | H-1 | R-4 | 4.0 | F-1 | 2.6 | 1.3 | B |
| Example 1-5 | A-5 | CG-1 | E-4 | H-1 | R-5 | 4.0 | F-1 | 2.6 | 1.3 | A |
| Example 1-6 | A-6 | CG-1 | E-4 | H-1 | R-6 | 1.0 | F-1 | 2.6 | 1.3 | B |
| Example 1-7 | A-7 | CG-1 | E-4 | H-1 | R-7 | 1.5 | F-1 | 2.6 | 1.3 | B |
| Example 1-8 | A-8 | CG-1 | E-4 | H-1 | R-8 | 9.0 | F-1 | 2.6 | 1.2 | A |
| Example 1-9 | A-9 | CG-1 | E-3 | H-1 | R-2 | 4.0 | F-1 | 2.6 | 1.2 | A |
| Example 1-10 | A-10 | CG-1 | E-2 | H-1 | R-2 | 4.0 | F-1 | 2.6 | 1.1 | A |
| Example 1-11 | A-11 | CG-1 | E-1 | H-1 | R-2 | 4.0 | F-1 | 2.6 | 1.1 | A |
| Example 1-12 | A-12 | CG-1 | E-5 | H-1 | R-2 | 4.0 | F-1 | 2.6 | 1.2 | A |
| Example 1-13 | A-13 | CG-1 | E-6 | H-1 | R-2 | 4.0 | F-1 | 2.6 | 1.1 | A |
| Example 1-14 | A-14 | CG-1 | E-7 | H-1 | R-2 | 4.0 | F-1 | 2.6 | 1.2 | A |
| Example 1-15 | A-15 | CG-1 | E-8 | H-1 | R-2 | 4.0 | F-1 | 2.6 | 1.2 | A |

TABLE 14

| | | | | | | | Filler | | | |
|---|---|---|---|---|---|---|---|---|---|---|
| | | | | | | | | Content | Abrasion | |
| | Photosensitive | | | | Resin | | | percentage | amount | Filming |
| | member | CGM | ETM | HTM | Type | n₁/n₂ | Type | [wt %] | [μm] | •scratch |
| Example 1-16 | A-16 | CG-1 | E-4 | H-2 | R-2 | 4.0 | F-1 | 2.6 | 1.1 | A |
| Example 1-17 | A-17 | CG-1 | E-4 | H-5 | R-2 | 4.0 | F-1 | 2.6 | 1.2 | A |
| Example 1-18 | A-18 | CG-1 | E-4 | H-6 | R-2 | 4.0 | F-1 | 2.6 | 1.1 | A |
| Example 1-19 | A-19 | CG-1 | E-4 | H-4 | R-2 | 4.0 | F-1 | 2.6 | 1.1 | A |
| Example 1-20 | A-20 | CG-1 | E-4 | H-7 | R-2 | 4.0 | F-1 | 2.6 | 1.1 | A |
| Example 1-21 | A-21 | CG-1 | E-4 | H-8 | R-2 | 4.0 | F-1 | 2.6 | 1.2 | A |
| Example 1-22 | A-22 | CG-1 | E-4 | H-3 | R-2 | 4.0 | F-1 | 2.6 | 1.3 | A |
| Example 1-23 | A-23 | CG-1 | E-4 | H-9 | R-2 | 4.0 | F-1 | 2.6 | 1.4 | A |
| Example 1-24 | A-24 | CG-1 | E-4 | H-10 | R-2 | 4.0 | F-1 | 2.6 | 1.3 | A |
| Example 1-25 | A-25 | CG-1 | E-4 | H-11 | R-2 | 4.0 | F-1 | 2.6 | 1.3 | A |
| Example 1-26 | A-26 | CG-1 | E-4 | H-1 | R-2 | 4.0 | F-2 | 2.6 | 1.4 | A |
| Example 1-27 | A-27 | CG-1 | E-4 | H-1 | R-2 | 4.0 | F-3 | 2.6 | 1.5 | A |
| Example 1-28 | A-28 | CG-1 | E-4 | H-1 | R-2 | 4.0 | F-4 | 2.6 | 1.5 | A |
| Example 1-29 | A-29 | CG-1 | E-4 | H-1 | R-2 | 4.0 | F-1 | 5.0 | 1.1 | A |
| Example 1-30 | A-30 | CG-1 | E-4 | H-1 | R-2 | 4.0 | F-1 | 9.5 | 1.0 | A |
| Example 1-31 | A-31 | CG-1 | E-4 | H-1 | R-2 | 4.0 | F-1 | 11.0 | 1.1 | A |

TABLE 15

| | | | | | | | Filler | | | |
|---|---|---|---|---|---|---|---|---|---|---|
| | | | | | | | | Content | Abrasion | |
| | Photosensitive | | | | Resin | | | percentage | amount | Filming |
| | member | CGM | ETM | HTM | Type | n₁/n₂ | Type | [wt %] | [μm] | •scratch |
| Comparative | B-1 | CG-1 | E-4 | H-1 | R-X | 0.7 | F-1 | 2.6 | 3.4 | C |
| Example 1-1 | | | | | | | | | | |
| Comparative | B-2 | CG-1 | E-4 | H-1 | R-Y | 4.0 | F-1 | 2.6 | 3.0 | C |
| Example 1-2 | | | | | | | | | | |
| Comparative | B-3 | CG-1 | E-4 | H-1 | R-A | — | F-1 | 2.6 | 4.5 | D |
| Example 1-3 | | | | | | | | | | |
| Comparative | B-4 | CG-1 | E-4 | H-1 | R-D | — | F-1 | 2.6 | 3.2 | D |
| Example 1-4 | | | | | | | | | | |
| Comparative | B-5 | CG-1 | E-4 | H-1 | R-F | — | F-1 | 2.6 | 2.2 | C |
| Example 1-5 | | | | | | | | | | |

TABLE 16

| | | | | | | | Abrasion | | |
|---|---|---|---|---|---|---|---|---|---|
| | Photosensitive | | | | Resin | | amount | Filming | ΔVtc |
| | member | CGM | ETM | HTM | Type | n₁/n₂ | [μm] | •scratch | [V] |
| Example 2-1 | A2-1 | CG-1 | E-2 | H-1 | R-1 | 4.0 | 2.0 | B | 32 |
| Example 2-2 | A2-2 | CG-1 | E-2 | H-1 | R-2 | 4.0 | 1.6 | A | 25 |
| Example 2-3 | A2-3 | CG-1 | E-2 | H-1 | R-3 | 4.0 | 1.8 | A | 33 |
| Example 2-4 | A2-4 | CG-1 | E-2 | H-1 | R-4 | 4.0 | 2.0 | B | 29 |
| Example 2-5 | A2-5 | CG-1 | E-2 | H-1 | R-5 | 4.0 | 1.9 | A | 27 |
| Example 2-6 | A2-6 | CG-1 | E-2 | H-1 | R-6 | 1.0 | 2.0 | B | 30 |
| Example 2-7 | A2-7 | CG-1 | E-2 | H-1 | R-7 | 1.5 | 1.7 | B | 24 |
| Example 2-8 | A2-8 | CG-1 | E-2 | H-1 | R-8 | 9.0 | 2.1 | A | 26 |
| Example 2-9 | A2-9 | CG-1 | E-3 | H-1 | R-2 | 4.0 | 1.8 | A | 23 |
| Example 2-10 | A2-10 | CG-1 | E-6 | H-1 | R-2 | 4.0 | 1.7 | A | 26 |
| Example 2-11 | A2-11 | CG-1 | E-7 | H-1 | R-2 | 4.0 | 1.8 | A | 28 |
| Example 2-12 | A2-12 | CG-1 | E-8 | H-1 | R-2 | 4.0 | 1.8 | A | 27 |
| Example 2-13 | A2-13 | CG-1 | E-2 | H-2 | R-2 | 4.0 | 1.9 | A | 28 |
| Example 2-14 | A2-14 | CG-1 | E-2 | H-3 | R-2 | 4.0 | 2.0 | A | 30 |
| Example 2-15 | A2-15 | CG-1 | E-2 | H-4 | R-2 | 4.0 | 1.7 | A | 26 |
| Example 2-16 | A2-16 | CG-1 | E-2 | H-5 | R-2 | 4.0 | 1.8 | A | 24 |
| Example 2-17 | A2-17 | CG-1 | E-2 | H-6 | R-2 | 4.0 | 1.9 | A | 24 |
| Example 2-18 | A2-18 | CG-1 | E-2 | H-7 | R-2 | 4.0 | 2.0 | A | 27 |
| Example 2-19 | A2-19 | CG-1 | E-2 | H-8 | R-2 | 4.0 | 1.7 | A | 24 |
| Example 2-20 | A2-20 | CG-1 | E-2 | H-9 | R-2 | 4.0 | 1.8 | A | 25 |
| Example 2-21 | A2-21 | CG-1 | E-2 | H-10 | R-2 | 4.0 | 2.1 | A | 26 |
| Example 2-22 | A2-22 | CG-1 | E-2 | H-11 | R-2 | 4.0 | 2.0 | A | 25 |

TABLE 17

| | | | | | | | Abrasion | | |
|---|---|---|---|---|---|---|---|---|---|
| | Photosensitive | | | | Resin | | amount | Filming | ΔVtc |
| | member | CGM | ETM | HTM | Type | n₁/n₂ | [μm] | •scratch | [V] |
| Comparative | B2-1 | CG-1 | E-2 | H-1 | R-A | — | 4.7 | C | 103 |
| Example 2-1 | | | | | | | | | |
| Comparative | B2-2 | CG-1 | E-2 | H-1 | R-B | — | 4.2 | C | 126 |
| Example 2-2 | | | | | | | | | |
| Comparative | B2-3 | CG-1 | E-2 | H-1 | R-C | — | 6.3 | D | 123 |
| Example 2-3 | | | | | | | | | |
| Comparative | B2-4 | CG-1 | E-2 | H-1 | R-D | — | 4.5 | D | 110 |
| Example 2-4 | | | | | | | | | |
| Comparative | B2-5 | CG-1 | E-2 | H-1 | R-E | — | 3.4 | C | 122 |
| Example 2-5 | | | | | | | | | |
| Comparative | B2-6 | CG-1 | E-2 | H-1 | R-F | — | 2.9 | C | 106 |
| Example 2-6 | | | | | | | | | |
| Example 2-23 | A2-23 | CG-1 | E-2 | H-A | R-2 | 4.0 | 2.3 | B | 156 |
| Example 2-24 | A2-24 | CG-1 | E-A | H-1 | R-2 | 4.0 | 2.2 | B | 176 |

TABLE 18

| | Photosensitive | | Dispersion | | | | VL | Filming |
|---|---|---|---|---|---|---|---|---|
| | member | CGM | agent | HTM | ETM | Resin | [+V] | •scratch |
| Example 3-1 | A3-1 | CG-1 | 30 | H-1 | E-1 | R-1 | 96 | B |
| Example 3-2 | A3-2 | CG-1 | 30 | H-1 | E-2 | R-1 | 99 | B |
| Example 3-3 | A3-3 | CG-1 | 30 | H-1 | E-3 | R-1 | 100 | B |
| Example 3-4 | A3-4 | CG-1 | 30 | H-1 | E-4 | R-1 | 93 | B |
| Example 3-5 | A3-5 | CG-1 | 30 | H-1 | E-5 | R-1 | 97 | B |
| Example 3-6 | A3-6 | CG-1 | 30 | H-1 | E-6 | R-1 | 103 | B |
| Example 3-7 | A3-7 | CG-1 | 30 | H-1 | E-7 | R-1 | 109 | B |
| Example 3-8 | A3-8 | CG-1 | 30 | H-1 | E-8 | R-1 | 97 | B |
| Example 3-9 | A3-9 | CG-1 | 30 | H-2 | E-4 | R-1 | 90 | B |
| Example 3-10 | A3-10 | CG-1 | 30 | H-3 | E-4 | R-1 | 94 | B |
| Example 3-11 | A3-11 | CG-1 | 30 | H-4 | E-4 | R-1 | 90 | B |
| Example 3-12 | A3-12 | CG-1 | 30 | H-5 | E-4 | R-1 | 98 | B |
| Example 3-13 | A3-13 | CG-1 | 30 | H-6 | E-4 | R-1 | 105 | B |
| Example 3-14 | A3-14 | CG-1 | 30 | H-7 | E-4 | R-1 | 104 | B |
| Example 3-15 | A3-15 | CG-1 | 30 | H-8 | E-4 | R-1 | 93 | B |
| Example 3-16 | A3-16 | CG-1 | 30 | H-9 | E-4 | R-1 | 97 | B |
| Example 3-17 | A3-17 | CG-1 | 30 | H-10 | E-4 | R-1 | 90 | B |
| Example 3-18 | A3-18 | CG-1 | 30 | H-11 | E-4 | R-1 | 86 | B |
| Example 3-19 | A3-19 | CG-1 | 30 | H-11 | E-4 | R-2 | 102 | B |
| Example 3-20 | A3-20 | CG-1 | 31 | H-1 | E-1 | R-1 | 94 | B |
| Example 3-21 | A3-21 | CG-1 | 30 | H-1 | E-1 | R-2 | 92 | A |
| Example 3-22 | A3-22 | CG-1 | 30 | H-1 | E-1 | R-3 | 91 | A |
| Example 3-23 | A3-23 | CG-1 | 30 | H-1 | E-1 | R-4 | 95 | B |
| Example 3-24 | A3-24 | CG-1 | 30 | H-1 | E-1 | R-5 | 95 | A |
| Example 3-25 | A3-25 | CG-1 | 30 | H-1 | E-1 | R-6 | 93 | B |
| Example 3-26 | A3-26 | CG-1 | 30 | H-1 | E-1 | R-7 | 92 | A |
| Example 3-27 | A3-27 | CG-1 | 30 | H-1 | E-1 | R-8 | 83 | B |

TABLE 19

| | Photosensitive | | Dispersion | | | | VL | Filming |
|---|---|---|---|---|---|---|---|---|
| | member | CGM | agent | HTM | ETM | Resin | [+V] | •scratch |
| Example 3-28 | A3-28 | CG-1 | — | H-2 | E-4 | R-1 | 133 | B |
| Example 3-29 | A3-29 | CG-A | — | H-2 | E-4 | R-1 | 152 | B |
| Example 3-30 | A3-30 | CG-A | 30 | H-2 | E-4 | R-1 | 159 | B |
| Example 3-31 | A3-31 | CG-A | 31 | H-2 | E-4 | R-1 | 188 | B |
| Comparative | B3-5 | CG-1 | 30 | H-3 | E-5 | R-A | 106 | D |
| Example 3-1 | | | | | | | | |
| Comparative | B3-6 | CG-1 | 30 | H-3 | E-5 | R-B | 102 | D |
| Example 3-2 | | | | | | | | |
| Comparative | B3-7 | CG-1 | 30 | H-3 | E-5 | R-C | 101 | C |
| Example 3-3 | | | | | | | | |
| Comparative | B3-8 | CG-1 | 30 | H-3 | E-5 | R-D | 110 | C |
| Example 3-4 | | | | | | | | |
| Comparative | B3-9 | CG-1 | 30 | H-3 | E-5 | R-E | 103 | D |
| Example 3-5 | | | | | | | | |
| Comparative | B3-10 | CG-1 | 30 | H-3 | E-5 | R-F | 98 | C |
| Example 3-6 | | | | | | | | |

As shown in Tables 15, 17, and 19, the photosensitive layers of the photosensitive members (B-1) to (B-5), (B2-1) to (B2-6), and (B3-5) to (B3-10) each did not contain the polyarylate resin (PA). Therefore, the photosensitive members (B-1) to (B-5), (B2-1) to (B2-6), and (B3-5) to (B3-10) were evaluated as C or D in the evaluation of filming resistance and scratch resistance and were poor in filming resistance and scratch resistance.

As shown in Tables 13, 14, 16, 17, 18, and 19, the photosensitive layers of the photosensitive members (A-1) to (A-31), (A2-1) to (A2-24), and (A3-1) to (A3-31) each contained a charge generating material, a hole transport material, an electron transport material, and a polyarylate resin. The polyarylate resin was the polyarylate resin (PA) (more specifically, one of the polyarylate resins (R-1) to (R-8)). Therefore, the photosensitive members (A-1) to (A-31), (A2-1) to (A2-24), and (A3-1) to (A3-31) were evaluated as A or B in the evaluation of filming resistance and scratch resistance and were excellent in filming resistance and scratch resistance.

From the above, it was demonstrated that the photosensitive member, which encompasses the photosensitive members (A-1) to (A-31), (A2-1) to (A2-24), and (A3-1) to (A3-31), is excellent in filming resistance and scratch resistance. Furthermore, as a result of including a photosensitive member such as above, the process cartridge and the image forming apparatus according to the present disclosure can be determined to include a photosensitive member with improved filming resistance and scratch resistance.

What is claimed is:

1. An electrophotographic photosensitive member comprising:
A conductive substrate and a photosensitive layer, wherein
The photosensitive layer is a single layer,
The photosensitive layer contains a charge generating material, a hole transport material, an electron transport material, and a polyarylate resin,
the polyarylate resin includes a repeating unit represented by formula (1), a repeating unit represented by formula (2), and a repeating unit represented by formula (3), and
a ratio n₁/n₂ of a number m of repeats of the repeating unit represented by the formula (1) to a number n₂ of repeats of the repeating unit represented by the formula (2) is at least 1.0, 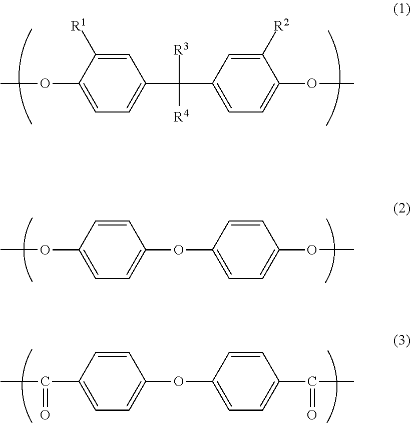
where in the formula (1):
R¹ and R² each represent a methyl group, and R³ and R⁴ are bonded to each other to represent a cycloalkylidene group with a carbon number of 5 or 6; or
R¹ and R² each represent, independently of one another, a hydrogen atom or a methyl group, R³ represents a methyl group, and R⁴ represents a hydrogen atom or an alkyl group with a carbon number of 2 or 3.

2. The electrophotographic photosensitive member according to claim 1, wherein
The repeating unit represented by the formula (1) is a repeating unit represented by formula (1-1), (1-2), (1-3), (1-4), or (1-5),

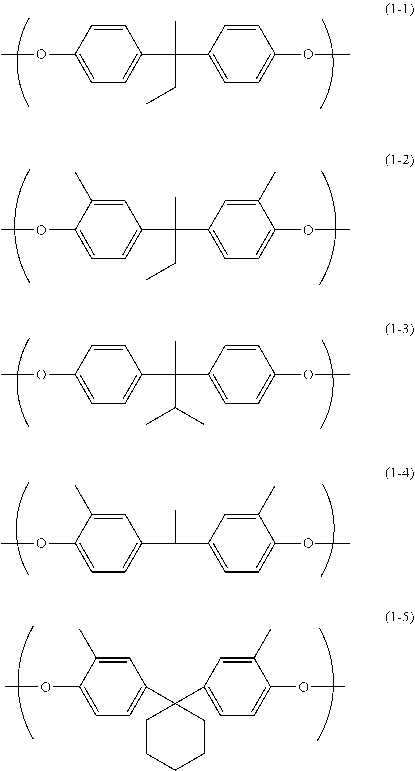

3. The electrophotographic photosensitive member according to claim 2, wherein
The repeating unit represented by the formula (1) is the repeating unit represented by the formula (1-5).

4. The electrophotographic photosensitive member according to claim 1, wherein
The photosensitive layer further contains resin particles.

5. The electrophotographic photosensitive member according to claim 4, wherein
The resin particles have a volume median diameter of at least 0.05 μm and no greater than 5.00 μm.

6. The electrophotographic photosensitive member according to claim 4, wherein
A percentage content of the resin particles relative to a mass of the photosensitive layer is at least 0.01% by mass and no greater than 15.0% by mass.

7. The electrophotographic photosensitive member according to claim 4, wherein
The resin particles are silicone resin particles.

8. The electrophotographic photosensitive member according to claim 1, wherein
The charge generating material includes titanyl phthalocyanine,
The photosensitive layer further contains a dispersion agent, and
the dispersion agent includes a compound represented by formula (30) or (31),

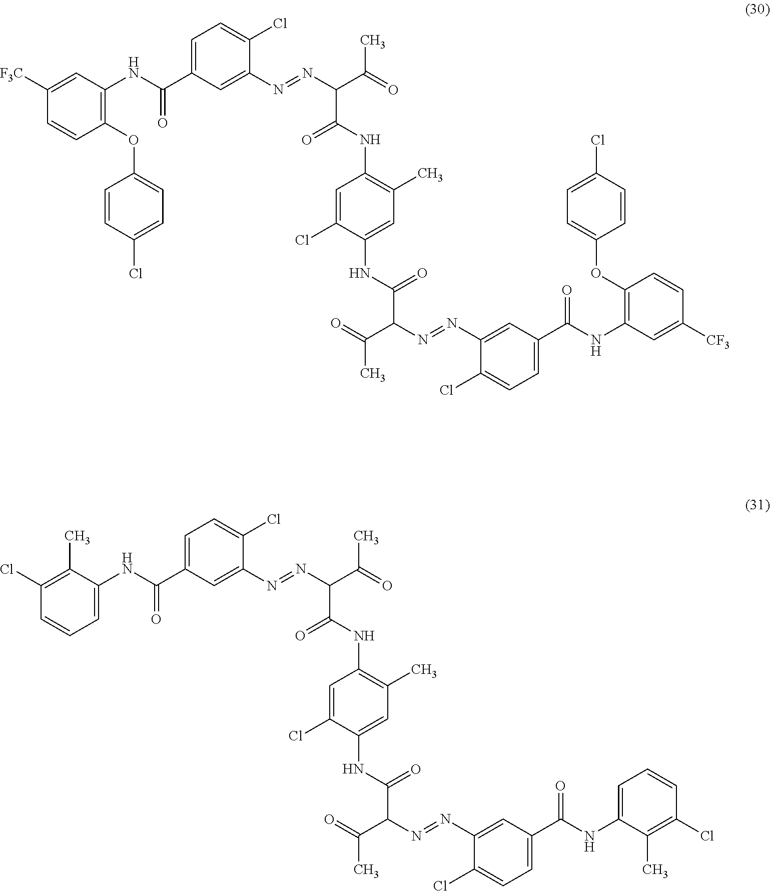 [SMILES: CC(=O)C(/N=N/c1cc(C(=O)Nc2cc(C(F)(F)F)ccc2Oc2ccc(Cl)cc2)ccc1Cl)C(=O)Nc1cc(Cl)c(NC(=O)C(/N=N/c2cc(C(=O)Nc3cc(C(F)(F)F)ccc3Oc3ccc(Cl)cc3)ccc2Cl)C(C)=O)cc1C ; CC(=O)C(/N=N/c1cc(C(=O)Nc2cccc(Cl)c2C)ccc1Cl)C(=O)Nc1cc(Cl)c(NC(=O)C(/N=N/c2cc(C(=O)Nc3cccc(Cl)c3C)ccc2Cl)C(C)=O)cc1C]

9. The electrophotographic photosensitive member according to claim 1, wherein
The electron transport material includes a compound represented by formula (10), (11), (12), (13), (14), (15), or (16), 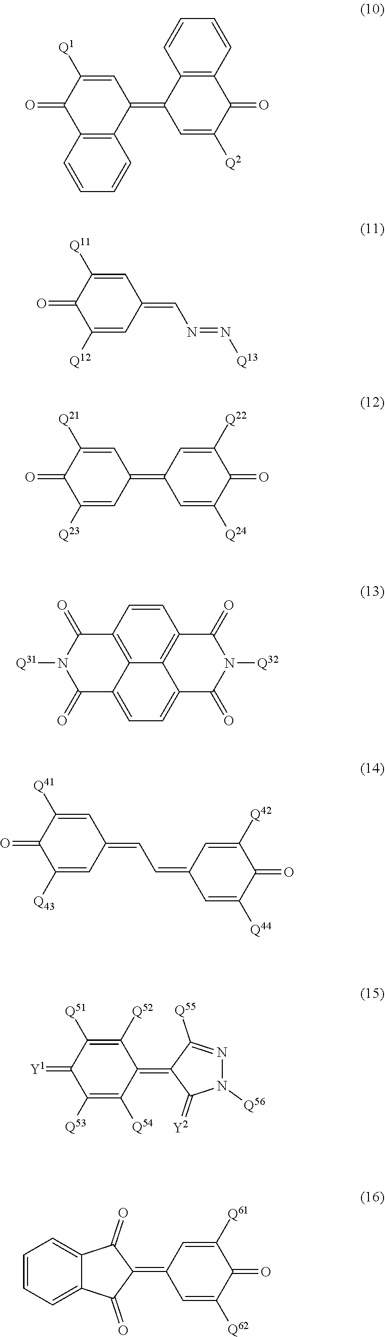
where Q¹ and Q² in the formula (10), Q¹¹, Q¹², and Q¹³ in the formula (11), Q²¹, Q²², Q²³, and Q²⁴ in the formula (12), Q³¹ and Q³² in the formula (13), Q⁴¹, Q⁴², Q⁴³, and Q⁴⁴ in the formula (14), Q⁵¹, Q⁵², Q⁵³, Q⁵⁴, Q⁵⁵, and Q⁵⁶ in the formula (15), and Q⁶¹ and Q⁶² in the formula (16) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6, and
Y¹ and Y² in the formula (15) each represent, independently of one another, an oxygen atom or a sulfur atom.

10. The electrophotographic photosensitive member according to claim 1, wherein
the electron transport material includes a compound represented by formula (E-1), (E-2), (E-3), (E-4), (E-5), (E-6), (E-7), or (E-8),

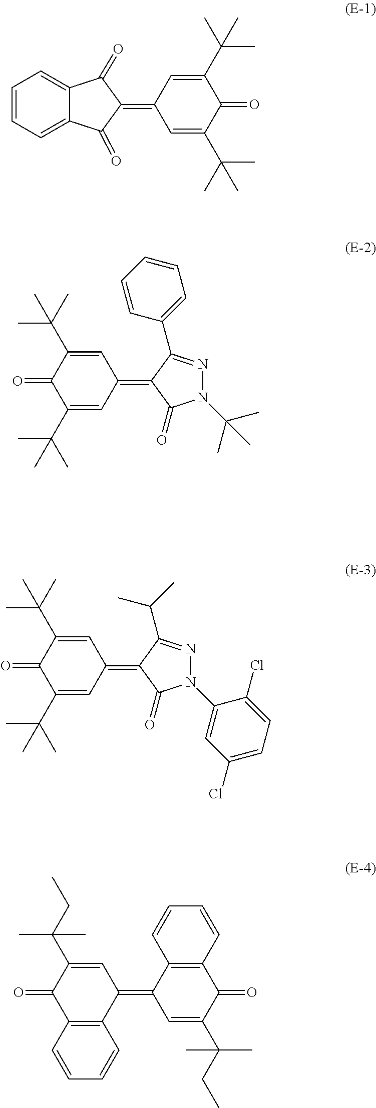 [SMILES: CC(C)(C)C1=CC(=C2C(=O)c3ccccc3C2=O)C=C(C(C)(C)C)C1=O ; CC(C)(C)C1=CC(=C2C(=O)N(C(C)(C)C)N=C2c2ccccc2)C=C(C(C)(C)C)C1=O ; CC(C)C1=NN(c2cc(Cl)ccc2Cl)C(=O)C1=C1C=C(C(C)(C)C)C(=O)C(C(C)(C)C)=C1 ; CCC(C)(C)C1=C/C(=C2/C=C(C(C)(C)CC)C(=O)c3ccccc32)c2ccccc2C1=O]

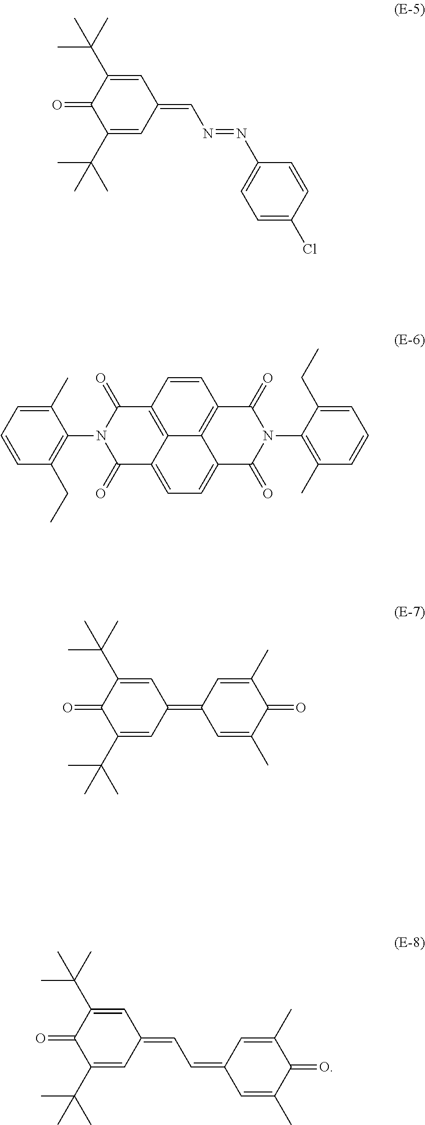 [SMILES: CC(C)(C)C1=CC(=C/N=N/c2ccc(Cl)cc2)C=C(C(C)(C)C)C1=O ; CCc1cccc(C)c1N1C(=O)c2ccc3c4c(ccc(c24)C1=O)C(=O)N(c1c(C)cccc1CC)C3=O ; CC1=CC(=C2C=C(C(C)(C)C)C(=O)C(C(C)(C)C)=C2)C=C(C)C1=O ; CC1=CC(=CC=C2C=C(C(C)(C)C)C(=O)C(C(C)(C)C)=C2)C=C(C)C1=O]

11. The electrophotographic photosensitive member according to claim 1, wherein
the hole transport material includes a compound represented by formula (20), (21), (22), (23), or (24), 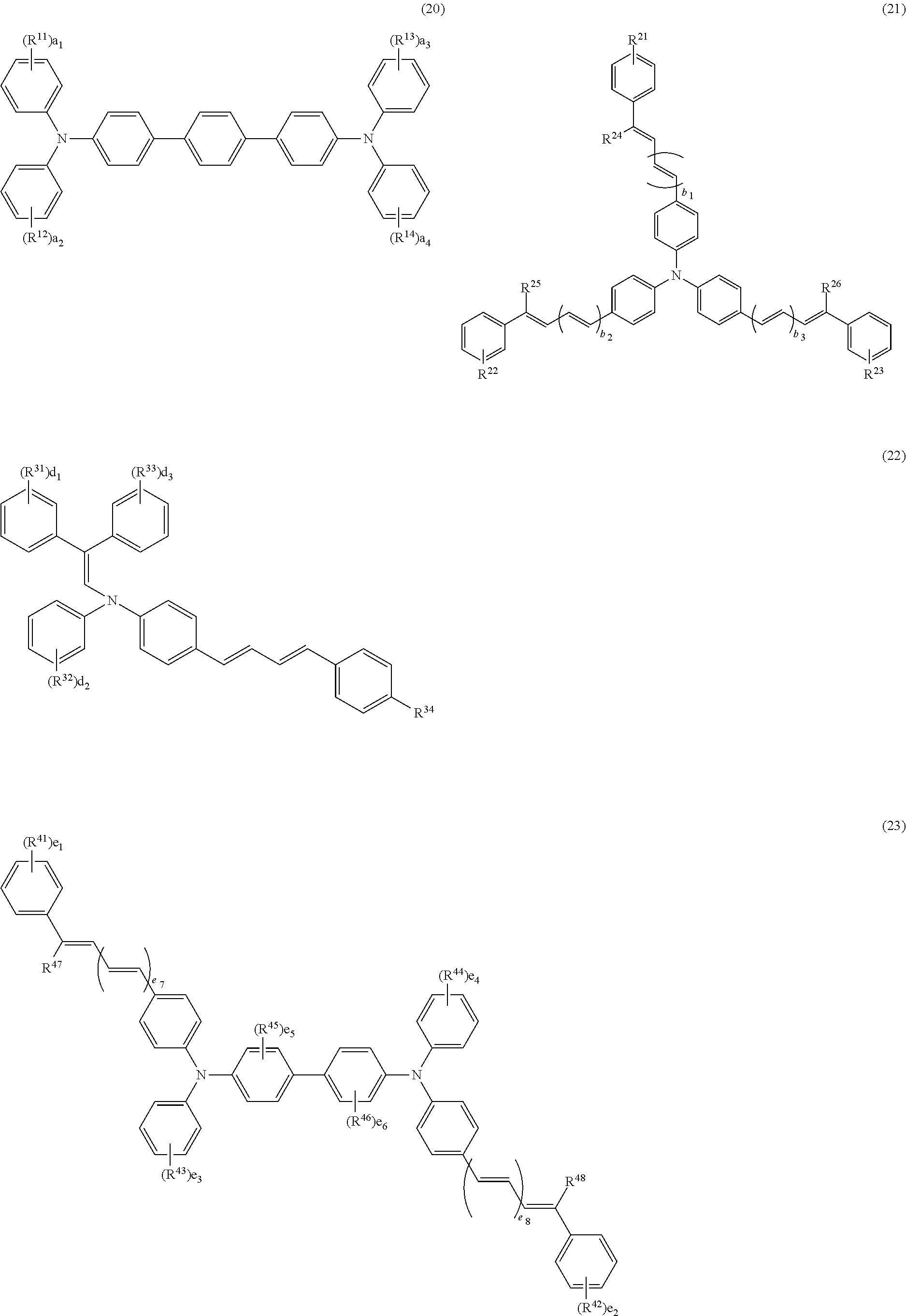 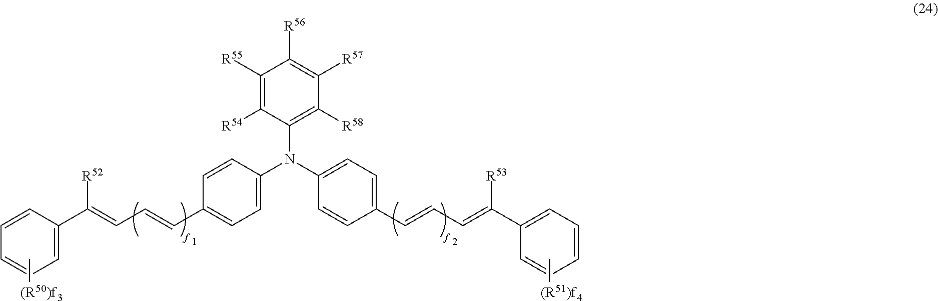
in the formula (20), R¹¹, R¹², R¹³, and R¹⁴ each represent, independently of one another, an alkyl group with a carbon number of at least 1 and no greater than 6 or an alkoxy group with a carbon number of at least 1 and no greater than 6, and a₁, a₂, a₃, and a₄ each represent, independently of one another, an integer of at least 0 and no greater than 5,
in the formula (21), R²¹, R²², and R²³ each represent, independently of one another, an alkyl group with a carbon number of at least 1 and no greater than 6, R²⁴, R²⁵, and R²⁶ each represent, independently of one another, a hydrogen atom or an alkyl group with a carbon number of at least 1 and no greater than 6, and b₁, b₂, and b₃ each represent, independently of one another, 0 or 1,
in the formula (22), R³¹, R³², and R³³ each represent, independently of one another, an alkyl group with a carbon number of at least 1 and no greater than 6, R³⁴ represents a hydrogen atom or an alkyl group with a carbon number of at least 1 and no greater than 6, and d₁, d₂, and d₃ each represent, independently of one another, an integer of at least 0 and no greater than 5,
in the formula (23), R⁴¹, R⁴², R⁴³, R⁴⁴, R⁴⁵, and R⁴⁶ each represent, independently of one another, a phenyl group or an alkyl group with a carbon number of at least 1 and no greater than 6, R⁴⁷ and R⁴⁸ each represent, independently of one another, a hydrogen atom, a phenyl group, or an alkyl group with a carbon number of at least 1 and no greater than 6, e₁, e₂, e₃, and e₄ each represent, independently of one another, an integer of at least 0 and no greater than 5, e₅ and e₆ each represent, independently of one another, an integer of at least 0 and no greater than 4, and e₇ and e₈ each represent, independently of one another, 0 or 1, and
in the formula (24), R⁵⁰ and R⁵¹ each represent, independently of one another, a phenyl group, an alkyl group with a carbon number of at least 1 and no greater than 6, or an alkoxy group with a carbon number of at least 1 and no greater than 6, R⁵², R⁵³, R⁵⁴, R⁵⁵, R⁵⁶, R⁵⁷, and R⁵⁸ each represent, independently of one another, a hydrogen atom, an alkyl group with a carbon number of at least 1 and no greater than 6, an alkoxy group with a carbon number of at least 1 and no greater than 6, or a phenyl group optionally substituted with an alkyl group with a carbon number of at least 1 and no greater than 6, f₁ and f₂ each represent, independently of one another, an integer of at least 0 and no greater than 2, and f₃ and f₄ each represent, independently of one another, an integer of at least 0 and no greater than 5.

12. The electrophotographic photosensitive member according to claim 11, wherein
the electron transport material includes a compound represented by formula (15), (12), (13), or (14), 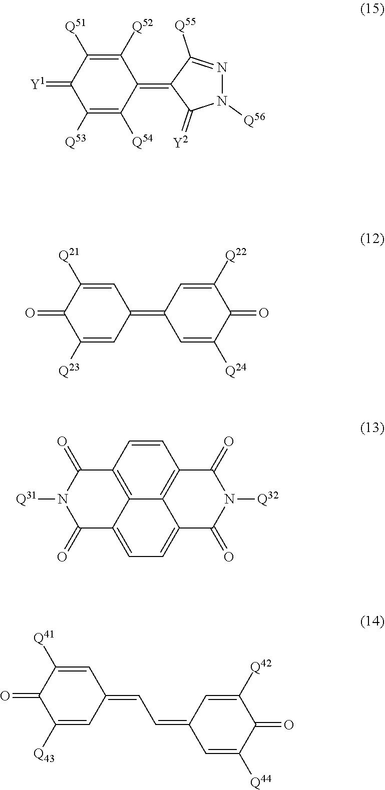
where Q⁵¹, Q⁵², Q⁵³, Q⁵⁴, Q⁵⁵, and Q⁵⁶ in the formula (15), Q²¹, Q²², Q²³, and Q²⁴ in the formula (12), Q³¹ and Q³² in the formula (13), and Q⁴¹, Q⁴², Q⁴³, and Q⁴⁴ in the formula (14) each represent, independently of one another, a hydrogen atom, a halogen atom, a cyano group, an alkyl group with a carbon number of at least 1 and no greater than 6, an alkenyl group with a carbon number of at least 2 and no greater than 6, an alkoxy group with a carbon number of at least 1 and no greater than 6, or an aryl group with a carbon number of at least 6 and no greater than 14 optionally substituted with at least one substituent selected from the group consisting of a halogen atom and an alkyl group with a carbon number of at least 1 and no greater than 6, and
in the formula (15), Y¹ and Y² each represent, independently of one another, an oxygen atom or a sulfur atom.

13. The electrophotographic photosensitive member according to claim 1, wherein
the hole transport material includes a compound represented by formula (H-1), (H-2), (H-3), (H-4), (H-5), (H-6), (H-7), (H-8), (H-9), (H-10) or (H-11),

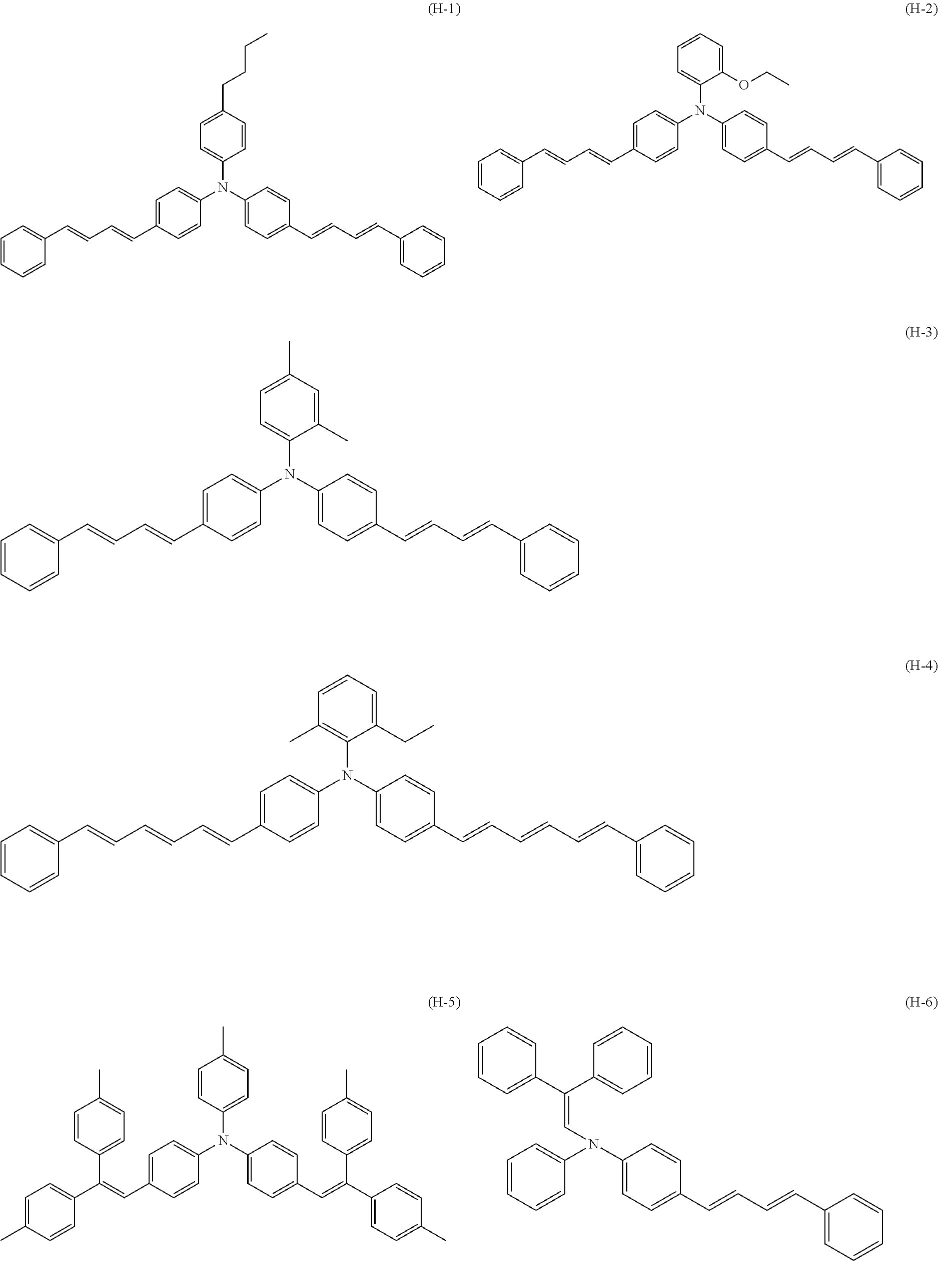

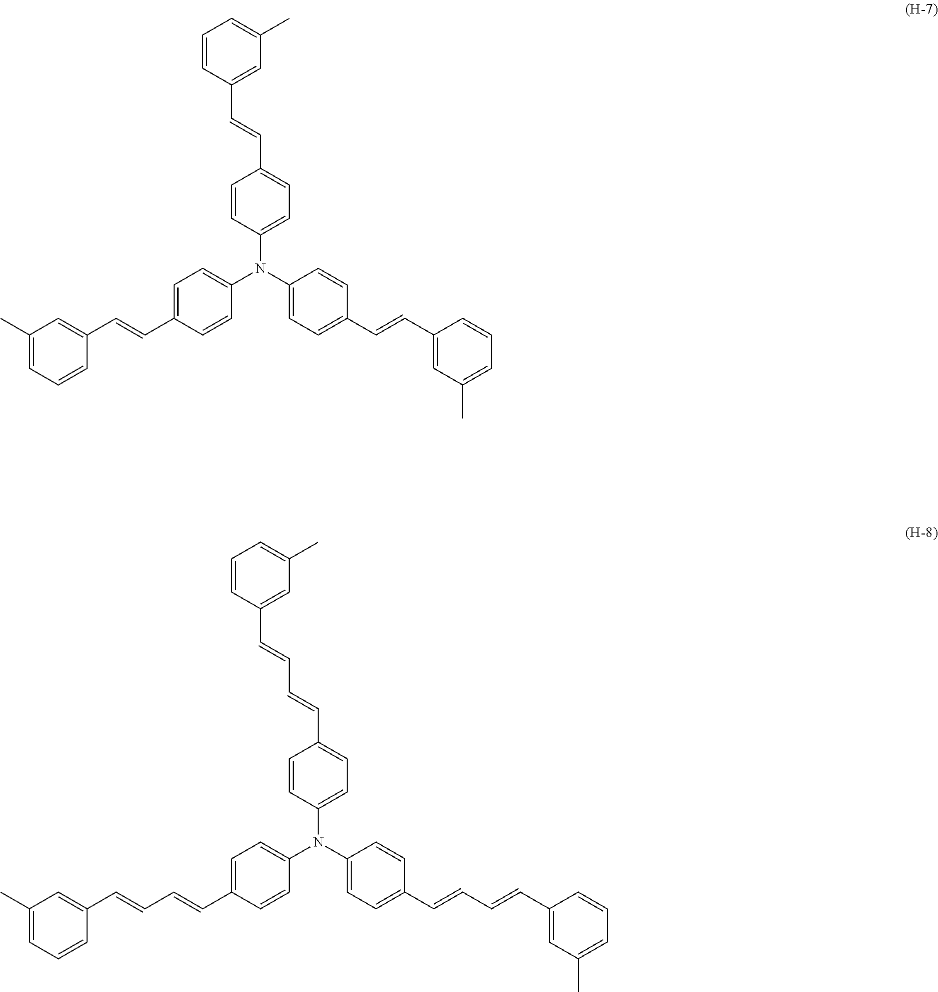 [SMILES: Cc1cccc(/C=C/c2ccc(N(c3ccc(/C=C/c4cccc(C)c4)cc3)c3ccc(/C=C/c4cccc(C)c4)cc3)cc2)c1 ; Cc1cccc(/C=C/C=C/c2ccc(N(c3ccc(/C=C/C=C/c4cccc(C)c4)cc3)c3ccc(/C=C/C=C/c4cccc(C)c4)cc3)cc2)c1]

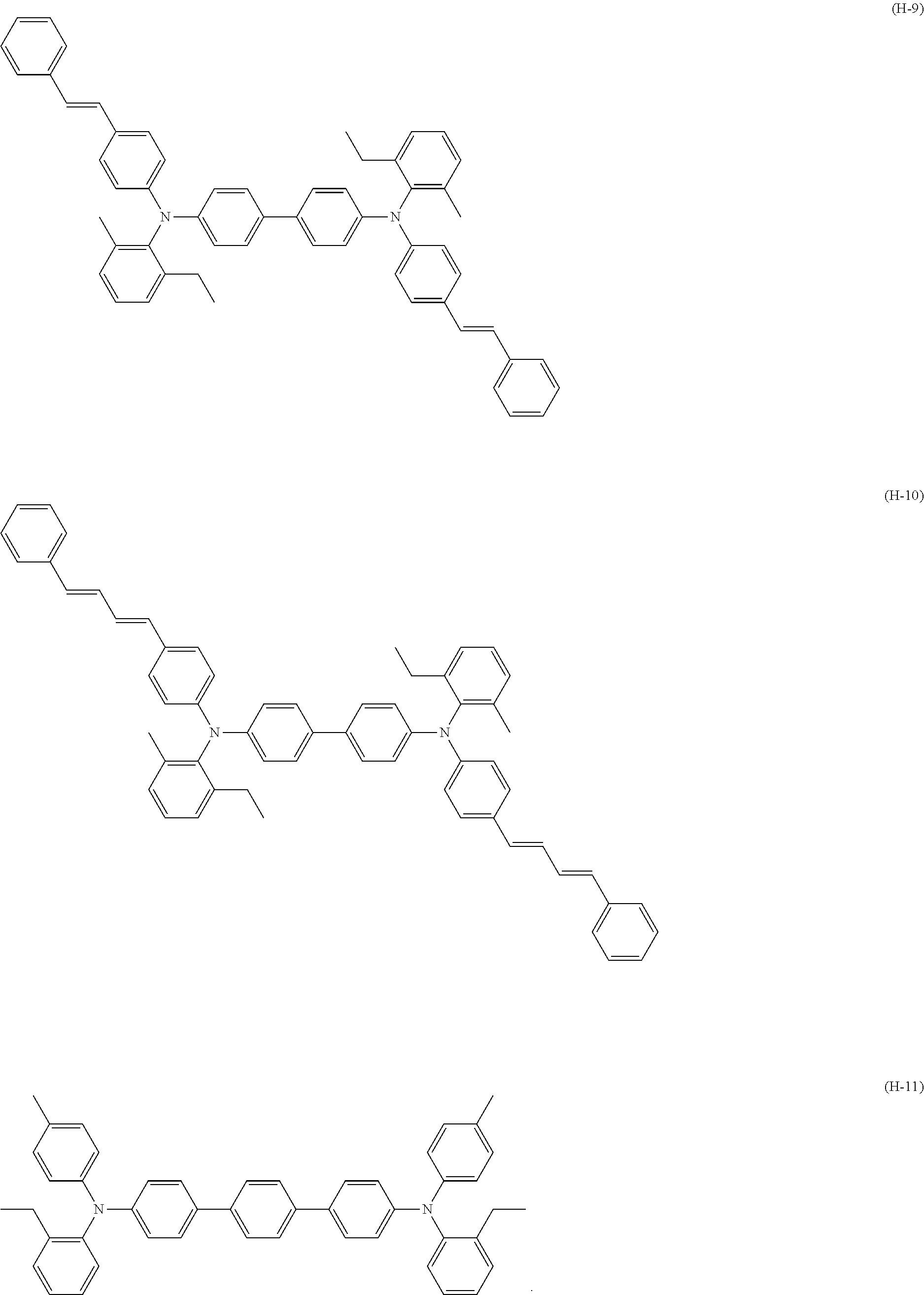 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1 ; CCc1ccccc1N(c1ccc(C)cc1)c1ccc(-c2ccc(-c3ccc(N(c4ccc(C)cc4)c4ccccc4CC)cc3)cc2)cc1]

14. The electrophotographic photosensitive member according to claim 1, wherein
the charge generating material includes titanyl phthalocyanine.

15. The electrophotographic photosensitive member according to claim 1, wherein
the photosensitive layer is provided as an outermost surface layer.

16. A process cartridge comprising
the electrophotographic photosensitive member according to claim 1.

17. An image forming apparatus comprising:
an image bearing member;
a charger configured to charge a surface of the image bearing member;
a light exposure device configured to expose the charged surface of the image bearing member to light to form an electrostatic latent image on the surface of the image bearing member;
a development device configured to develop the electrostatic latent image into a toner image by supplying toner to the surface of the image bearing member; and
a transfer device configured to transfer the toner image from the image bearing member to a transfer target, wherein
the image bearing member is the electrophotographic photosensitive member according to claim 1.

18. The image forming apparatus according to claim 17, further comprising
either or both a cleaner and a static eliminator, the cleaner being configured to collect toner of the toner attached to the surface of the image bearing member, the static eliminator being configured to perform static elimination on the surface of the image bearing member.

19. The image forming apparatus according to claim 17, wherein
the charger is a charging roller.

20. The image forming apparatus according to claim 17, wherein
the development device supplies the toner charged by friction with a carrier to the surface of the image bearing member.
